(19) United States
(12) Patent Application Publication
(10) Pub. No.: US 2017/0038641 A1
(43) Pub. Date: Feb. 9, 2017

(54) DISPLAY DEVICE, ELECTRONIC DEVICE, AND SYSTEM

(71) Applicant: Semiconductor Energy Laboratory Co., Ltd., Atsugi-shi (JP)

(72) Inventor: Shunpei YAMAZAKI, Setagaya (JP)

(73) Assignee: Semiconductor Energy Laboratory Co., Ltd.

(21) Appl. No.: 15/225,149

(22) Filed: Aug. 1, 2016

(30) Foreign Application Priority Data
Aug. 7, 2015 (JP) 2015-157126
Jun. 16, 2016 (JP) 2016-119609

(51) Int. Cl. G02F 1/1335; G02F 1/1333; G06F 1/16

(52) U.S. Cl. CPC G02F 1/133555; G06F 1/1616; G06F 1/1647; G06F 1/1654; G06F 1/1681; G02F 1/133308

(57) ABSTRACT

A system includes an electronic device and a display device. The electronic device includes a first display portion positioned on a first surface including an upper surface of a housing and a second display portion positioned on a second surface including a first side surface of the housing. The display device includes a third display portion positioned on a third surface of a support portion and a connection portion having a function of connecting to the housing and reversibly changing the relative positions of the support portion and the housing between a first configuration and a second configuration. In the first configuration, the support portion covers the first display portion such that the second display portion is visible. In the second configuration, the support portion and the housing are opened such that the first, second, and third display portions are visible.

### BACKGROUND OF THE INVENTION

1. Field of the Invention

One embodiment of the present invention relates to a display device. One embodiment of the present invention relates to an electronic device. One embodiment of the present invention relates to a system including a display device.

Note that one embodiment of the present invention is not limited to the above technical field. Examples of the technical field of one embodiment of the present invention disclosed in this specification include a semiconductor device, a display device, a light-emitting device, a power storage device, a memory device, an electronic device, a lighting device, an input device, an input/output device, a method for driving any of them, and a method for manufacturing any of them.

2. Description of the Related Art

Electronic devices including display devices have recently been diversified. Examples of the electronic devices include cellular phones, smartphones, tablet terminals, and wearable terminals.

Examples of the display devices include, typically, a light-emitting device including a light-emitting element such as an organic electroluminescent (EL) element or a light-emitting diode (LED), a liquid crystal display device, and an electronic paper performing display by an electrophoretic method or the like.

Patent Document 1 discloses a flexible light-emitting device using an organic EL element.

### PATENT DOCUMENT

[Patent Document 1] Japanese Published Patent Application No. 2014-197522

### SUMMARY OF THE INVENTION

In recent years, browsability of display has been considered to be improved by enlarging display regions of electronic devices to display a larger amount of data. However, in applications of portable devices and the like, an enlargement of display regions might entail a reduction in portability. For this reason, browsability of display and portability are difficult to improve at the same time.

An object of one embodiment of the present invention is to enlarge a display region of an electronic device. Another object is to protect a display region of an electronic device. Another object is to provide a function of selecting the size of a display region of an electronic device depending on its intended use. Another object is to provide a display device for extending a display region of an electronic device. Another object is to provide a highly portable electronic device.

Another object is to reduce power consumption of an electronic device. Another object is to provide an electronic device with high visibility independent of the intensity of external light.

Another object of one embodiment of the present invention is to provide a novel display device, a novel electronic device, or a novel system including a display device.

Note that the descriptions of these objects do not disturb the existence of other objects. In one embodiment of the present invention, there is no need to achieve all the objects. Objects other than the above objects can be derived from the description of the specification and the like.

One embodiment of the present invention is a display device that is attachable to an electronic device. The electronic device includes a housing, and the housing includes a first display portion and a second display portion. The first display portion is positioned on a first surface including an upper surface of the housing, and the second display portion is positioned on a second surface including a first side surface of the housing. The display device includes a support portion, a connection portion, and a third display portion. The third display portion is positioned on a third surface of the support portion. The connection portion has a function of connecting to the housing and a function of reversibly changing the relative positions of the support portion and the housing between a first configuration and a second configuration. The first configuration is the one in which the support portion covers the first display portion such that the second display portion is visible. The second configuration is the one in which the support portion and the housing are opened such that the first display portion, the second display portion, and the third display portion are visible.

It is preferable that the third display portion of the display device include a portion in which a liquid crystal element and a light-emitting element are stacked. It is further preferable that the liquid crystal element include a first electrode that reflects visible light and that has an opening, and the light-emitting element have a function of emitting light through the opening.

It is preferable that, in the first configuration, the first display portion and the third display portion be positioned to face each other.

It is preferable that, in the first configuration, the support portion be positioned not to cover at least a portion of the second display portion.

It is preferable that the support portion include a light-transmitting portion, and in the first configuration, the light-transmitting portion be positioned to cover a portion of the first side surface of the housing so as to overlap with the second display portion.

It is preferable that the support portion be flexible and have a function of allowing the third display portion to be bent.

It is preferable that the connection portion be flexible. In that case, it is preferable that the relative positions of the support portion and the housing be reversibly changed between the first configuration and the second configuration by bending the connection portion.

It is preferable that the connection portion include a hinge structure with two or more rotation axes. In that case, it is preferable that the hinge structure enable the relative positions of the support portion and the housing to be reversibly changed between the first configuration and the second configuration.

It is preferable that the connection portion include a reception portion supplied with power and a signal from the housing. In that case, it is preferable that the reception portion be supplied with the power and the signal wirelessly.

It is preferable that the connection portion have a function of being magnetically attachable to and detachable from the housing.

Another embodiment of the present invention is an electronic device to which a display device is attachable. The electronic device includes a housing, and the housing includes a first display portion and a second display portion. The first display portion is positioned on a first surface including an upper surface of the housing, and the second display portion is positioned on a second surface including a first side surface of the housing. The display device includes a support portion, a connection portion, and a third display portion. The third display portion is positioned on a third surface of the support portion. The connection portion has a function of connecting to the housing and a function of reversibly changing the relative positions of the support portion and the housing between a first configuration and a second configuration. The first configuration is the one in which the support portion covers the first display portion such that the second display portion is visible. The second configuration is the one in which the support portion and the housing are opened such that the first display portion, the second display portion, and the third display portion are visible.

It is preferable that the third display portion of the display device include a portion in which a liquid crystal element and a light-emitting element are stacked. It is further preferable that the liquid crystal element include a first electrode that reflects visible light and that has an opening, and the light-emitting element have a function of emitting light through the opening.

It is preferable that the connection portion be attachable to a second side surface opposite to the first side surface of the housing.

It is preferable that the first display portion and the second display portion be constituted by one display panel. It is preferable that the second display portion include a curved portion.

It is preferable that the housing include a support mechanism. It is preferable that, in the second configuration, the support mechanism have a function of supporting the support portion such that the first surface and the third surface are at a predetermined angle.

It is preferable that the support mechanism include a lock mechanism such that the relative positions of the housing and the support portion include a plurality of stable positions.

It is preferable that the housing include a transmission portion for supplying power and a signal to the connection portion. In that case, it is preferable that the transmission portion supply the power and the signal from the housing wirelessly.

It is preferable that the housing have a function of being magnetically attachable to and detachable from the connection portion.

Another embodiment of the present invention is a system including any of the above display devices and any of the above electronic devices.

According to one embodiment of the present invention, a display region of an electronic device can be enlarged. A display region of an electronic device can be protected. A function of selecting the size of a display region of an electronic device depending on its intended use can be provided. A display device for extending a display region of an electronic device can be provided. A highly portable electronic device can be provided.

Power consumption of an electronic device can be reduced. An electronic device with high visibility independent of the intensity of external light can be provided.

### BRIEF DESCRIPTION OF THE DRAWINGS

FIGS. 1A1, 1A2, 1A3, 1B1, 1B2, 1C1, and 1C2 illustrate a structural example of a system according to an embodiment.

FIGS. 2A1, 2A2, and 2A3 illustrate a structural example of a system according to an embodiment.

FIG. 3 illustrates a structural example of a system according to an embodiment.

FIGS. 4A1, 4A2, 4B1, and 4B2 illustrate a structural example of a system according to an embodiment.

FIGS. 5A1, 5A2, 5B, and 5C illustrate a structural example of a system according to an embodiment.

FIG. 6 illustrates a structural example of a system according to an embodiment.

FIGS. 7A to 7C illustrate a structural example of a system according to an embodiment.

FIG. 8 illustrates a structural example of a system according to an embodiment.

FIGS. 9A to 9C illustrate a structural example of a system according to an embodiment.

FIGS. 10A and 10B illustrate a structural example of a system according to an embodiment.

FIGS. 11A1, 11A2, 11B, and 11C illustrate a structural example of a system according to an embodiment.

FIGS. 12A and 12B illustrate a structural example of a system according to an embodiment.

FIGS. 13A and 13B illustrate a structural example of a system according to an embodiment.

FIGS. 14A and 14B illustrate a structural example of a system according to an embodiment.

FIGS. 15A and 15B illustrate a structural example of a system according to an embodiment.

FIGS. 16A and 16B illustrate a structural example of a system according to an embodiment.

FIGS. 17A and 17B illustrate a structural example of a system according to an embodiment.

FIGS. 18A and 18B illustrate a structural example of a system according to an embodiment.

FIG. 19 illustrates a configuration example of a system according to an embodiment.

FIG. 20 illustrates a configuration example of a system according to an embodiment.

FIGS. 21A, 21B1, and 21B2 illustrate a structure of a display panel according to an embodiment.

FIGS. 22A to 22C illustrate a structure of a display panel according to an embodiment.

FIG. 23 is a circuit diagram illustrating a pixel circuit according to an embodiment.

FIGS. 24A, 24B1, and 24B2 illustrate a structure of a display panel according to an embodiment.

FIG. 25 illustrates a structure of a display panel according to an embodiment.

FIGS. 26A to 26D illustrate structural examples of input devices according to an embodiment.

FIGS. 27A to 27D each illustrate a structural example of an input device according to an embodiment.

FIGS. 28A and 28B illustrate a structural example of an input/output device according to an embodiment.

FIG. 29 illustrates a structural example of an input/output device according to an embodiment.

FIG. 30 illustrates a structural example of an input/output device according to an embodiment.

FIG. 31 illustrates a structural example of an input/output device according to an embodiment.

FIG. 32 illustrates a structural example of an input/output device according to an embodiment.

FIG. 33 illustrates a structural example of an input/output device according to an embodiment.

FIG. 34 illustrates a structural example of an input/output device according to an embodiment.

FIGS. 35A and 35B illustrate a structural example of an input/output device according to an embodiment.

FIG. 36 illustrates a structural example of an input/output device according to an embodiment.

FIGS. 37A to 37D illustrate structural examples of portable information terminals according to an embodiment.

FIG. 38 shows measured XRD spectra of samples.

FIGS. 39A and 39B are TEM images of samples and FIGS. 39C to 39L are electron diffraction patterns thereof.

FIGS. 40A to 40C show EDX mapping images of a sample.

### DETAILED DESCRIPTION OF THE INVENTION

Embodiments will be described in detail with reference to the drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments.

Note that in the structures of the invention described below, the same portions or portions having similar functions are denoted by the same reference numerals in different drawings, and description of such portions is not repeated. Furthermore, the same hatch pattern is applied to similar functions, and these are not especially denoted by reference numerals in some cases.

Note that in each drawing described in this specification, the size, the layer thickness, or the region of each component is exaggerated for clarity in some cases. Therefore, embodiments of the present invention are not limited to such a scale.

Note that ordinal numbers such as “first” and “second” in this specification and the like are used in order to avoid confusion among components, and the terms do not limit the components numerically.

### Embodiment 1

In this embodiment, structural examples of a display device, an electronic device, and a system of one embodiment of the present invention are described.

### Structural Example 1

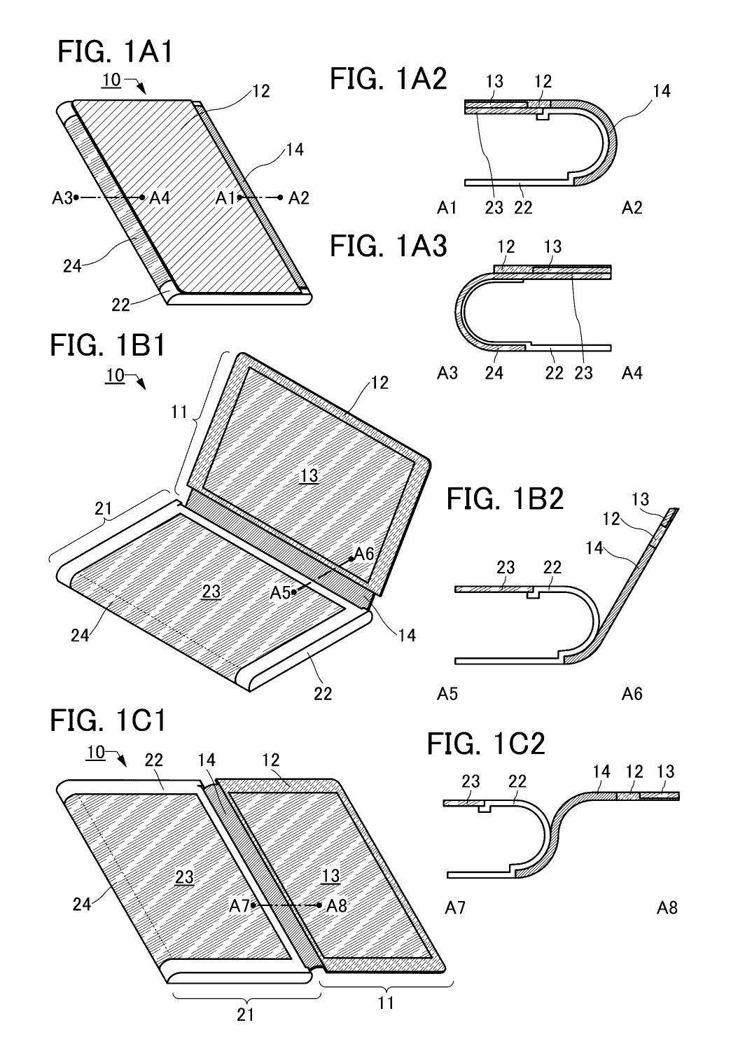

FIGS. 1A1, 1B1, and 1C1 are perspective schematic views of a system 10 including a display device 11 and an electronic device 21. FIG. 1A1 illustrates a state in which the display device 11 and the electronic device 21 overlap with each other (this state is also referred to as a closed state or a folded state). FIG. 1B1 illustrates a state in which they are unfolded (this state is also referred to as an opened state). FIG. 1C1 illustrates a state in which they are further unfolded (opened) to be substantially parallel to each other.

FIGS. 1A2 and 1A3 are cross-sectional schematic views taken along the section lines A1-A2 and A3-A4, respectively, in FIG. 1A1. FIG. 1B2 is a cross-sectional schematic view taken along the section line A5-A6 in FIG. 1B1. FIG. 1C2 is a cross-sectional schematic view taken along the section line A7-A8 in FIG. 1C1. Note that the internal structure of the housing 22 is not illustrated in each cross-sectional schematic view.

The display device 11 includes a support 12, a display portion 13, and a connection portion 14. The electronic device 21 includes a housing 22, a display portion 23, and a display portion 24.

The connection portion 14 connects the support 12 and the housing 22 to each other. The connection portion 14 has a function of changing the relative positions of the support 12 and the housing 22. This enables the relative positions of the support 12 and the housing 22 to be reversibly changed from a configuration illustrated in FIG. 1A1 to a configuration illustrated in FIG. 1C1 through a configuration illustrated in FIG. 1B1.

For example, the connection portion 14 may be flexible or may have a hinge structure. A structural example of the connection portion 14 having a hinge structure will be described later.

The connection portion 14 can be attached to the housing 22. The connection portion 14 and the housing 22 may be attached and fixed to each other so that a user cannot detach them, or the connection portion 14 and the housing 22 may be attached to each other so that a user can detach them. For example, a portion of the housing 22 may have a fixing mechanism with which the connection portion 14 can engage, or may have a fixing mechanism with which the housing 22 and the connection portion 14 can be mechanically or magnetically fixed to each other so as to be detachable as described later. It is preferable that the connection portion 14 and the housing 22 be electrically connected to each other or be capable of transmitting and receiving power and a signal therebetween.

The display portion 13 is provided over a surface of the support 12. Specifically, the display portion 13 is provided over a surface of the support 12 which is positioned on the electronic device 21 side in a state where the support 12 and the electronic device 21 overlap with each other as illustrated in FIG. 1A1.

The electronic device 21 includes, inside the housing 22, a battery, a printed circuit board on which a variety of ICs such as an arithmetic unit and a driver circuit are mounted, and the like. Electronic components, for example, a wireless receiver, a wireless transmitter, a wireless power receiver, and a variety of sensors such as an acceleration sensor may be incorporated as appropriate into the housing 22, so that the electronic device 21 can function as a portable terminal, a portable image reproducing device, a portable lighting device, or the like. A camera, a speaker, a variety of input/output terminals such as a terminal for power supply and a terminal for signal supply, a variety of sensors such as an optical sensor, an operation button, or the like may also be incorporated into the housing 22. The support 12 may also include a printed circuit board, an electronic component, a camera, a speaker, a variety of input/output terminals such as a terminal for power supply and a terminal for signal supply, a variety of sensors such as an optical sensor, an operation button, or the like as described above.

The display portion 23 is provided over a surface of the housing 22. The display portion 24 is provided over a side surface of the housing 22.

An example in which the display portion 23 and the display portion 24 form a seamless and continuous display portion is described here. For example, the display portion 23 and the display portion 24 may be formed by curving or bending a portion of one display panel. In FIGS. 1B1 and 1C1 and the like, a boundary between the display portion 23 and the display portion 24 is indicated by a broken line.

It is preferable that the display portion 23 display an image over a flat surface. It is also preferable that at least a portion of the display portion 24 display an image over a curved surface.

When the display portion 23 and the display portion 24 form a seamless and continuous display portion, for example, there is a case where the boundary therebetween is unclear. In this specification and the like, when the two display portions form a seamless and continuous display portion, a line connecting points of change in curvature of these surfaces is regarded as the boundary between the two display portions. Therefore, when the two display portions form a seamless and continuous display portion, at least a portion of the display portion 24 includes a curved surface.

In the configuration in which the support 12 and the housing 22 overlap with each other (this configuration is also referred to as a closed state) as illustrated in FIG. 1A1 or the like, the display portion 23 is preferably covered with the support 12. In that case, a portion of the support 12 functions as a protective cover for a surface of the display portion 23 and can prevent the surface of the display portion 23 from being damaged. In addition, the support 12 can prevent a surface of the display portion 13 from being damaged. In the state illustrated in FIG. 1A1, the surface of the display portion 23 and the surface of the display portion 13 may be in contact with each other. However, a gap is preferably provided between the surface of the display portion 13 and the surface of the display portion 23 such that these surfaces are not in contact with each other, in which case these surfaces can be prevented from being rubbed together and damaged.

In this configuration, the display portion 24 is preferably not covered with the support 12. In that case, the display portion 24 is visible to a user even in the state where the support 12 and the housing 22 are closed; thus, the user can see information displayed on the display portion 24. When the display portion 24 includes a touch sensor, an icon or the like displayed on the display portion 24 can be operated.

Examples of the information displayed on the display portion 24 include notification of an incoming e-mail, call, social networking service (SNS) message, or the like, the subject of an e-mail, an SNS message, or the like, the sender of an e-mail, an SNS message, or the like, the message, the date, the time, information on playing music or voice, the volume, the temperature, the battery level, the communication status, the reception strength of an antenna, and the status of downloading a file or the like. The display portion 24 may display icons associated with applications, icons associated with functions, operation buttons, a slider, or the like. Examples include icons associated with a function of adjusting the volume, a fast-forward function, and a fast-backward function during the replay of voice or music. As another example, an icon associated with a function of answering the call or placing the call on hold or a function of awaking the operation invalid state (the lock state) of the electronic device 20 or the system 10 may be displayed.

In the state where the support 12 and the housing 22 are closed, it is preferable that the display portion 23 and the display portion 13 not display an image. It is preferable that pixels in a portion of the display panel not be driven in the case where the display portion 23 and the display portion 24 are constituted by a single display panel. In the case where a display device including a backlight like a transmissive liquid crystal device is used as the display portion 23 or the display portion 13, it is preferable that the backlight not be driven. Power consumption can be significantly reduced by preventing a portion of the display portion that is not visible to a user from displaying an image (or from operating) when the support 12 and the housing 22 are closed.

In the configuration illustrated in FIG. 1B1, the display portion 23 can display an image functioning as a keyboard or a touch pad, for example. That is, when a portion of the display portion 23 functions as an input means and the display portion 13 functions as a main display portion, the system 10 can be used as a notebook-type computer or a game machine. Alternatively, when both the display portion 13 and the display portion 23 display text data, the system 10 can be used as a foldable electronic book reader. For example, the system 10 can be favorably used as a textbook or the like.

In the configuration illustrated in FIG. 1C1, the display portion 13 can function as an extended display. That is, the display portion 23 and the display portion 13 can display a large image that the electronic device 21 alone cannot display, or can separately display different images. Furthermore, the electronic device 21 and the display device 11 can separately display images associated with different applications to achieve multitasking.

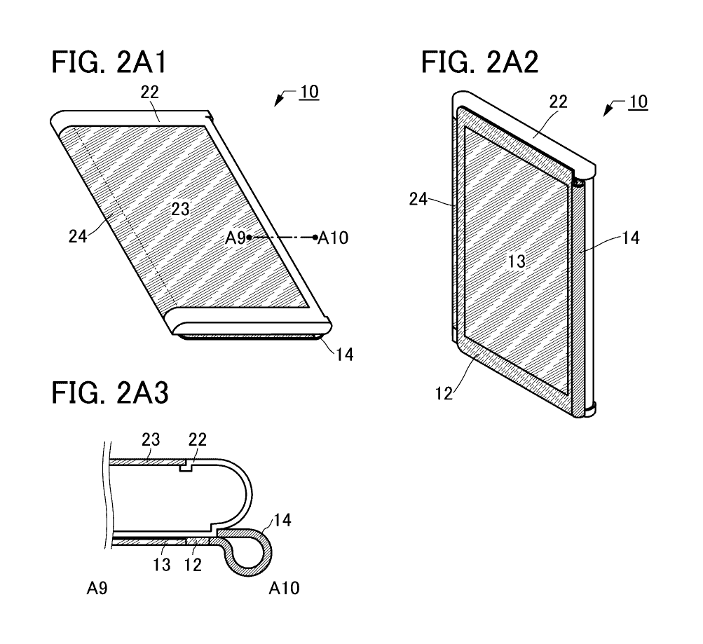

FIGS. 2A1 and 2A2 illustrate an example in which the display device 11 is folded to the side opposite to the display portion 23 side of the housing 22 (hereinafter also referred to as the back side or back surface side). FIG. 2A1 illustrates the display portion 23 side, and FIG. 2A2 illustrates the back side of the housing 22. FIG. 2A3 illustrates a cross-sectional schematic view taken along the section line A9-A10 in FIG. 2A1.

In such a configuration, an image can be displayed over two surfaces or three surfaces of the system 10. For example, when the display portion 23 and the display portion 13 display the same image, the same image can be shown to a user and a person facing the user. Alternatively, when the display portion 23 and the display portion 13 display different images, different images can be presented to a user and a person facing the user, which can be utilized for an application such as an interactive game.

Note that the above uses are mere examples, and images or the like that can be displayed on the display portions in each configuration are not limited to those given above. A variety of images for different applications can be displayed.

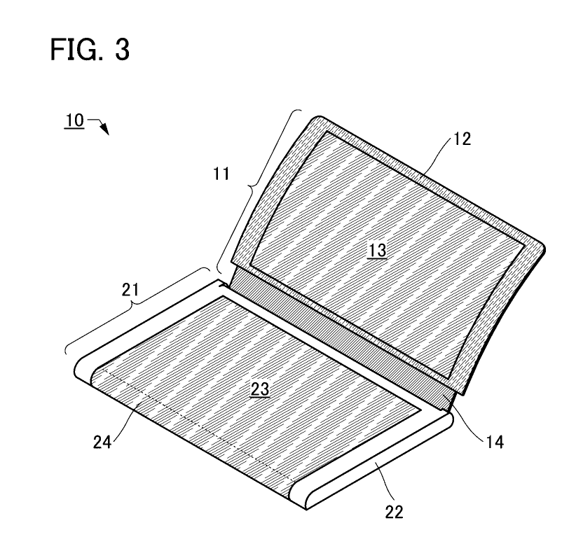

FIG. 3 illustrates an example in which the support 12 of the display device 11 is curved. In this example, the display portion 13 of the display device 11 can display an image over the curved surface.

FIG. 1A2 and the like illustrate a case where a side surface of the housing 22 on a side to which the connection portion 14 is attached has a convexly curved shape. The connection portion 14 and the housing 22 are attached to each other such that the connection portion 14 curves along the curved surface in the configuration where the support 12 and the housing 22 overlap with each other. This structure can prevent the relative positions of the support 12 and the housing 22 from being easily changed when the support 12 and the housing 22 overlap with each other. When the support 12 and the housing 22 are closed, two side surfaces of the system 10, i.e., a side surface on the display portion 24 side and a side surface on the connection portion 14 side, may be similarly curved and have substantially symmetrical shapes as illustrated in FIGS. 1A2 and 1A3. In that case, the system 10 with the display device 11 attached thereto can have a plainer (or simpler) design. It is preferable that a surface of the housing 22 have a recess into which the connection portion 14 fits so as not to generate a level difference between the surface of the connection portion 14 and the surface of the housing 22 in the state where the support 12 and the housing 22 overlap with each other.

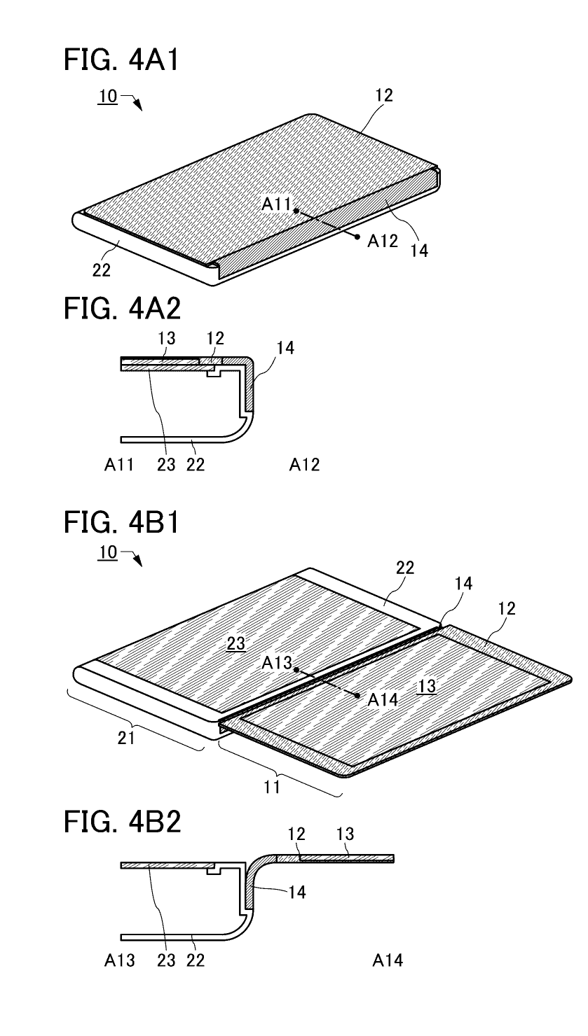

The side surface of the housing 22 on the side to which the connection portion 14 is attached may have a flat shape as illustrated in FIGS. 4A1, 4A2, 4B1, and 4B2. In that case, the connection portion 14 includes a portion that is bent along the surface of the housing 22 in the configuration where the housing 22 and the support 12 overlap with each other as illustrated in FIGS. 4A1 and 4A2. A connecting portion between the housing 22 and the connection portion 14 (here, an end portion of the connection portion 14) may be positioned on the display portion 23 side with respect to the back surface of the housing 22. In that case, a design can be made such that the height of the display portion 23 and the height of the display portion 13 are substantially equal to each other in the state where the housing 22 and the support 12 are opened as illustrated in FIG. 4B2.

A display panel which includes both a reflective liquid crystal element and a light-emitting element and can display an image both in a transmissive mode and in a reflective mode is preferably used as a display panel in the display portion 13 of the display device 11. Such a display panel can also be referred to as a transmissive OLED and reflective LC hybrid display (TR-hybrid display).

One example of such a display panel is a structure in which a liquid crystal element including an electrode that reflects visible light and a light-emitting element are stacked. In this structure, it is preferable that the electrode that reflects visible light have an opening and the opening overlap with the light-emitting element. This enables driving in the transmissive mode by which light is emitted from the light-emitting element through the opening. It is also preferable that a transistor for driving the liquid crystal element and a transistor included in the light-emitting element be positioned on the same plane. It is also preferable that the light-emitting element and the liquid crystal element be stacked with an insulating layer therebetween.

Such a display panel can be driven with extremely low power consumption by displaying an image in the reflective mode in a place with bright external light such as an outdoor space. At night or in a place with weak external light such an indoor space, the display panel can display an image with an optimal luminance by displaying the image in the transmissive mode. Furthermore, by displaying an image in both the transmissive and reflective modes, the display panel can display the image with less power consumption and a higher contrast than a conventional display panel even in a place with extremely bright external light.

The above-described display panel including both the light-emitting element and the liquid crystal element may be used as a display panel in the display portion 23 of the electronic device 21. The total power consumption of the system 10 including the display device 11 and the electronic device 21 can be significantly reduced. Therefore, the system 10 is favorable to an application such as a textbook which is used for a long time. The capacity of the battery in the electronic device 21 can be decreased, whereby the weight of the electronic device 21 can be significantly decreased. Therefore, the system 10 is favorable to an application such as a textbook which is daily used and carried around by a child.

Details of such a display panel will be described in Embodiment 2.

It is preferable that a module including a touch sensor be provided on the display surface side of the display panel in the display portion 23 and the display portion 24 so as to overlap with the display panel. At least a portion of the module including a touch sensor in the display portion 24 is preferably flexible to follow the bending of the display panel. The module including a touch sensor may be bonded to the display panel with an adhesive or the like. A polarizing plate or a cushion material (e.g., a separator) may be provided between the module and the display panel. The thickness of the module including a touch sensor is preferably smaller than or equal to that of the display panel.

Alternatively, the display panel in the display portion 23 and the display portion 24 may function as a touch panel. For example, the display panel may be an on-cell touch panel or an in-cell touch panel. In the case of using the on-sell or in-sell touch panel, the thickness of the display panel can be small even when the display panel also serves as a touch panel.

The display portion 13 does not necessarily have a function of a touch sensor. Even in that case, the display device 11 can function as an extended display of the electronic device 21 to improve display browsability.

The display portion 13 may have the above-described touch sensor function. The display portion 13 preferably has the function of the touch sensor because a region that a user can operate can be enlarged and therefore a more user-friendly application can be incorporated.

Examples of materials that can be used for the housing 22 include plastic, a metal such as aluminum, an alloy such as stainless steel or a titanium alloy, rubber such as silicone rubber, and the like.

In the case where the connection portion 14 is flexible, an elastically deformable material can be favorably used for part of or the whole of the connection portion 14. For example, the whole connection portion 14 may be elastic, or the connection portion 14 may contain an elastic material at least in a bending portion.

For example, a material with a Young's modulus lower than that of the housing 22 can be used for the connection portion 14. In the case where a material with a Young's modulus higher than or comparable to that of the housing 22 is used, the connection portion 14 is made thinner than the housing 22. Examples of materials that can be used to form the connection portion 14 include plastic, rubber, a metal, an alloy, and the like. Other examples include a silicone resin and a gel.

In the case where a hinge is used as the connection portion 14, a rigid material is preferably used for that part. For example, plastic, a metal such as aluminum, an alloy such as stainless steel or a titanium alloy, or the like is preferably used.

It is preferable to use a highly rigid material for the support 12 because a function of a protective cover can be enhanced. It is also preferable to use an elastic material for the support 12 because an impact can be relieved when the system 10 is dropped or the system 10 comes in contact with a hard object, for example. When the support 12 and the display panel in the display portion 13 are each flexible, the display portion 13 can display an image over a curved surface. A material that can be used for the support 12 can be selected as appropriate from materials that can be used for the housing 22 or the connection portion 14.

A variety of display panels can be used as the display portion 13, the display portion 23, and the display portion 24.

In the case where the display portion 13 and the support 12 are used in a bent state, a flexible display panel is preferably used in the display portion 13. Even in the case where the display portion 13 and the support 12 are not used in a bent state, the display device 11 can include a flexible display panel to reduce the weight of the display device 11. Accordingly, an increase in total weight of the system 10 can be suppressed even when the display device 11 is used.

In the case where the display portion 24 displays an image over a curved surface, a flexible display panel is preferably used in the display portion 24. It is preferable that a single flexible display panel be used in the display portion 23 and the display portion 24 and be partly curved in the display portion 24. In that case, the number of components of the electronic device 21 can be reduced, and the weight of the electronic device 21 can be decreased with the use of the flexible display panel.

Display panels or touch panels used in the display portion 23, the display portion 24, and the display portion 13 may include the same display elements or different display elements. For example, a touch panel including a liquid crystal element may be used in the display portion 23 and the display portion 24. Alternatively, a touch panel including a liquid crystal element may be used in the display portion 23, and a touch panel including an organic EL element may be used in the display portion 24.

Besides, for example, a display element such as a micro electro mechanical systems (MEMS) element or an electron-emissive element can be used in the display device. Examples of MEMS display elements include a MEMS shutter display element, an optical interference type MEMS display element, and the like. A carbon nanotube may be used for the electron-emissive element. Alternatively, electronic paper may be used. As the electronic paper, an element using a microcapsule method, an electrophoretic method, an electrowetting method, an Electronic Liquid Powder (registered trademark) method, or the like can be used.

For example, in this specification and the like, an active matrix method in which an active element is included in a pixel or a passive matrix method in which an active element is not included in a pixel can be used.

In an active matrix method, as an active element (a non-linear element), not only a transistor but also various active elements such as a metal insulator metal (MIM) and a thin film diode (TFD) can be used. Since these elements can be formed with a smaller number of manufacturing steps, manufacturing cost can be reduced or yield can be improved. Alternatively, since the size of these elements is small, the aperture ratio can be improved, so that power consumption can be reduced or higher luminance can be achieved.

Since an active element is not used in the passive matrix method, the number of manufacturing steps is small, so that manufacturing cost can be reduced or yield can be improved. Furthermore, since an active element is not used, the aperture ratio can be improved, so that power consumption can be reduced or higher luminance can be achieved, for example.

The above is the description of Structural example 1.

### Structural Example 2

A structural example partly different from Structural example 1 described above will be described below. Note that description of the portions already described is omitted and different portions are described.

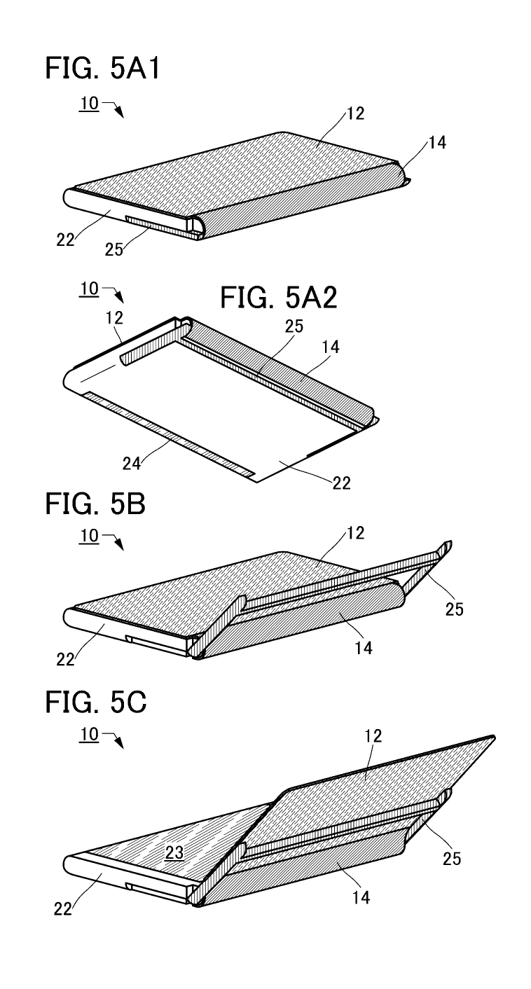

FIGS. 5A1, 5A2, 5B, and 5C are perspective schematic views of a system 10 described as an example below. The system 10 illustrated in FIGS. 5A1 to 5C differs from that in Structural example 1 mainly in including a support mechanism 25.

FIGS. 5A1 and 5A2 illustrate a state in which the housing 22 and the support 12 are closed. FIG. 5A1 illustrates the support 12 side, and FIG. 5A2 illustrates the back surface side of the housing 22.

The housing 22 includes the support mechanism 25. As illustrated in FIGS. 5A1 and 5A2, the support mechanism 25 is preferably stored in the housing 22 when not in use. For example, a portion of a surface of the housing 22 and a portion of a surface of the support mechanism 25 are made to be positioned on the same plane when the support mechanism 25 is stored in the housing 22. In that case, the electronic device 21 can have an excellent design and can be put in a bag or a pocket without getting stuck. In addition, when the housing 22 and the support mechanism 25 are integrated, the support mechanism 25 does not need to be carried around separately from the electronic device 21, leading to improved convenience.

FIG. 5B illustrates a state in which the support mechanism 25 is pulled out from the housing 22. FIG. 5C illustrates a state in which the support 12 is opened.

The support mechanism 25 has a function of supporting a portion of a surface of the support 12 on the side opposite to the display portion 13. In other words, the support mechanism 25 has a function of supporting the support 12 such that a surface of the display portion 23 of the electronic device 21 and a surface of the display portion 13 of the display device 11 are at a predetermined angle. The support mechanism 25 described above can stabilize the position of the support 12 as compared with the configuration illustrated in FIG. 1B1 or FIG. 3, for example. Even when the connection portion 14 does not include a hinge mechanism, for example, the relative positions of the housing 22 and the support 12 can be fixed.

The support mechanism 25 preferably includes a mechanism capable of locking the relative positions of the support 12 and the housing 22 at one or more stable position (this mechanism is also referred to as a lock mechanism) and a mechanism capable of releasing the lock. It is particularly preferable that the lock mechanism have two or more stable positions. With such a mechanism, a user can adjust the angle according to his or her preference.

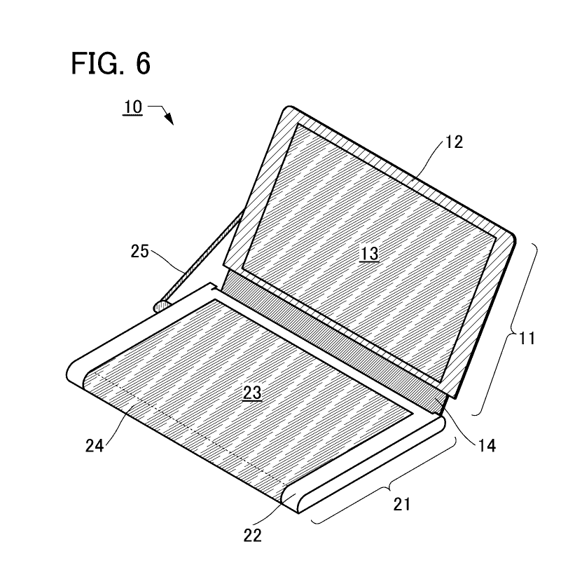

Note that the structure of the support mechanism 25 is not particularly limited as long as the mechanism can support the support 12. For example, FIG. 6 illustrates an example of a structure of the support mechanism 25 capable of supporting one end portion of the support 12. The support mechanism 25 is attached to the housing 22 and has a rotating function. Thus, the support 12 can be supported in a state where the support 12 and the housing 22 are opened at a given angle.

The above is the description of Structural example 2.

### Structural Example 3

A structural example partly different from the above structural examples will be described below. Note that description of the portions already described is omitted and different portions are described.

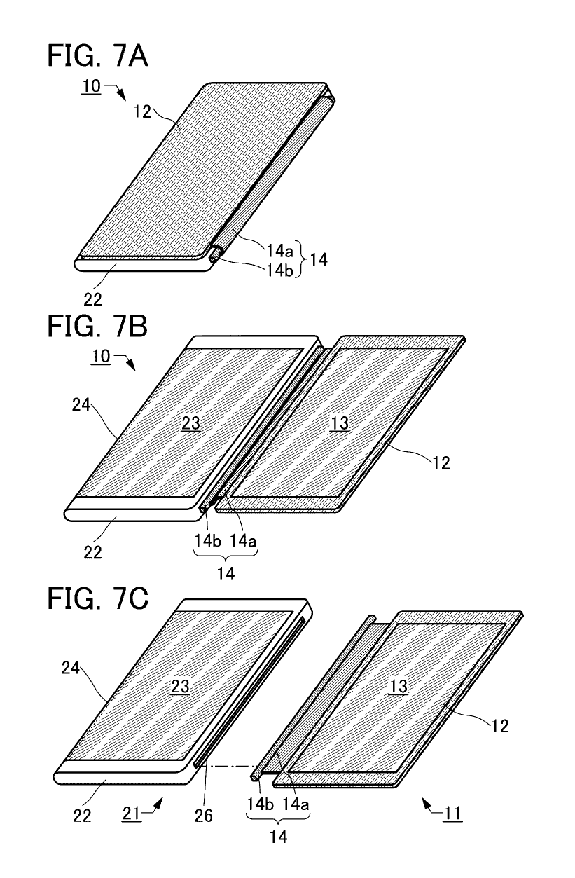

FIGS. 7A to 7C are perspective schematic views of a system 10 described as an example below. The system 10 illustrated in FIGS. 7A to 7C differs from those described above mainly in the structure of the connection portion 14.

FIG. 7A illustrates a state in which the housing 22 and the support 12 are closed. FIG. 7B illustrates a state in which they are opened. FIG. 7C illustrates a state in which the electronic device 21 and the display device 11 are separated from each other.

The connection portion 14 of the display device 11 illustrated in FIGS. 7A to 7C includes a movable portion 14a and a detachment portion 14b.

The movable portion 14a has a function of connecting the detachment portion 14b and the support 12 to each other. The movable portion 14a also has a function of bending in a manner similar to that of the connection portion 14 in the above structural example.

The housing 22 includes an engagement portion 26 which engages with the detachment portion 14b. Accordingly, the display device 11 can be detachably attached to the electronic device 21. The engagement portion 26 and the detachment portion 14b may include a mechanism capable of locking each other mechanically so that these components attached to each other are not easily detached from each other.

The engagement portion 26 preferably includes a terminal for transmitting power or a signal from the housing 22 to the display device 11. The detachment portion 14b preferably includes a terminal for receiving the signal. The terminal of the engagement portion 26 and the terminal of the detachment portion 14b can be provided so as to be in contact with each other when the display device 11 is attached to the electronic device 21.

Alternatively, the housing 22 may include an antenna for transmitting the power or the signal in a position close to the engagement portion 26, and the detachment portion 14b may include an antenna for receiving the power or the signal, in order to wirelessly supply the power or the signal from the electronic device 21 to the display device 11.

In the housing 22, the terminal for transmitting power and a signal or the antenna and a circuit for wirelessly transmitting them can be referred to as a transmission portion. The terminal provided in the connection portion 14 for receiving power and a signal or the antenna and a circuit for wirelessly receiving them can be referred to as a reception portion.

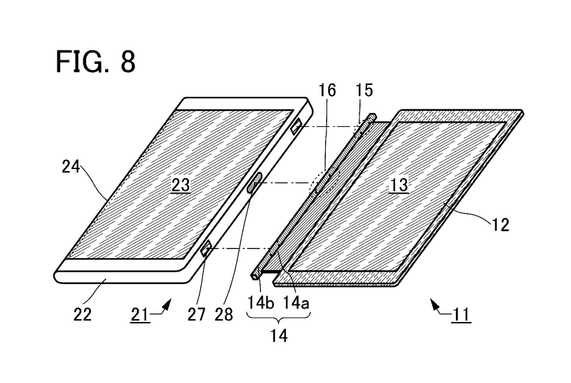

FIG. 8 illustrates a configuration in which the housing 22 includes a connection portion 27 and a terminal 28 instead of the engagement portion 26. The detachment portion 14b includes a connection portion 15 and a terminal 16.

It is preferable that the connection portion 27 and the connection portion 15 be magnetically connectable to each other. For example, a magnet or the like may be provided in one of the connection portions 27 and 15, and a magnetic metal or a soft magnetic material that can be magnetized by the magnet or the like may be provided in the other. Alternatively, an electromagnet may be used.

The terminal 28 and the terminal 16 are electrically connected to each other when the detachment portion 14b and the housing 22 are connected to each other, and through these terminals, power or a signal can be transmitted and received between the housing 22 and the display device 11. As the terminal 28 and the terminal 16, the above-described antennas may be used to wirelessly transmit and receive power or a signal.

The above is the description of Structural example 3.

### Structural Example 4

A structural example partly different from the above structural examples will be described below. Note that description of the portions already described is omitted and different portions are described.

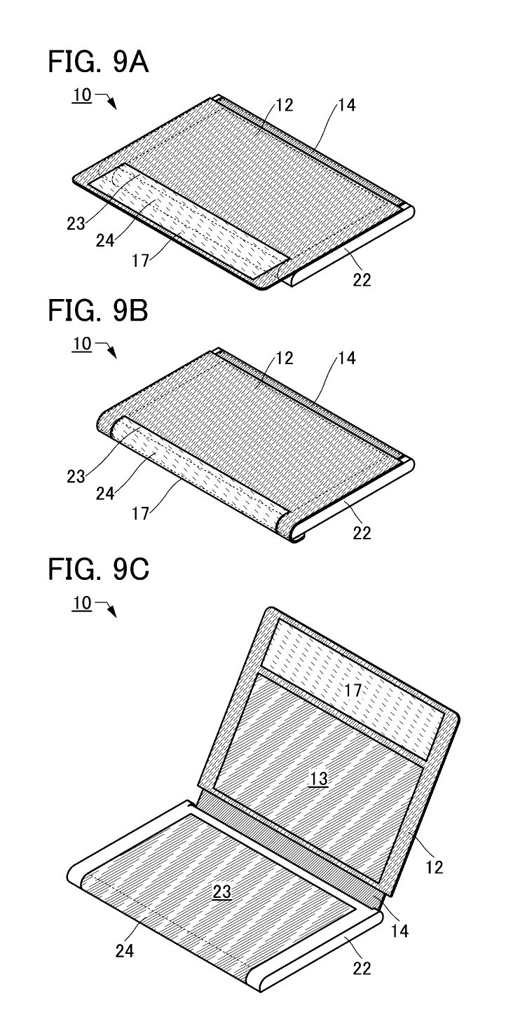

FIGS. 9A to 9C are perspective schematic views of a system 10 described as an example below. The system 10 illustrated in FIGS. 9A to 9C differs from those described above mainly in the structure of the support 12.

The support 12 includes a window portion 17 which transmits visible light. The window portion 17 is provided at an end opposite to the connection portion 14 with the display portion 13 therebetween.

A portion provided with the window portion 17 in the support 12 is flexible. Accordingly, in the state where the housing 22 and the support 12 are closed as illustrated in FIG. 9A, a side surface of the housing 22 can be covered with the window portion 17 as illustrated in FIG. 9B. Therefore, the window portion 17 can function as a protective cover for protecting a surface of the display portion 24 provided at the side surface of the housing 22.

Since the window portion 17 transmits visible light, a user can see the display portion 24 even in the state where the side surface of the housing 22 is covered with the window portion 17 as illustrated in FIG. 9B. In the case where the display portion 24 has a function of a touch panel, a user can operate the display portion 24 with the window portion 17 therebetween.

A material of the window portion 17 is not particularly limited as long as the material transmits visible light and is flexible. For example, a resin, glass that is thin enough to have flexibility, or the like can be used. In the case of using a resin, a surface thereof is preferably subjected to hard-coating treatment or the like because the surface can be prevented from being damaged easily.

A light-transmitting display panel can also be used in the window portion 17. For example, a display panel having a see-through function with a light-transmitting material used for a wiring of a pixel can be used. This enables the window portion 17 to be used as a display portion in a state where the housing 22 and the support 12 are opened as illustrated in FIG. 9C, and thus enables a display region to be enlarged. The window portion 17 may have a function of a touch sensor.

The window portion 17 can protect the surface of the display portion 24 by being bent along the display portion 24 also in the case where the support 12 is located on the back surface side of the housing 22.

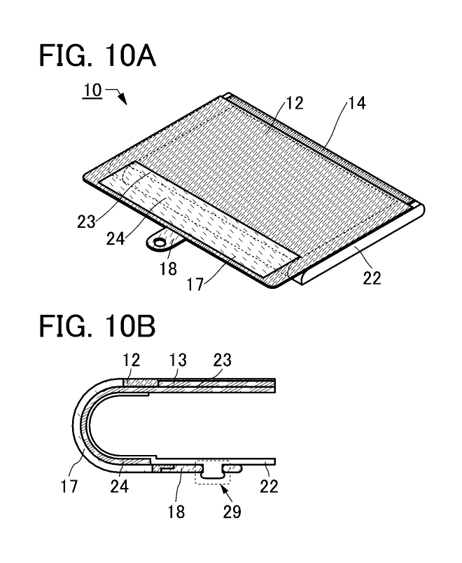

FIGS. 10A and 10B illustrate a structure including a fastener 18 at an end of the support 12 which is opposite to the connection portion 14. FIG. 10B is a cross-sectional schematic view in a state where one end of the support 12 is fixed to the housing 22 with the fastener 18.

The fastener 18 has, for example, an opening as illustrated in FIG. 10A. A projection 29 configured to engage with the opening of the fastener 18 is provided on the back surface side of the housing 22 as illustrated in FIG. 10B. In this manner, the fastener can fix the support 12 and the housing 22 in a closed state.

Note that the structure of the fastener 18 is not limited to this example, and for example, the support 12 and the housing 22 may be magnetically fastened to each other. In that case, the fastener 18 which projects from the support 12 as illustrated in FIG. 10A may be provided, or overlapping portions of the support 12 and the housing 22 may be magnetically fixed to each other so as to be detachable.

The above is the description of Structural example 4.

### Structural Example 5

A structural example partly different from the above structural examples will be described below. Note that description of the portions already described is omitted and different portions are described.

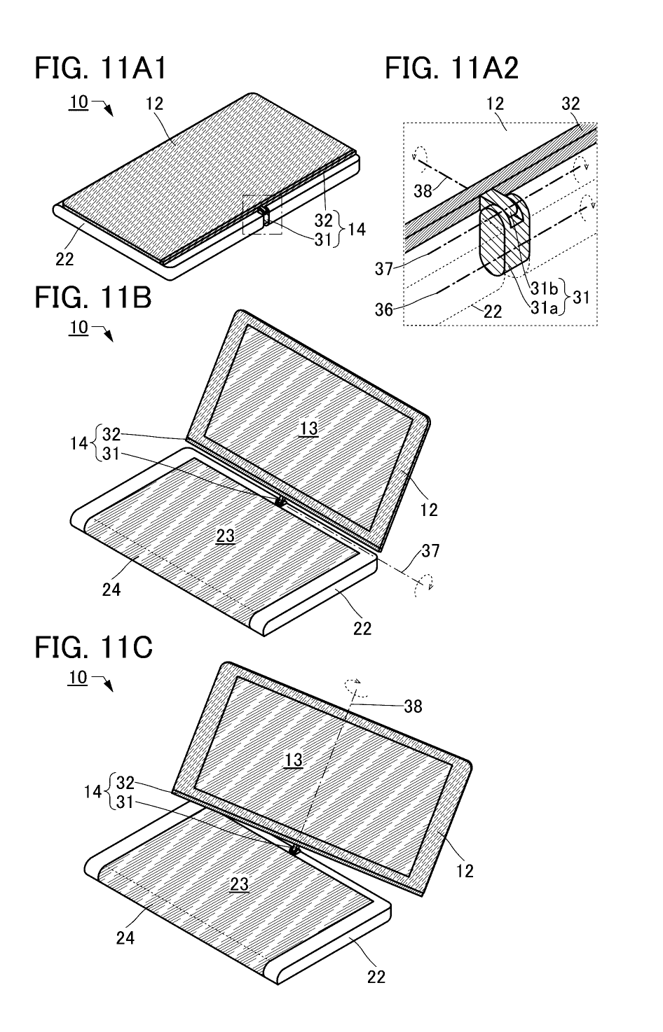

FIGS. 11A1, 11A2, 11B, and 11C are perspective schematic views of a system 10 described as an example below. The system 10 illustrated in FIGS. 11A1 to 11C differs from those described above mainly in the structure of the connection portion 14.

The connection portion 14 includes a hinge 31 and a rigid portion 32.

The rigid portion 32 has a function of connecting the hinge 31 and the support 12 to each other. In the case where a flexible material is used for the support 12, a material that is more rigid than that of the support 12 is preferably used for the rigid portion 32. In the case where the support 12 has rigidity, a portion of the support 12 may function as the rigid portion 32.

FIG. 11A2 is an enlarged view of a region surrounded by a dashed dotted line in FIG. 11A1. In FIG. 11A2, the support 12 and the housing 22 are illustrated as being transparent.

The hinge 31 includes a first portion 31a and a second portion 31b. The first portion 31a and the housing 22 are attached to each other so as to be rotatable on a rotation axis 36. The first portion 31a and the second portion 31b are attached to each other so as to be rotatable on a rotation axis 37. The second portion 31b and the rigid portion 32 are attached to each other so as to be rotatable on a rotation axis 38.

The rotation axis 36 and the rotation axis 37 are preferably parallel to each other. The rotation axis 38 and the rotation axis 37 are preferably perpendicular to each other.

Such a structure including the hinge 31 with two or more rotation axes as the connection portion 14 can improve the degree of freedom in terms of the relative positions of the housing 22 and the display device 11.

FIG. 11B illustrates an example in which the support 12 is rotated with respect to the housing 22 on the rotation axis 37 from the state illustrated in FIG. 11A1. The hinge 31 allows a reversible change in shape from the state in which the housing 22 and the support 12 are closed to the state in which they are opened.

FIG. 11C illustrates an example in which the support 12 is rotated on the rotation axis 38 from the state illustrated in FIG. 11B. In this manner, the hinge 31 enables the support 12 to be rotated not only in a folding direction but also in a direction crossing the folding direction, and enables the orientation of the support 12 to be adjusted according to user's preference.

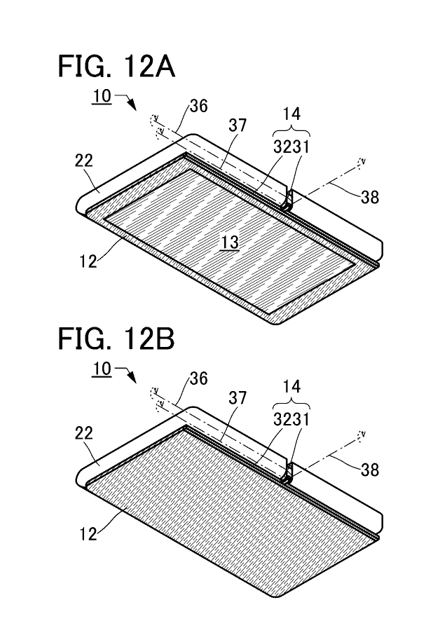

FIG. 12A illustrates a state in which the support 12 is rotated on the rotation axis 36 and the rotation axis 37 from the state illustrated in FIG. 11B and is positioned on the back surface side of the housing 22.

FIG. 12B illustrates a state in which the support 12 is rotated on the rotation axis 38 and is thereby positioned such that the display portion 13 of the support 12 and the back surface of the housing 22 face each other. In this state, the display portion 13 can be protected by the support 12 even in the case where the support 12 is positioned on the back surface side of the housing 22.

The connection portion 14 including the hinge 31 and the rigid portion 32 is preferably configured to enable power or a signal to be transmitted and received between the electronic device 21 and the display device 11. For example, this can be achieved by providing a wiring or the like inside the hinge 31. Alternatively, wireless power or signal transmission and reception may be achieved by providing an antenna in the housing 22 and providing an antenna in the rigid portion 32 or the support 12.

Note that the hinge 31 and the rigid portion 32 are described as part of the display device 11 in the system 10 described here as an example, but can be regarded as part of the electronic device 21. Alternatively, the system 10 can be regarded as including the display device 11 that includes the support 12, the electronic device 21 that includes the housing 22, and a connection device that includes the hinge 31.

The above is the description of Structural example 5.

### Modification Examples

Modification examples in which the structure of the electronic device 21 is partly different will be described below.

In each of the above-described structural examples, the side surface of the housing 22 of the electronic device 21 has a convexly curved surface and the display portion 24 is provided to the back surface side of the housing 22 along the convexly curved surface. The structure of the display portion 24 is not limited to this example, and the display portion 24 may be provided over a flat surface. Furthermore, the display portion 24 is not necessarily provided to the back surface side of the housing 22, and may have an end portion at a portion of the side surface of the housing 22.

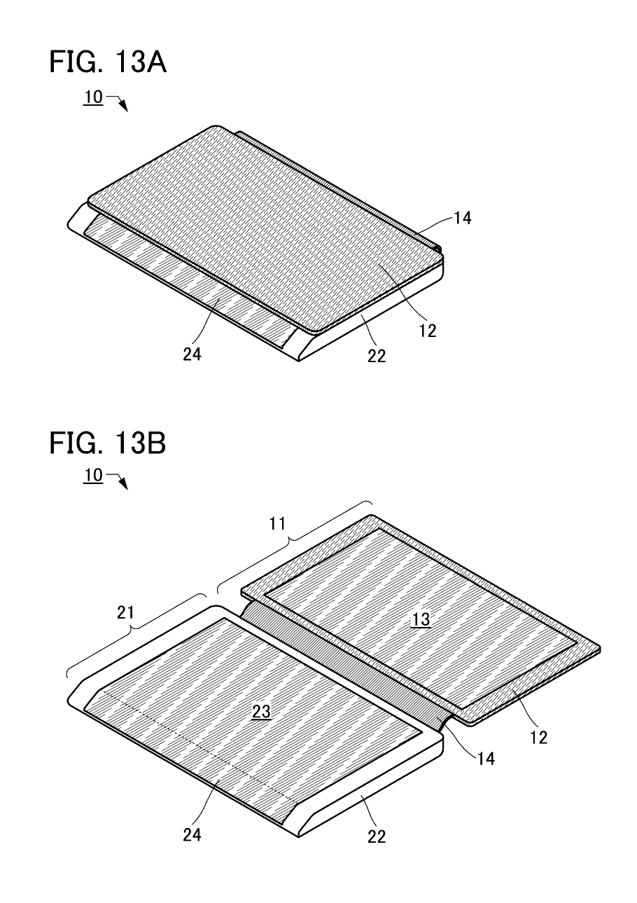

FIGS. 13A and 13B illustrate an example in which a portion of the housing 22 in which the display portion 24 is provided has a flat surface. FIGS. 13A and 13B illustrate a case in which a plane parallel to the display portion 23 and a plane parallel to a portion of the display portion 24 are not parallel to each other. The display portion 23 and the display portion 24 are connected at the boundary therebetween, and the display portion 23 and the display portion 24 can display a continuous image.

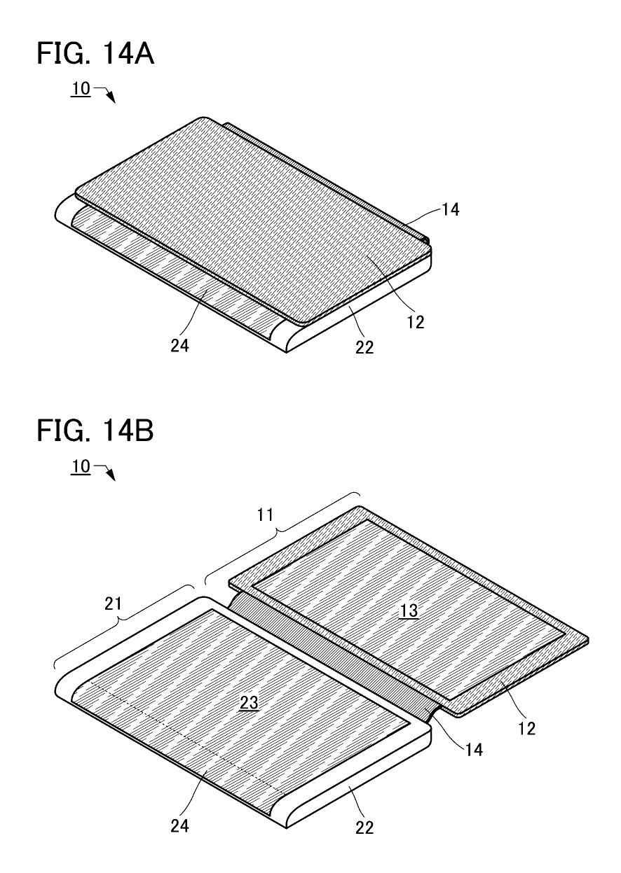

FIGS. 14A and 14B illustrate an example in which an end portion of the display portion 24 is positioned at a portion of the side surface of the housing 22 without reaching the back surface of the housing 22. In the example illustrated in FIGS. 14A and 14B, the display portion 24 can display an image over a curved surface.

In the above-described example, the display portion 23 and the display portion 24 form a seamless and continuous display portion. However, these display portions do not necessarily form a continuous display portion, and a non-display portion may be provided between these two display portions.

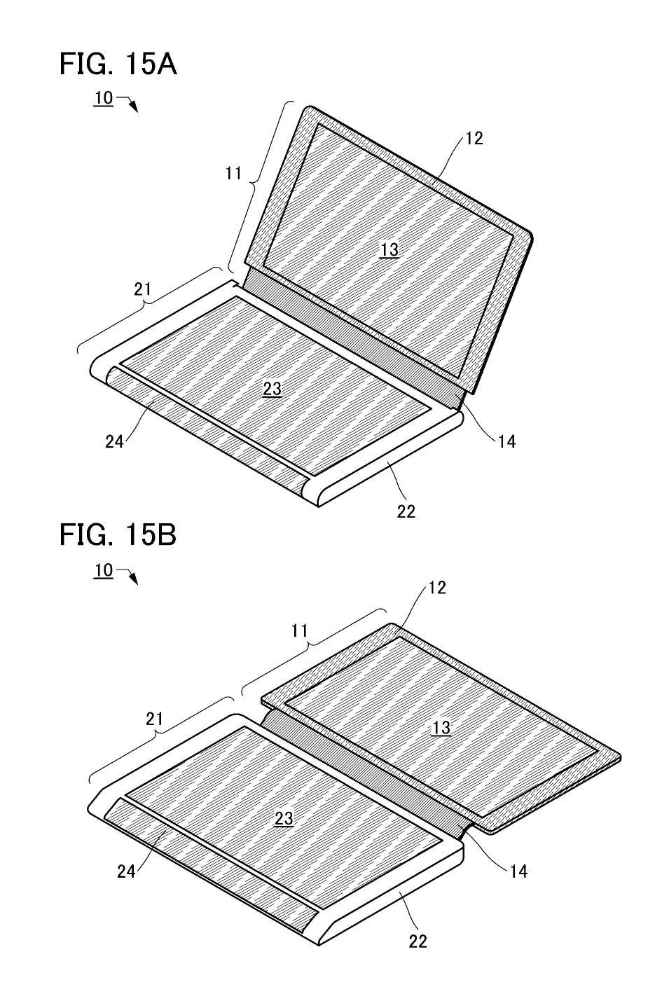

FIG. 15A illustrates an example of the structure illustrated in FIGS. 1A1 to 1C2 in which the display portion 23 and the display portion 24 do not form a continuous display portion. In this example, the display portion 23 and the display portion 24 may include different display panels. For example, a display panel having low flexibility or no flexibility can be used in the display portion 23, and a display panel having higher flexibility than the display panel used in the display portion 23 can be used in the display portion 24.

FIG. 15B illustrates an example of the structure illustrated in FIGS. 13A and 13B in which the display portion 23 and the display portion 24 do not form a continuous display portion. In the structure illustrated in FIG. 15B, the display portion 23 and the display portion 24 can each display an image over a flat surface. In this example, a display panel having low flexibility or no flexibility can be used in each of the display portions 23 and 24.

The display portion 24 can be variously configured as long as it covers a portion of the side surface of the housing 22.

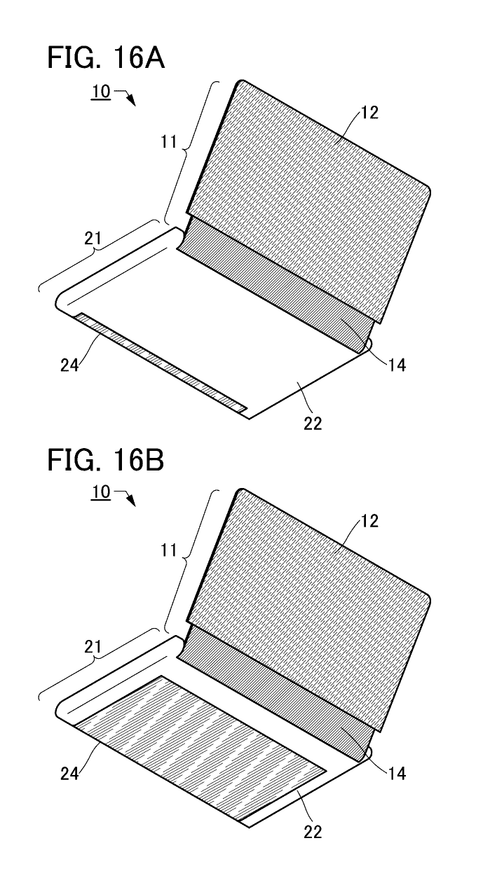

FIG. 16A is a perspective view of the configuration illustrated in FIG. 1B1 which is seen from the back surface side of the housing 22. As illustrated, the display portion 24 can be provided so as to reach a portion of the back surface of the housing 22. FIG. 16B illustrates an example in which the display portion 24 covers a large area of the back surface of the housing 22. In the example illustrated in FIG. 16B, an end portion of the display portion 24 is positioned so as to be close to the connection portion 14 beyond the middle of the back surface of the housing 22.

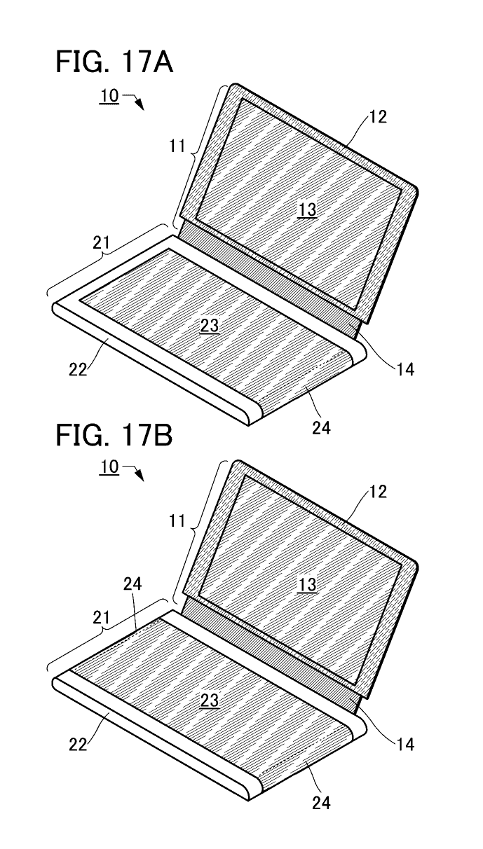

Although the display portion 24 is provided over the side surface on a longer side of the housing 22 in the above-described examples, the display portion 24 may be provided over a side surface on a shorter side of the housing 22 as illustrated in FIG. 17A. Furthermore, the display portion 24 may be provided over two or more side surfaces of the housing 22 as illustrated in FIG. 17B.

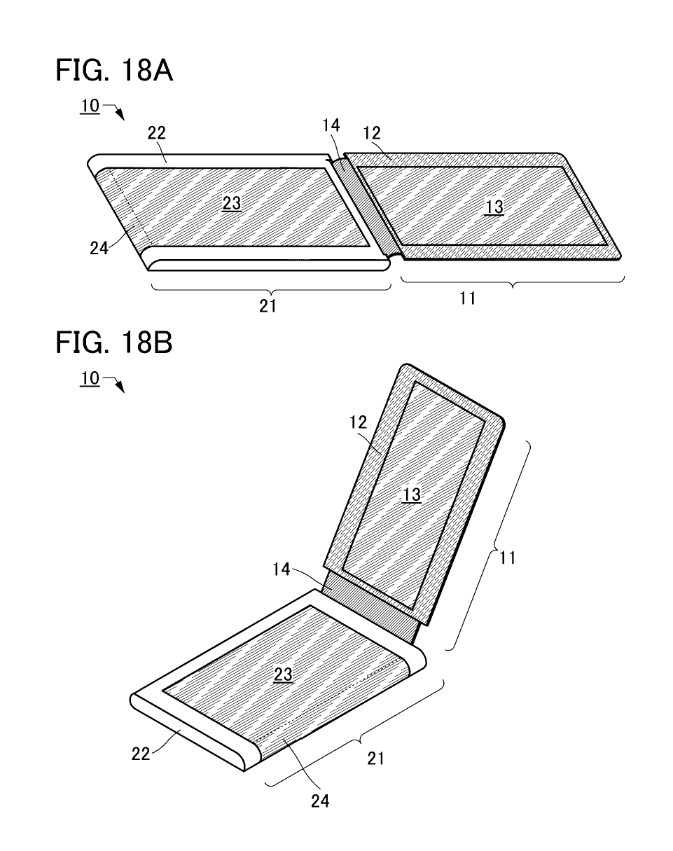

Although the connection portion 14 of the display device 11 is attached on the longer side of the housing 22 in the above-described examples, the position at which the connection portion 14 is attached is not limited. For example, the connection portion 14 may be attached to a side surface on the shorter side of the housing 22 as illustrated in FIGS. 18A and 18B. FIG. 18A illustrates an example in which the display portion 24 is provided over a side surface on the shorter side of the housing 22. FIG. 18B illustrates an example in which the display portion 24 is provided over a side surface on the longer side of the housing 22.

Note that it is needless to say that the structure of the display device 11 in the system 10 described as a modification example is not limited to those described above and can be replaced with any of the structures described in the above structural examples. Furthermore, the structure of the housing 22 can be changed as appropriate depending on the structure of the connection portion 14 of the display device 11.

The above is the description of the modification examples.

### [Hardware Configuration Examples of System]

Hardware configuration examples of the electronic device 21 and the display device 11 included in the system 10 will be described below with reference to drawings.

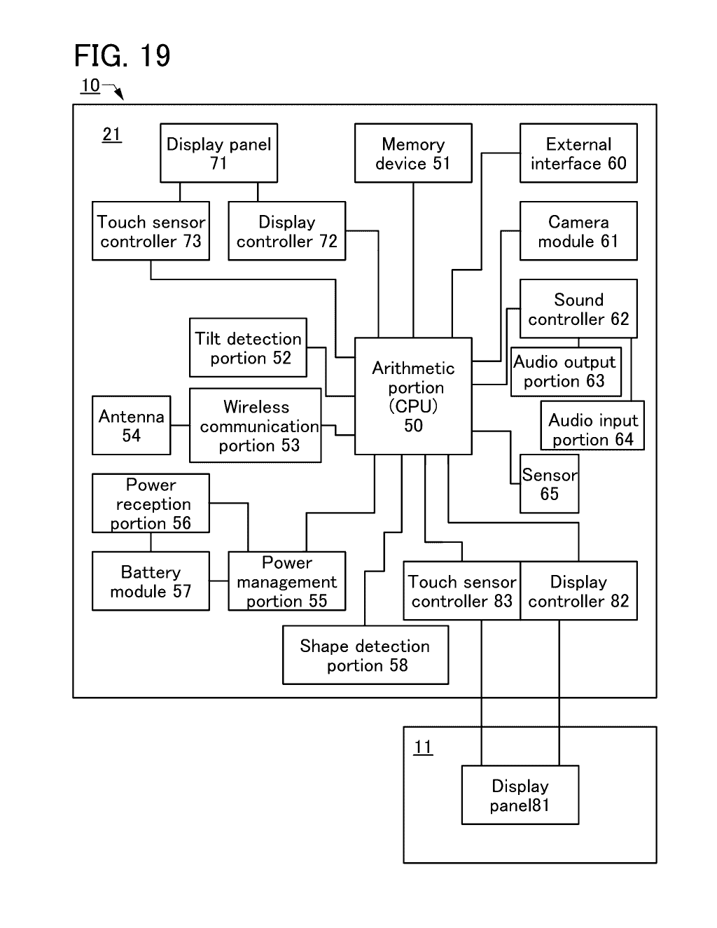

FIG. 19 is a block diagram illustrating a configuration example of the system 10. The system 10 includes the display device 11 and the electronic device 21.

Although a block diagram attached to this specification shows elements classified according to their functions in independent blocks, it may be practically difficult to completely separate the elements according to their functions and, in some cases, one element may be involved in a plurality of functions.

The electronic device 21 includes an arithmetic portion (CPU) 50, a memory device 51, a tilt detection portion 52, a wireless communication portion 53, an antenna 54, a power management portion 55, a power reception portion 56, a battery module 57, a shape detection portion 58, an external interface 60, a camera module 61, a sound controller 62, an audio output portion 63, an audio input portion 64, a sensor 65, a display panel 71, a display controller 72, a touch sensor controller 73, a display controller 82, a touch sensor controller 83, and the like.

The display device 11 includes a display panel 81.

Note that the configurations of the system 10, the electronic device 21, and the display device 11 illustrated in FIG. 19 are mere examples, and the system 10, the electronic device 21, and the display device 11 do not need to include all the components. The system 10, the electronic device 21, and the display device 11 include necessary components among the components illustrated in FIG. 19 and may include a component other than the components in FIG. 19.

The arithmetic portion 50 can function as a central processing unit (CPU), and has a function of controlling components such as the memory device 51, the tilt detection portion 52, the wireless communication portion 53, the power management portion 55, the shape detection portion 58, the external interface 60, the camera module 61, and the sound controller 62.

Signals are transmitted between the arithmetic portion 50 and the components via a system bus. The arithmetic portion 50 is configured to process signals input from the components which are connected through the system bus and to generate signals to be output to the components, so that the components connected to the system bus can be controlled comprehensively.

Note that a transistor which includes an oxide semiconductor in a channel formation region and has an extremely low off-state current can be used in the arithmetic portion 50. With the use of the transistor having an extremely low off-state current as a switch for holding electric charge (data) which flows into a capacitor serving as a memory element, a long data retention period can be ensured. By utilizing this characteristic for a register or a cache memory of the arithmetic portion 50, normally off computing is achieved where the arithmetic portion 50 operates only when needed and data on the previous processing is stored in the memory element in the rest of time; thus, power consumption of the electronic device 21 can be reduced.

A microprocessor such as a digital signal processor (DSP) or a graphics processing unit (GPU) can be used in addition to the CPU as the arithmetic portion 50. Furthermore, such a microprocessor may be obtained with a programmable logic device (PLD) such as a field programmable gate array (FPGA) or a field programmable analog array (FPAA). The arithmetic portion 50 interprets and executes instructions from various programs with the processor to process various kinds of data and control programs. The programs executed by the processor may be stored in a memory region of the processor or in the memory device 51.

The arithmetic portion 50 may include a main memory. The main memory can include a volatile memory, such as a random access memory (RAM), and a nonvolatile memory, such as a read only memory (ROM).

For example, a dynamic random access memory (DRAM) is used for the RAM included in the main memory, in which case a memory space as a workspace for the arithmetic portion 50 is virtually allocated and used. An operating system, an application program, a program module, program data, and the like which are stored in the memory device 51 are loaded into the RAM and executed. The data, program, and program module which are loaded into the RAM are directly accessed and operated by the arithmetic portion 50. Moreover, characteristic data for calculating the position of the electronic device 21 and the relative positional relationship between the electronic device 21 and the display device 11 from the data input from the tilt detection portion 52 and the shape detection portion 58 may be read out from the memory device 51 as a lookup table and stored in the main memory.

In the ROM, a basic input/output system (BIOS), firmware, and the like for which rewriting is not needed can be stored. As the ROM, a mask ROM, a one-time programmable read only memory (OTPROM), or an erasable programmable read only memory (EPROM) can be used. As an EPROM, an ultra-violet erasable programmable read only memory (UV-EPROM) which can erase stored data by irradiation with ultraviolet rays, an electrically erasable programmable read only memory (EEPROM), a flash memory, and the like can be given.

Examples of the memory device 51 are a memory media drive such as a hard disk drive (HDD), or a solid state drive (SSD); a memory device including a nonvolatile memory element, such as a flash memory, a magnetoresistive random access memory (MRAM), a phase change RAM (PRAM), a resistive RAM (ReRAM), or a ferroelectric RAM (FeRAM); a memory device including a volatile memory element such as a dynamic RAM (DRAM) or a static RAM (SRAM).

As the memory device 51, a memory device which can be connected and disconnected through the external interface 60 with a connector, such as an HDD or an SSD; or a memory media drive, such as a flash memory, a Blu-ray disc, or a DVD can be used. Note that the memory device 51 is not necessarily incorporated in the electronic device 21, and a memory device outside the electronic device 21 may be used as the memory device 51. In this case, the memory device may be connected through the external interface 60, or data transmission and reception may be wirelessly performed using the wireless communication portion 53.

The tilt detection portion 52 has a function of detecting a tilt, a posture, and the like of the electronic device 21. For example, an acceleration sensor, an angular velocity sensor, a vibration sensor, a pressure sensor, a gyroscope sensor, or the like can be used for the tilt detection portion 52. Alternatively, these sensors may be combined to be used.

The wireless communication portion 53 can communicate via the antenna 54. For example, the wireless communication portion 53 controls a control signal for connecting the electronic device 21 to a computer network according to instructions from the arithmetic portion 50 and transmits the signal to the computer network. Accordingly, communication can be performed by connecting the electronic device 21 to a computer network such as the Internet (which is an infrastructure of the World Wide Web (WWW)), an intranet, an extranet, a personal area network (PAN), a local area network (LAN), a campus area network (CAN), a metropolitan area network (MAN), a wide area network (WAN), or a global area network (GAN). When a plurality of communication methods are used, the electronic device 21 may have a plurality of antennas 54 for the communication methods.

For example, a high frequency circuit (an RF circuit) is included in the wireless communication portion 53 for receiving and transmitting an RF signal. The RF circuit performs conversion between an electromagnetic signal and an electric signal in a frequency band which is set by a national law, and performs communication with another communication device wirelessly with the use of the electromagnetic signal. Several tens of kilohertz to several tens of gigahertz are a practical frequency band which is generally used. The RF circuit includes an RF circuit portion and an antenna which are compatible with a plurality of frequency bands; the RF circuit portion can include an amplifier, a mixer, a filter, a DSP, an RF transceiver, or the like. In the case of performing wireless communication, it is possible to use, as a communication protocol or a communication technology, a communications standard such as Global System for Mobile Communication (GSM) (registered trademark), Enhanced Data Rates for GSM Evolution (EDGE), Code Division Multiple Access 2000 (CDMA2000), or Wideband Code Division Multiple Access (W-CDMA) (registered trademark), or a communications standard developed by IEEE such as Wireless Fidelity (Wi-Fi) (registered trademark), Bluetooth (registered trademark), or ZigBee (registered trademark).

In the case of using the electronic device 21 as a telephone, the wireless communication portion 53 controls a connection signal according to instructions from the arithmetic portion 50 and transmits the signal to the telephone line. The connection signal is a signal for connecting the electronic device 21 to the telephone line.

The power management portion 55 can manage a charge state of the battery module 57. In addition, the power management portion 55 supplies power from the battery module 57 to the components. The power reception portion 56 has a function of receiving power supplied from the outside and charging the battery module 57. The power management portion 55 can control the operation of the power reception portion 56 depending on the charge state of the battery module 57.

The battery module 57 includes one or more primary batteries or secondary batteries, for example. In the case of indoor use or the like, an alternating-current (AC) power supply may be used as an external power supply. Particularly in the case of using the electronic device 21 separately from the external power supply, it is favorable that the battery module 57 have a large charge/discharge capacity which allows the electronic device 21 to be used for a long time. The battery module 57 may be charged using a battery charger separated from the electronic device 21. At this time, charging may be performed through wires using an AC adaptor; alternatively, charging may be performed by a wireless power feeding method such as an electric field coupling method, an electromagnetic induction method, or an electromagnetic resonance (electromagnetic resonant coupling) method. Examples of the secondary battery which can be used for the battery module 57 include a lithium ion secondary battery and a lithium ion polymer secondary battery.

The power management portion 55 may include a battery management unit (BMU), for example. The BMU collects data on cell voltage or cell temperatures of the battery, monitors overcharge and overdischarge, controls a cell balancer, handles a deterioration state of the battery, calculates the remaining battery power level (state of charge: SOC), and controls detection of a failure, for example.

The power management portion 55 controls power transmission from the battery module 57 to the components through the system bus or a power supply line. The power management portion 55 can include a power converter with a plurality of channels, an inverter, a protection circuit, and the like.

The power management portion 55 preferably has a function of reducing power consumption. For example, after detection of no input to the electronic device 21 for a given period, the power management portion 55 lowers clock frequency or stops input of clocks of the arithmetic portion 50, stops operation of the arithmetic portion 50 itself, or stops operation of the auxiliary memory, thereby controlling power supply to the components and reducing power consumption. Such a function is performed with the power management portion 55 alone or the power management portion 55 interlocking with the arithmetic portion 50.

The shape detection portion 58 has a function of detecting the relative positional relationship between the display device 11 and the electronic device 21 and outputting the data to the arithmetic portion 50 via the system bus. In the case where the display device 11 and the electronic device 21 are detachable from each other, the shape detection portion 58 may have a function of detecting data on whether or not the display device 11 is connected to the electronic device 21 and outputting the data to the arithmetic portion 50. Although the shape detection portion 58 is illustrated in FIG. 19 as being included in the electronic device 21, at least a portion of the shape detection portion 58 may be provided in the display device 11 in some cases depending on the structure of the shape detection portion 58.

As the shape detection portion 58, a sensor similar to that in the tilt detection portion 52 can be provided in the display device 11. When data on the posture of the display device 11 is input from the shape detection portion 58 to the arithmetic portion 50 via the system bus, the arithmetic portion 50 can calculate the relative positional relationship between the electronic device 21 and the display device 11 from the data on the posture of the electronic device 21 detected by the tilt detection portion 52 and the data on the posture of the display device 11.

Alternatively, a sensor for detecting the curved shape of the connection portion 14 can be used as the shape detection portion 58. When such a sensor is used, a plurality of acceleration sensors or the like may be provided in, for example, the connection portion 14 so that the arithmetic portion 50 can calculate the shape of the connection portion 14 from change in acceleration at each position. Alternatively, a sensor including a piezoelectric element may be provided in the connection portion 14 so that bending can be detected. Alternatively, a sensor whose physical characteristics, such as resistivity, thermal conductivity, and transmissivity, change with a curving may be incorporated in the connection portion 14 so that the shape of the connection portion 14 can be calculated from change of the physical characteristics.

In the case where a hinge is included as the connection portion 14, the rotation angle of the hinge on each rotation axis can be measured mechanically, optically, or electromagnetically.

The shape detection portion 58 may have a function of detecting two states, a state in which the electronic device 21 and the display device 11 are closed and a state in which they are opened. As an example of an optical detection method, a light-receiving element may be provided on the surface of the housing 22 or the surface of the support 12, and blocking of external light when they are closed may be utilized for detection. Alternatively, a light-receiving element may be provided on one of the surfaces of the housing 22 and the support 12, a light source may be provided on the other, and incidence of light from the light source on the light-receiving element when they are closed may be utilized for detection. It is preferable to use infrared light as light from the light source because users cannot visually recognize it.

Note that the structure of the shape detection portion 58 is not limited to the above and any of a variety of sensors to which, for example, a mechanical, electromagnetic, thermal, acoustic, or chemical means is applied can be used as long as the sensor can detect the relative positional relationship between the electronic device 21 and the display device 11.

Note that the shape detection portion 58 is included in the electronic device 21 in the example illustrated in FIG. 19. However, in some cases, the display device 11 may include the shape detection portion 58. Furthermore, a portion of the shape detection portion 58 may be included in the electronic device 21, and the other portion thereof may be included in the display device 11.

The external interface 60 includes one or more buttons or switches provided on the housing (also referred to as housing switches) or an external port to which another input component can be connected, for example. The external interface 60 is connected to the arithmetic portion 50 via the system bus. Examples of the housing switches include a switch associated with powering on/off, a button for adjusting volume, and a camera button.

The external port of the external interface 60 can be connected to an external device such as a computer or a printer through a cable. A universal serial bus (USB) terminal is a typical example. As the external port, a local area network (LAN) connection terminal, a digital broadcasting reception terminal, an AC adaptor connection terminal, or the like may be provided. A transceiver for optical communication, without limitation to wire communication, using infrared rays, visible light, ultraviolet rays, or the like, may be provided.

The camera module 61 is connected to the arithmetic portion 50 via the system bus. The camera module 61 can take a still image or a moving image in synchronization with pushing a housing switch or touching the display panel 71 or the display panel 81.

The audio output portion 63 includes a speaker, an audio output connector, or the like. The audio input portion 64 includes a microphone, an audio input connector, or the like. The audio input portion 64 is connected to the sound controller 62, and is connected to the arithmetic portion 50 via the system bus. Audio data input to the audio input portion 64 is converted into a digital signal in the sound controller 62 and then processed in the sound controller 62 and the arithmetic portion 50. The sound controller 62 generates an analog audio signal audible to a user according to instructions from the arithmetic portion 50 and outputs the analog audio signal to the audio output portion 63. To the audio output connector of the audio output portion 63, an audio output device such as headphones or a headset can be connected and a sound generated in the sound controller 62 is output to the device.

The sensor 65 includes a sensor and a sensor controller. The sensor controller supplies electric power from the battery module 57 to the sensor. Moreover, the sensor controller converts the input from the sensor into a control signal and outputs it to the arithmetic portion 50 via the system bus. The sensor controller may handle errors made by the sensor or may calibrate the sensor. Note that the sensor controller may include a plurality of controllers which control the sensor.

The sensor 65 may include any of a variety of sensors which measure force, displacement, position, speed, acceleration, angular velocity, rotational frequency, distance, light, liquid, magnetism, temperature, a chemical substance, a sound, time, hardness, electric field, current, voltage, electric power, radiation, flow rate, humidity, gradient, oscillation, smell, and infrared rays.

For example, a light-receiving element may be included as the sensor 65 and may have a function of measuring external light illuminance. In the case where the display panel 71 or the display panel 81 can display an image in both a transmissive mode and a reflective mode, for example, the arithmetic portion 50 can select the mode of the display panel 71 or the display panel 81 according to data input from the sensor 65. In the case where the external light illuminance is lower than a first illuminance, for example, an image is displayed in the transmissive mode. In the case where the external light illuminance is higher than the first illuminance and lower than a second illuminance, an image is displayed in the reflective mode. In the case where the external light illuminance is higher than the second illuminance, an image is displayed in both the transmissive mode and the reflective mode. Data used as the first illuminance and the second illuminance may be stored in the memory device 51. The data may be read by the arithmetic portion 50 and stored as a lookup table in the main memory. It is preferable that the first illuminance and the second illuminance can be changed as appropriate by a user.

The display panel 71 is connected to the display controller 72 and the touch sensor controller 73. The display controller 72 and the touch sensor controller 73 are each connected to the arithmetic portion 50 via the system bus.

The display controller 72 controls the display panel 71 according to drawing instructions input from the arithmetic portion 50 via the system bus so that a predetermined image is displayed on the display screen of the display panel 71.

The touch sensor controller 73 controls a touch sensor of the display panel 71 according to requests from the arithmetic portion 50 via the system bus. In addition, the touch sensor controller 73 outputs a signal received by the touch sensor to the arithmetic portion 50 via the system bus. Note that the function of calculating touch position data from a signal received by the touch sensor may be given to the touch sensor controller 73 or the arithmetic portion 50.

The display panel 81 of the display device 11 can be connected to the display controller 82 and the touch sensor controller 83 when the display device 11 is attached to the electronic device 21. Like the display controller 72 and the touch sensor controller 73, the display controller 82 and the touch sensor controller 83 can control the display panel 81.

The display panel 81 and the display controller 82 or the touch sensor controller 83 may be connected to each other through a cable or a wiring or may transmit and receive signals wirelessly.

Although not illustrated here, power may be supplied to the display device 11 from the power management portion 55 of the electronic device 21. In that case, a power supply line for supplying power by wire or wirelessly from the power management portion 55 to the display device 11 (or the display panel 81) can be used.

Note that the display controller 82 and the touch sensor controller 83 are included in the electronic device 21 in this example, but may be included in the display device 11. In that case, the display controller 82 and the touch sensor controller 83 can be connected by wire or wirelessly to the arithmetic portion 50 through the system bus of the electronic device 21.

The display controller 72 may also serve as the display controller 82, and similarly, the touch sensor controller 73 may also serve as the touch sensor controller 83. That is, the display controller 72 and the touch sensor controller 73 may control both the display panel 71 and the display panel 81.

It is preferable that the display device 11 include minimum components such as the display panel 81 and the electronic device 21 include the other components as illustrated in FIG. 19 because the configuration of the display device 11 can be simplified. Accordingly, the display device 11 can be lightweight and compact. This makes it possible to minimize the total weight and an increase in thickness of the system 10 including the electronic device 21 and the display device 11. It is also preferable that components originally included in the electronic device 21 be used as components such as the display controller 82 and the touch sensor controller 83 for driving the display device 11 because no new components, or only minimum components, need to be added to the electronic device 21 to obtain the system 10.

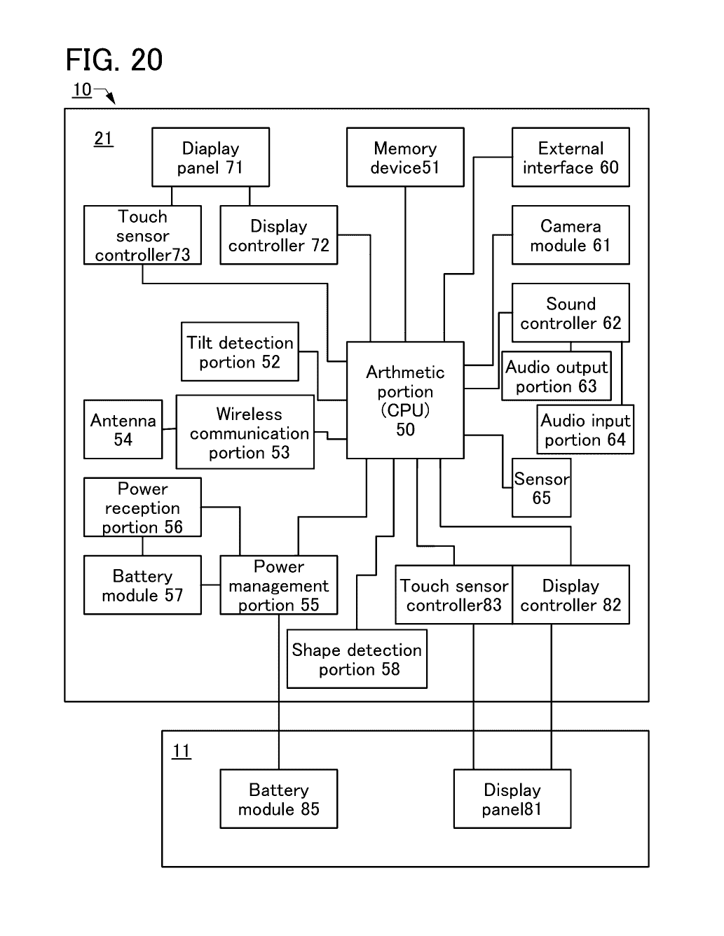

FIG. 20 illustrates an example in which the display device 11 includes a battery module 85.

The battery module 85 can be connected to the power management portion 55 of the electronic device 21 when the display device 11 is attached to the electronic device 21. The power management portion 55 can control the battery module 85 in addition to the battery module 57. It is preferable that power be supplied to the battery module 85 from the power reception portion 56 through the power management portion 55 so that the battery module 85 can be charged.

Note that the display device 11 may include a power management portion and a power reception portion in the case where the display device 11 is detachable. In that case, the battery module 85 can be charged in the display device 11 alone.

The battery module 85 preferably overlaps with the display panel 81. When the support 12 and the display panel 81 of the display device 11 are flexible and can be used in a bent state, it is preferable that the battery module 85 be also at least partly flexible. Examples of the secondary battery which can be used for the battery module 85 include a lithium ion secondary battery and a lithium ion polymer secondary battery. It is preferable that a laminate pouch be used as an exterior package of the battery so that the battery has flexibility.

A film used for the laminate pouch is a single-layer film selected from a metal film (such as aluminum, stainless steel, or nickel steel), a plastic film made of an organic material, a hybrid material film containing an organic material (e.g., an organic resin or fiber) and an inorganic material (e.g., ceramic), and a carbon-containing inorganic film (e.g., a carbon film or a graphite film), or a stacked-layer film including two or more of the above films. A metal film can be easily embossed. Forming depressions or projections by embossing increases the surface area of the film exposed to outside air, achieving efficient heat dissipation.

It is particularly preferable that a laminate pouch including a metal film having depressions and projections by embossing be used, in which case a strain caused by stress applied to the laminate pouch can be relieved, leading to an effective decrease of defects such as a break of the laminate pouch due to bending of a secondary battery.

In the configuration examples described here, the display device 11 includes the display panel 81 or includes the display panel 81 and the battery module 85, but may include other components. For example, the display device 11 may include one or more of the above-described components of the electronic device 21 or may include another or other components. In one example, the display device 11 may include the display panel 81, the battery module 85, a power management portion, and a power reception portion. In another example, the display device 11 may include the display panel 81, the battery module 85, a power management portion, a light reception portion, an arithmetic portion, and a camera module.

The above is the description of system hardware configurations.

At least part of this embodiment can be implemented in combination with any of the other embodiments described in this specification as appropriate.

### Embodiment 2

In this embodiment, an example of a display panel that can be used for the display portion of the display device, the electronic device, or the system described in the above embodiment will be described.

A display panel of one embodiment of the present invention includes a first display element, a first conductive film electrically connected to the first display element, a second conductive film including a region overlapping with the first conductive film, a second insulating film including a region located between the second conductive film and the first conductive film, a pixel circuit electrically connected to the second conductive film, and a second display element electrically connected to the pixel circuit. The second insulating film has an opening. The second conductive film is electrically connected to the first conductive film through the opening.

Thus, the first display element and the second display element that displays an image using a method different from that of the first display element can be driven using the pixel circuit that can be formed in the same process. Thus, a novel display panel which is highly convenient or reliable can be provided.

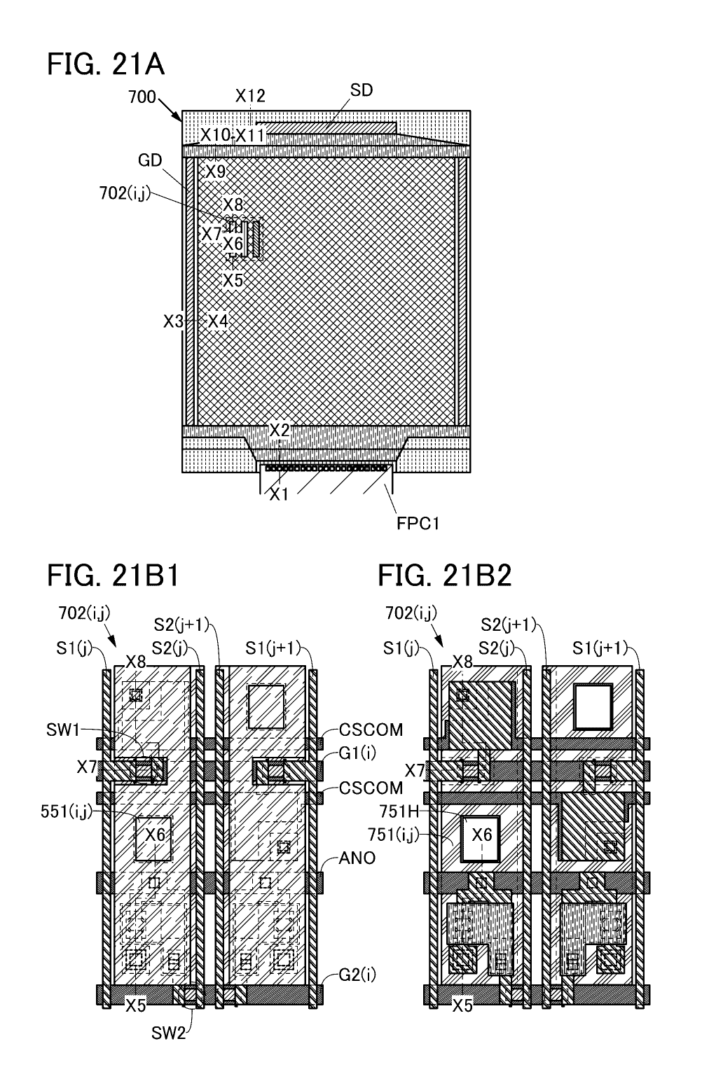

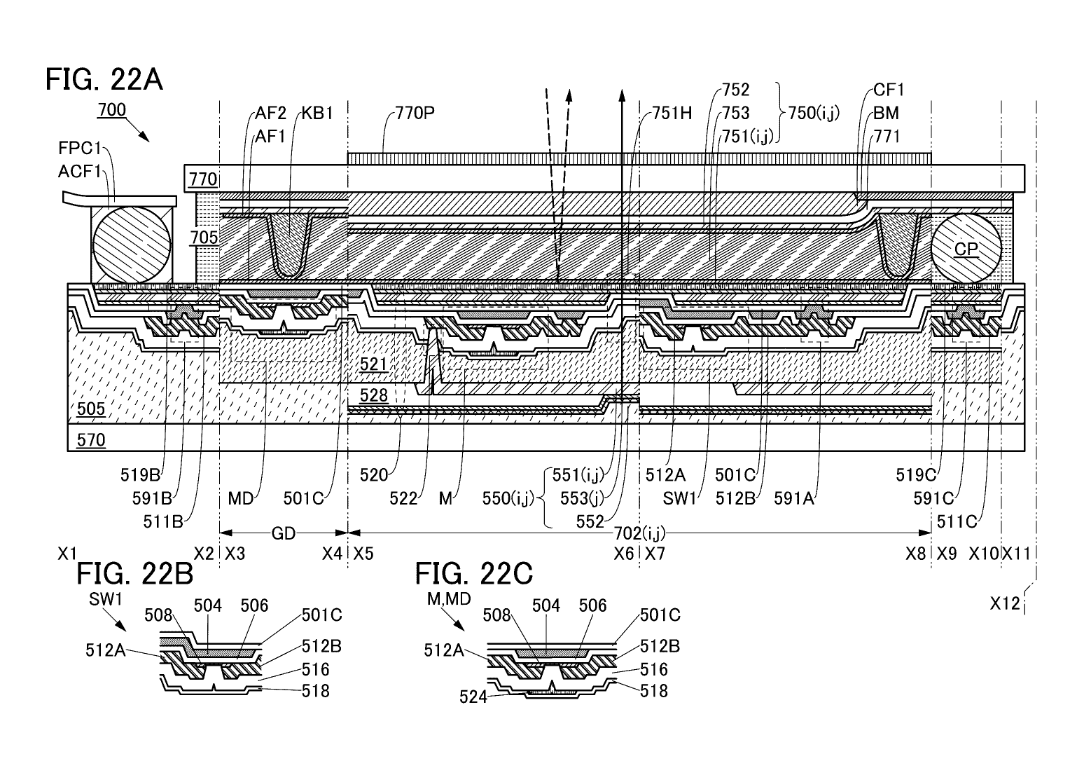

A structure of the display panel of one embodiment of the present invention will be described below with reference to FIGS. 21A, 21B1, and 21B2, FIGS. 22A to 22C, FIG. 23, and FIGS. 24A, 24B1, and 24B2.

FIGS. 21A, 21B1, and 21B2 illustrate the structure of a display panel 700 of one embodiment of the present invention. FIG. 21A is a bottom view of the display panel 700 of one embodiment of the present invention. FIG. 21B1 is a bottom view illustrating a portion of FIG. 21A. FIG. 21B2 is a bottom view in which some components in FIG. 21B1 are not illustrated.

FIGS. 22A to 22C illustrate the structure of the display panel 700 of one embodiment of the present invention. FIG. 22A is a cross-sectional view taken along section lines X1-X2, X3-X4, X5-X6, X7-X8, X9-X10, and X11-X12 in FIG. 21A. FIG. 22B is a cross-sectional view illustrating a structure of a portion of the display panel. FIG. 22C is a cross-sectional view illustrating a structure of another portion of the display panel.

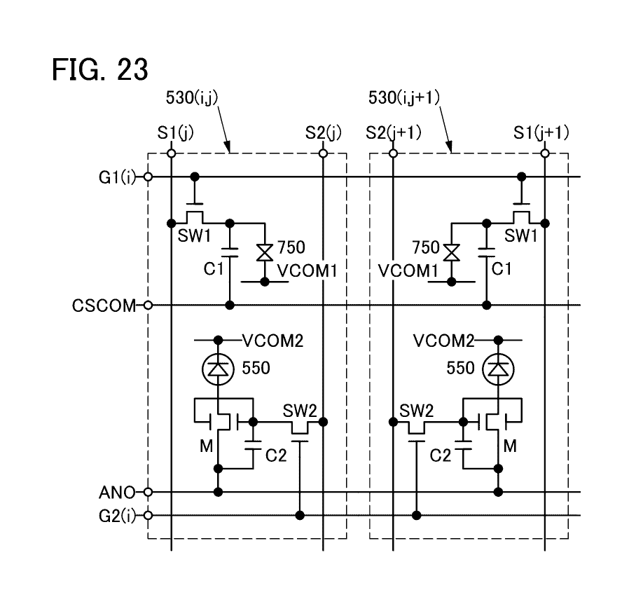

FIG. 23 illustrates the structure of the display panel 700 of one embodiment of the present invention. FIG. 23 is a circuit diagram of a pixel circuit 530(i, j) and a pixel circuit 530(i,j+1) which can be used as pixel circuits of the display panel 700 of one embodiment of the present invention.

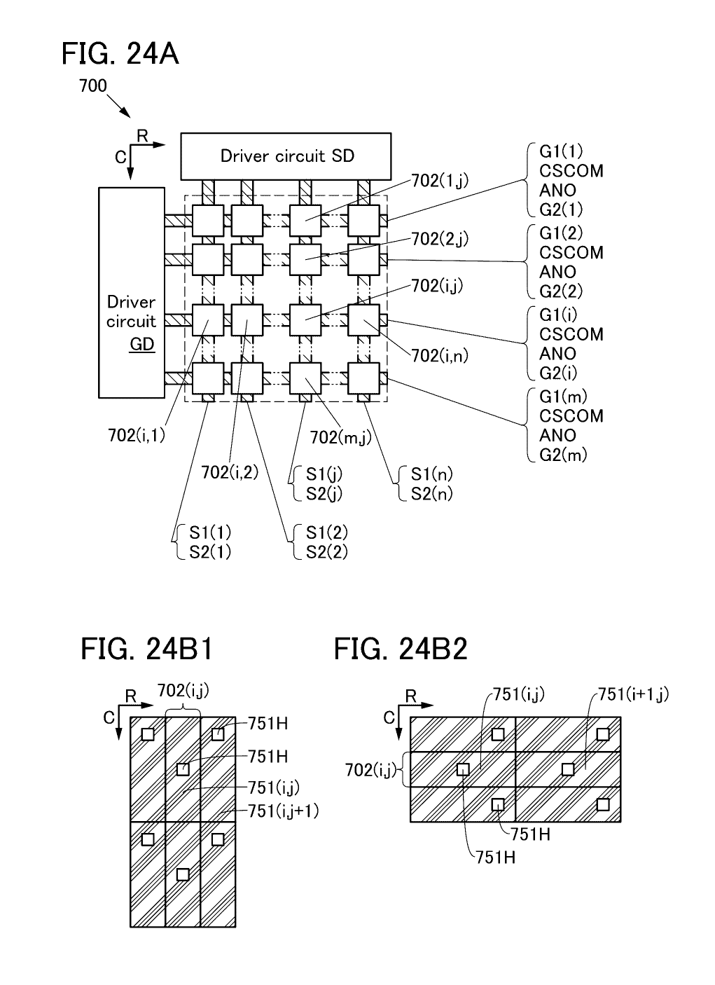

FIGS. 24A, 24B1, and 24B2 illustrate the structure of the display panel 700 of one embodiment of the present invention. FIG. 24A is a block diagram illustrating the arrangement of pixels, wirings, and the like which can be used in the display panel 700 of one embodiment of the present invention. FIGS. 24B1 and 24B2 are schematic diagrams illustrating the arrangement of openings 751H which can be used in the display panel 700 of one embodiment of the present invention.

### [Structural Example 1 of Display Panel]

The display panel 700 described in this embodiment includes a signal line S1(j) and a pixel 702(i, j) (see FIGS. 21B1 and 21B2).

The pixel 702(i, j) is electrically connected to the signal line S1(j).

The pixel 702(i, j) includes a first display element 750(i, j), a first conductive film, a second conductive film, a second insulating film 501C, a pixel circuit 530(i, j), and a second display element 550(i, j) (see FIG. 22A and FIG. 23).

The first conductive film is electrically connected to the first display element 750(i, j) (see FIG. 22A). For example, the first conductive film can be used for a first electrode 751(i, j) of the first display element 750(i, j).

The second conductive film includes a region overlapping with the first conductive film. For example, the second conductive film can be used for a conductive film 512B serving as a source electrode or a drain electrode of a transistor that can be used for a switch SW1.

The second insulating film 501C includes a region interposed between the second conductive film and the first conductive film.

The pixel circuit 530(i, j) is electrically connected to the second conductive film. For example, a transistor using the second conductive film for the conductive film 512B serving as a source electrode or a drain electrode can be used for the switch SW1 of the pixel circuit 530(i, j) (see FIG. 22A and FIG. 23).

The second display element 550(i, j) is electrically connected to the pixel circuit 530(i, j).

The second insulating film 501C has an opening 591A (see FIG. 22A).

The second conductive film is electrically connected to the first conductive film through the opening 591A. For example, the conductive film 512B is electrically connected to the first electrode 751(i, j) doubling as the first conductive film.

The pixel circuit 530(i, j) is electrically connected to the signal line S1(j) (see FIG. 23). Note that a conductive film 512A is electrically connected to the signal line S1(j) (see FIG. 22A and FIG. 23).

The first electrode 751(i, j) includes a side end portion embedded at the second insulating film 501C.

The pixel circuit 530(i, j) of the display panel described in this embodiment includes the switch SW1. The switch SW1 includes a transistor that includes an oxide semiconductor.

Furthermore, the second display element 550(i, j) of the display panel described in this embodiment has a function of displaying images in the same direction as a direction in which the first display element 750(i, j) displays images. For example, in the drawing, a dashed arrow shows the direction in which the first display element 750(i, j) displays images by controlling the intensity of external light reflection. In addition, a solid arrow shows the direction in which the second display element 550(i, j) displays images (see FIG. 22A).

Furthermore, the second display element 550(i, j) of the display panel described in this embodiment has a function of displaying images in a region surrounded by a region in which the first display element 750(i, j) displays images. Note that the first display element 750(i, j) displays images in a region overlapping with the first electrode 751(i, j), and the second display element 550(i, j) displays images in a region overlapping with the opening 751H.

The first display element 750(i, j) of the display panel described in this embodiment includes a reflective film having a function of reflecting incident light and has a function of controlling the intensity of reflected light. The reflective film has the opening 751H. Note that the first conductive film or the first electrode 751(i, j) can be used for the reflective film of the first display element 750(i, j).

The second display element 550(i, j) has a function of emitting light toward the opening 751H.

The display panel described in this embodiment includes the pixel 702(i, j), a group of pixels 702(i, 1) to 702(i, n), another group of pixels 702(1, j) to 702(m, j), and a scan line G1(i) (see FIG. 24A). Note that i is an integer greater than or equal to 1 and less than or equal to m, j is an integer greater than or equal to 1 and less than or equal to n, and each of m and n is an integer greater than or equal to 1.

The display panel described in this embodiment also includes a scan line G2(i), a wiring CSCOM, and a wiring ANO.

The group of pixels 702(t, 1) to 702(i, n) include the pixel 702(i, j) and are arranged in the row direction (the direction shown by the arrow R in drawings).

The other group of pixels 702(1, j) to 702(m, j) include the pixel 702(i, j) and are arranged in the column direction (the direction shown by the arrow C in drawings) intersecting the row direction.

The scan line G1(i) is electrically connected to the group of pixels 702(i, 1) to 702(i, n) arranged in the row direction.

The other group of pixels 702(1, j) to 702(m, j) arranged in the column direction are electrically connected to the signal line S1(j).

For example, the pixel 702(i, j+1) adjacent to the pixel 702(i, j) in the row direction has an opening in a position different from that of the opening 751H in the pixel 702(i, j) (see FIG. 24B1).

For example, the pixel 702(i+1, j) adjacent to the pixel 702(i, j) in the column direction has an opening in a position different from that of the opening 751H in the pixel 702(i, j) (see FIG. 24B2). Note that for example, the first electrode 751(i, j) can be used for the reflective film.

The display panel of one embodiment of the present invention includes a first display element, a first conductive film electrically connected to the first display element, a second conductive film including a region overlapping with the first conductive film, a second insulating film including a region located between the second conductive film and the first conductive film, a pixel circuit electrically connected to the second conductive film, and a second display element electrically connected to the pixel circuit. The second insulating film has an opening. The second conductive film is electrically connected to the first conductive film through the opening.

Thus, the first display element and the second display element that displays an image using a method different from that of the first display element can be driven using the pixel circuit that can be formed in the same process. Thus, a novel display panel which is highly convenient or reliable can be provided.

The display panel described in this embodiment also includes a terminal 519B and a conductive film 511B (see FIG. 22A).

The second insulating film 501C includes a region located between the terminal 519B and the conductive film 511B. The second insulating film 501C has an opening 591B.

The terminal 519B is electrically connected to the conductive film 511B through the opening 591B. In addition, the conductive film 511B is electrically connected to the pixel circuit 530(i, j). For example, in the case where the first electrode 751(i, j) or the first conductive film is used for the reflective film, a surface serving as a contact of the terminal 519B faces in the same direction as a surface of the first electrode 751(i, j) that faces light incident on the first display element 750(i, j).

Thus, power or signals can be supplied to the pixel circuit through the terminal. Thus, a novel display panel which is highly convenient or reliable can be provided.

The first display element 750(i, j) of the display panel described in this embodiment includes a layer 753 containing a liquid crystal material, the first electrode 751(i, j), and a second electrode 752. The second electrode 752 is positioned such that an electric field which controls the alignment of the liquid crystal material is generated between the second electrode 752 and the first electrode 751(i, j).

The display panel described in this embodiment also includes an alignment film AF1 and an alignment film AF2. The alignment film AF2 is provided such that the layer 753 containing a liquid crystal material is located between the alignment film AF1 and the alignment film AF2.

The second display element 550(i, j) of the display panel described in this embodiment includes a third electrode 551(i, j), a fourth electrode 552, and a layer 553(j) containing a light-emitting organic compound.

The fourth electrode 552 includes a region overlapping with the third electrode 551(i, j). The layer 553(j) containing a light-emitting organic compound is provided between the third electrode 551 and the fourth electrode 552. The third electrode 551(i, j) is electrically connected to the pixel circuit 530(i, j) at a connection portion 522.

The pixel 702(i, j) of the display panel described in this embodiment includes a coloring film CF1, a light-blocking film BM, an insulating film 771, and a functional film 770P.

The coloring film CF1 includes a region overlapping with the first display element 750(i, j). The light-blocking film BM has an opening in a region overlapping with the first display element 750(i, j).

The insulating film 771 is provided between the coloring film CF1 and the layer 753 containing a liquid crystal material or between the light-blocking film BM and the layer 753 containing a liquid crystal material. The insulating film 771 can reduce surface unevenness due to the thickness of the coloring film CF1. Furthermore, the insulating film 771 can prevent impurities from diffusing from the light-blocking film BM, the coloring film CF1, or the like to the layer 753 containing a liquid crystal material.

The functional film 770P includes a region overlapping with the first display element 750(i, j). The functional film 770P is provided such that a substrate 770 is located between the functional film 770P and the first display element 750(i, j).

The display panel described in this embodiment also includes a substrate 570, the substrate 770, and a functional layer 520.

The substrate 770 includes a region overlapping with the substrate 570. The functional layer 520 is provided between the substrate 570 and the substrate 770.

The functional layer 520 includes the pixel circuit 530(i, j), the second display element 550(i, j), an insulating film 521, and an insulating film 528. The functional layer 520 includes an insulating film 518 and an insulating film 516.

The insulating film 521 is provided between the pixel circuit 530(i, j) and the second display element 550(i, j).

The insulating film 528 is provided between the insulating film 521 and the substrate 570, and has an opening in a region overlapping with the second display element 550(i, j). The insulating film 528 formed along the outer edge of the third electrode 551 can prevent a short circuit between the third electrode 551 and the fourth electrode 552.

The insulating film 518 includes a region located between the insulating film 521 and the pixel circuit 530(i, j), and the insulating film 516 includes a region located between the insulating film 518 and the pixel circuit 530(i, j).

The display panel described in this embodiment also includes a bonding layer 505, a sealing material 705, and a structure body KB1.

The bonding layer 505 is provided between the functional layer 520 and the substrate 570, and has a function of bonding the functional layer 520 and the substrate 570 together.

The sealing material 705 is provided between the functional layer 520 and the substrate 770, and has a function of bonding the functional layer 520 and the substrate 770 together.

The structure body KB1 has a function of providing a certain space between the functional layer 520 and the substrate 770.

The display panel described in this embodiment also includes a terminal 519C, a conductive film 511C, and a conductor CP.

The second insulating film 501C includes a region located between the terminal 519C and the conductive film 511C. The second insulating film 501C has an opening 591C.

The terminal 519C is electrically connected to the conductive film 511C through the opening 591C. The conductive film 511C is electrically connected to the pixel circuit 530(i, j).

The conductor CP is located between the terminal 519C and the second electrode 752, and electrically connects the terminal 519C and the second electrode 752. For example, a conductive particle can be used as the conductor CP.

The display panel described in this embodiment also includes a driver circuit GD and a driver circuit SD (see FIG. 21A and FIG. 24A).

The driver circuit GD is electrically connected to the scan line G1(i). The driver circuit GD includes a transistor MD, for example. Specifically, a transistor including a semiconductor film that can be formed in the same process as the transistor included in the pixel circuit 530(i, j) can be used as the transistor MD (see FIGS. 22A and 22C).

The driver circuit SD is electrically connected to the signal line S1(j). The driver circuit SD is electrically connected to a terminal that can be formed in the same process as, for example, the terminal 519B or the terminal 519C with the use of a conductive material.

Individual components included in the display panel will be described below. Note that in some cases, these components cannot be clearly distinguished and one component may also serve as another component or include part of another component.

For example, the first conductive film can be used for the first electrode 751(i, j). Furthermore, the first conductive film can also be used for the reflective film.

The second conductive film can be used for the conductive film 512B serving as the source electrode or the drain electrode of the transistor.

### Structural Example 1

The display panel of one embodiment of the present invention includes the substrate 570, the substrate 770, the structure body KB1, the sealing material 705, or the bonding layer 505.

The display panel of one embodiment of the present invention also includes the functional layer 520, the insulating film 521, and the insulating film 528.

The display panel of one embodiment of the present invention also includes the signal line S1(j), a signal line S2(j), the scan line G1(i), the scan line G2(i), the wiring CSCOM, and the wiring ANO.

The display panel of one embodiment of the present invention also includes the first conductive film or the second conductive film.

The display panel of one embodiment of the present invention also includes the terminal 519B, the terminal 519C, the conductive film 511B, or the conductive film 511C.

The display panel of one embodiment of the present invention also includes the pixel circuit 530(i, j) and the switch SW1.

The display panel of one embodiment of the present invention also includes the first display element 750(i, j), the first electrode 751(i, j), the reflective film, the opening 751H, the layer 753 containing a liquid crystal material, and the second electrode 752.

The display panel of one embodiment of the present invention also includes the alignment film AF1, the alignment film AF2, the coloring film CF1, the light-blocking film BM, the insulating film 771, and the functional film 770P.

The display panel of one embodiment of the present invention also includes the second display element 550(i, j), the third electrode 551(i, j), the fourth electrode 552, or the layer 553(j) containing a light-emitting organic compound.

The display panel of one embodiment of the present invention also includes the second insulating film 501C.

The display panel of one embodiment of the present invention also includes the driver circuit GD or the driver circuit SD.

### [Substrate 570]

A material having heat resistance high enough to withstand heat treatment in the manufacturing process can be used for the substrate 570 or the like. Specifically, an alkali-free glass substrate with a thickness of 0.7 mm can be used.

For example, a large-area glass substrate having any of the following sizes can be used as the substrate 570 or the like: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For the substrate 570 or the like, an organic material, an inorganic material, a composite material of an organic material and an inorganic material, or the like can be used. For example, an inorganic material such as glass, ceramic, or metal can be used for the substrate 570 or the like.

Specifically, alkali-free glass, soda-lime glass, potash glass, crystal glass, quartz, sapphire, or the like can be used for the substrate 570 or the like. Specifically, an inorganic oxide film, an inorganic nitride film, an inorganic oxynitride film, or the like can be used for the substrate 570 or the like. For example, a silicon oxide film, a silicon nitride film, a silicon oxynitride film, or an aluminum oxide film can be used for the substrate 570 or the like. Stainless steel, aluminum, or the like can be used for the substrate 570 or the like.

For example, a single crystal semiconductor substrate or a polycrystalline semiconductor substrate of silicon or silicon carbide, a compound semiconductor substrate of silicon germanium, an SOI substrate, or the like can be used as the substrate 570 or the like. Thus, a semiconductor element can be provided on the substrate 570 or the like.

For example, an organic material such as a resin, a resin film, or plastic can be used for the substrate 570 or the like. Specifically, a resin film or a resin plate of polyester, polyolefin, polyamide, polyimide, polycarbonate, an acrylic resin, or the like can be used as the substrate 570 or the like.

For example, a composite material such as a resin film to which a metal plate, a thin glass plate, or a film of an inorganic material or the like is attached can be used for the substrate 570 or the like. For example, a composite material formed by dispersing a fibrous or particulate metal, glass, inorganic material, or the like into a resin film can be used for the substrate 570 or the like. For example, a composite material formed by dispersing a fibrous or particulate resin, organic material, or the like into an inorganic material can be used for the substrate 570 or the like.

For the substrate 570 or the like, a single-layer material or a material in which a plurality of layers are stacked can be used. For example, a material in which a base, an insulating film that prevents diffusion of impurities contained in the base, and the like are stacked can be used for the substrate 570 or the like. Specifically, a material in which glass and one or a plurality of films that prevent diffusion of impurities contained in the glass and that are selected from a silicon oxide layer, a silicon nitride layer, a silicon oxynitride layer, and the like are stacked can be used for the substrate 570 or the like. Alternatively, a material in which a resin and a film that prevents diffusion of impurities permeating the resin, such as a silicon oxide film, a silicon nitride film, or a silicon oxynitride film are stacked can be used for the substrate 570 or the like.

Specifically, a resin film, a resin plate, a stack, or the like of polyester, polyolefin, polyamide, polyimide, polycarbonate, an acrylic resin, or the like can be used as the substrate 570 or the like.

Specifically, a material including polyester, polyolefin, polyamide (e.g., nylon or aramid), polyimide, polycarbonate, polyurethane, an acrylic resin, an epoxy resin, or a resin having a siloxane bond can be used for the substrate 570 or the like.

Specifically, polyethylene terephthalate (PET), polyethylene naphthalate (PEN), polyethersulfone (PES), acrylic, or the like can be used for the substrate 570 or the like.

Alternatively, paper, wood, or the like can be used for the substrate 570 or the like.

For example, a flexible substrate can be used as the substrate 570 or the like.

Note that a transistor, a capacitor, or the like can be directly formed over the substrate. Alternatively, for example, a transistor, a capacitor, or the like formed over a process substrate having resistance to heat applied in the manufacturing process can be transferred to the substrate 570 or the like. Thus, a transistor, a capacitor, or the like can be formed over a flexible substrate, for example.

### [Substrate 770]

For example, a light-transmitting material can be used for the substrate 770. Specifically, a material selected from the materials that can be used for the substrate 570 can be used for the substrate 770. Specifically, an alkali-free glass substrate polished to a thickness of approximately 0.7 mm or 0.1 mm can be used.

[Structure body KB1]

For example, an organic material, an inorganic material, a composite material of an organic material and an inorganic material, or the like can be used for the structure body KB1 or the like. This allows a predetermined space to be provided between components between which the structure body KB1 or the like is located.

Specifically, polyester, polyolefin, polyamide, polyimide, polycarbonate, polysiloxane, an acrylic resin, or the like, or a composite material of a plurality of kinds of resins selected from these can be used for the structure body KB1 or the like. Alternatively, a photosensitive material may be used.

### [Sealing Material 705]

An inorganic material, an organic material, a composite material of an inorganic material and an organic material, or the like can be used for the sealing material 705 or the like.

For example, an organic material such as a thermally fusible resin or a curable resin can be used for the sealing material 705 or the like.

For example, an organic material such as a reactive curable adhesive, a photo-curable adhesive, a thermosetting adhesive, and/or an anaerobic adhesive can be used for the sealing material 705 or the like.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, or the like can be used for the sealing material 705 or the like.

### [Bonding Layer 505]

For example, a material that can be used for the sealing material 705 can be used for the bonding layer 505.

### [Insulating Film 521]

For example, an insulating inorganic material, an insulating organic material, or an insulating composite material containing an inorganic material or an organic material can be used for the insulating film 521 or the like.

Specifically, an inorganic oxide film, an inorganic nitride film, an inorganic oxynitride film, or the like or a material obtained by stacking any of these films can be used for the insulating film 521 or the like. For example, a film including ay of a silicon oxide film, a silicon nitride film, a silicon oxynitride film, and an aluminum oxide film, or a film including a material obtained by stacking any of these films can be used for the insulating film 521 or the like.

Specifically, polyester, polyolefin, polyamide, polyimide, polycarbonate, polysiloxane, an acrylic resin, or the like, or a layered material or a composite material of a plurality of kinds of resins selected from these can be used for the insulating film 521 or the like. Alternatively, a photosensitive material may be used.

Thus, for example, the insulating film 521 can eliminate level differences caused by various structures underlying the insulating film 521.

### [Insulating Film 528]

For example, the material that can be used for the insulating film 521 can be used for the insulating film 528 or the like. Specifically, a 1-μm-thick film containing polyimide can be used for the insulating film 528.

### [Second Insulating Film 501C]

For example, the material that can be used for the insulating film 521 can be used for the second insulating film 501C. Specifically, a material containing silicon and oxygen can be used for the second insulating film 501C. Thus, diffusion of impurities into the pixel circuit, the second display element, or the like can be inhibited.

For example, a 200-nm-thick film containing silicon, oxygen, and nitrogen can be used as the second insulating film 501C.

Note that the second insulating film 501C has the opening 591A, the opening 591B, or the opening 591C.

### [Wiring, Terminal, and Conductive Film]

A conductive material can be used for the wiring or the like. Specifically, a conductive material can be used for the signal line S1(j), the signal line S2(j), the scan line G1(i), the scan line G2(i), the wiring CSCOM, the wiring ANO, the terminal 519B, the terminal 519C, the conductive film 511B, the conductive film 511C, or the like.

For example, an inorganic conductive material, an organic conductive material, a metal, a conductive ceramic, or the like can be used for the wiring or the like.

Specifically, a metal element selected from aluminum, gold, platinum, silver, copper, chromium, tantalum, titanium, molybdenum, tungsten, nickel, iron, cobalt, palladium, and manganese, or the like can be used for the wiring or the like. Alternatively, an alloy including any of the above-described metal elements, or the like can be used for the wiring or the like. In particular, an alloy of copper and manganese is suitably used in microfabrication with the use of a wet etching method.

Specifically, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, or the like can be used for the wiring or the like.

Specifically, a conductive oxide such as indium oxide, indium tin oxide, indium zinc oxide, zinc oxide, or zinc oxide to which gallium is added can be used for the wiring or the like.

Specifically, a film including graphene or graphite can be used for the wiring or the like.

For example, a film including graphene oxide is formed and is subjected to reduction, so that a film including graphene can be formed. As a reducing method, a method using heat, a method using a reducing agent, or the like can be employed.

Specifically, a conductive polymer can be used for the wiring or the like.

### [First Conductive Film and Second Conductive Film]

For example, a material that can be used for the wiring or the like can be used for the first conductive film or the second conductive film.

Alternatively, the first electrode 751(i, j), the wiring, or the like can be used for the first conductive film.

The wiring, the conductive film 512B of the transistor that can be used for the switch SW1, or the like can be used for the second conductive film.

[Pixel Circuit 530(i, j)]

The pixel circuit 530(i, j) is electrically connected to the signal line S1(j), the signal line S2(j), the scan line G1(i), the scan line G2(i), the wiring CSCOM, and the wiring ANO (see FIG. 23).

The pixel circuit 530(i, j+1) is electrically connected to a signal line S1(j+1), a signal line S2(j+1), the scan line G1(i), the scan line G2(i), the wiring CSCOM, and the wiring ANO.

In the case where the voltage used as a signal supplied to the signal line S2(j) is different from the voltage used as a signal supplied to the signal line S1(j+1), the signal line S1(j+1) is positioned apart from the signal line S2(j). Specifically, the signal line S2(j+1) is positioned adjacent to the signal line S2(j).

The pixel circuit 530(i, j) includes the switch SW1, a capacitor C1, a switch SW2, a transistor M, and a capacitor C2.

For example, a transistor including a gate electrode electrically connected to the scan line G1(i) and a first electrode electrically connected to the signal line S1(j) can be used for the switch SW1.

The capacitor C1 includes a first electrode electrically connected to a second electrode of the transistor used for the switch SW1 and a second electrode electrically connected to the wiring CSCOM.

For example, a transistor including a gate electrode electrically connected to the scan line G2(i) and a first electrode electrically connected to the signal line S2(j) can be used for the switch SW2.

The transistor M includes a gate electrode electrically connected to a second electrode of the transistor used for the switch SW2 and a first electrode electrically connected to the wiring ANO.

Note that a transistor including a conductive film provided such that a semiconductor film is located between a gate electrode and the conductive film can be used as the transistor M. For example, a conductive film electrically connected to the wiring capable of supplying a potential equal to that supplied to the first electrode of the transistor M can be used.

The capacitor C2 includes a first electrode electrically connected to the second electrode of the transistor used for the switch SW2 and a second electrode electrically connected to the first electrode of the transistor M.

Note that the first electrode and the second electrode of the first display element 750 are electrically connected to the second electrode of the transistor used for the switch SW1 and the wiring VCOM1, respectively. This enables the first display element 750 to be driven.

Note that the first electrode and the second electrode of the second display element 550 are electrically connected to the second electrode of the transistor M and the wiring VCOM2, respectively. This enables the second display element 550 to be driven.

### [Switch SW1, Switch SW2, Transistor M, and Transistor MD]

For example, a bottom-gate or top-gate transistor can be used for the switch SW1, the switch SW2, the transistor M, the transistor MD, and the like.

For example, a transistor in which a semiconductor containing an element belonging to Group 14 is used for a semiconductor film can be used. Specifically, a semiconductor containing silicon can be used for a semiconductor film. For example, single crystal silicon, polysilicon, microcrystalline silicon, amorphous silicon, or the like can be used for the semiconductor films of the transistors.

For example, a transistor in which an oxide semiconductor is used for a semiconductor film can be used. Specifically, an oxide semiconductor containing indium or an oxide semiconductor containing indium, gallium, and zinc can be used for a semiconductor film.

For example, a transistor having a lower leakage current in an off state than a transistor in which amorphous silicon is used for a semiconductor film can be used for the switch SW1, the switch SW2, the transistor M, the transistor MD, and the like. Specifically, a transistor in which an oxide semiconductor is used for a semiconductor film 508 can be used for the switch SW1, the switch SW2, the transistor M, the transistor MD, and the like.

Thus, a pixel circuit can hold an image signal for a longer time than a pixel circuit including a transistor in which amorphous silicon is used for a semiconductor film. Specifically, a selection signal can be supplied at a frequency of lower than 30 Hz, preferably lower than 1 Hz, more preferably less than once per minute while flickering is suppressed. Consequently, fatigue accumulated in a user of the data processing device can be reduced, and power consumption for driving can be reduced.

The transistor that can be used for the switch SW1 includes the semiconductor film 508 and the conductive film 504 including a region overlapping with the semiconductor film 508 (see FIG. 22B). The transistor that can be used for the switch SW1 also includes the conductive film 512A and the conductive film 512B.

Note that the conductive film 504 and the insulating film 506 serve as a gate electrode and a gate insulating film, respectively. The conductive film 512A has one of a function of a source electrode and a function of a drain electrode, and the conductive film 512B has the other.

A transistor including a conductive film 524 provided such that the semiconductor film 508 is located between the conductive film 504 and the conductive film 524 can be used as the transistor M (see FIG. 22C).

A conductive film formed by stacking a 10-nm-thick film containing tantalum and nitrogen and a 300-nm-thick film containing copper in this order can be used as the conductive film 504.

A material obtained by stacking a 400-nm-thick film containing silicon and nitrogen and a 200-nm-thick film containing silicon, oxygen, and nitrogen can be used for the insulating film 506.

A 25-nm-thick film containing indium, gallium, and zinc can be used as the semiconductor film 508.

A conductive film formed by stacking a 50-nm-thick film containing tungsten, a 400-nm-thick film containing aluminum, and a 100-nm-thick film containing titanium in this order can be used as the conductive film 512A or the conductive film 512B.

[First Display Element 750(i, j)]

For example, a display element having a function of controlling transmission or reflection of light can be used as the first display element 750(i, j) or the like. For example, a combined structure of a polarizing plate and a liquid crystal element or a MEMS shutter display element can be used. The use of a reflective display element can reduce power consumption of a display panel. Specifically, a reflective liquid crystal display element can be used as the first display element 750(i, j) or the like.

A liquid crystal element that can be driven by any of the following driving methods can be used: an in-plane-switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

Alternatively, a liquid crystal element that can be driven by a driving method such as a vertical alignment (VA) mode, specifically, a multi-domain vertical alignment (MVA) mode, a patterned vertical alignment (PVA) mode, an electrically controlled birefringence (ECB) mode, a continuous pinwheel alignment (CPA) mode, or an advanced super-view (ASV) mode can be used.

For example, a thermotropic liquid crystal, a low-molecular liquid crystal, a high-molecular liquid crystal, a polymer dispersed liquid crystal, a ferroelectric liquid crystal, an anti-ferroelectric liquid crystal, or the like can be used. Alternatively, a liquid crystal material which exhibits a cholesteric phase, a smectic phase, a cubic phase, a chiral nematic phase, an isotropic phase, or the like can be used. Alternatively, a liquid crystal material which exhibits a blue phase can be used.

[First Electrode 751(i, j)]

For example, the material that is used for the wiring or the like can be used for the first electrode 751(i, j). Specifically, a reflective film can be used for the first electrode 751(i, j).

### [Reflective Film]

For example, a material that reflects visible light can be used for the reflective film. Specifically, a material containing silver can be used for the reflective film. For example, a material containing silver, palladium, and the like or a material containing silver, copper, and the like can be used for the reflective film.

The reflective film reflects light that passes through the layer 753 containing a liquid crystal material, for example. This allows the first display element 750 to serve as a reflective liquid crystal element. Alternatively, for example, a material with unevenness on its surface can be used for the reflective film. In that case, incident light can be reflected in various directions so that a white image can be displayed.

Note that the first electrode 751(i, j) is not necessarily used for the reflective film. For example, the reflective film can be provided between the layer 753 containing a liquid crystal material and the first electrode 751(i, j). Alternatively, the first electrode 751(i, j) having a light-transmitting property can be provided between the reflective film and the layer 753 containing a liquid crystal material.

### [Opening 751H]

If the ratio of the total area of the opening 751H to the total area of the reflective film other than the opening is excessively high, an image displayed using the first display element 750(i, j) is dark. If the ratio of the total area of the opening 751H to the total area of the reflective film other than the opening is excessively low, an image displayed using the second display element 550(i, j) is dark.

If the area of the opening 751H in the reflective film is too small, light emitted from the second display element 550 is not efficiently extracted for display.

The opening 751H may have a polygonal shape, a quadrangular shape, an elliptical shape, a circular shape, a cross shape, a stripe shape, a slit-like shape, or a checkered pattern. The opening 751H may be close to the adjacent pixel. The opening 751H is preferably provided close to a pixel that has a function of emitting light of the same color, in which case an undesired phenomenon in which light emitted from the second display element 550 enters a coloring film of the adjacent pixel, which is called crosstalk, can be suppressed.

### [Second Electrode 752]

For example, a conductive material that transmits visible light can be used for the second electrode 752.

For example, a conductive oxide, a metal film thin enough to transmit light, or a metal nanowire can be used for the second electrode 752.

Specifically, a conductive oxide containing indium can be used for the second electrode 752. Alternatively, a metal thin film with a thickness greater than or equal to 1 nm and less than or equal to 10 nm can be used for the second electrode 752. Alternatively, a metal nanowire containing silver can be used for the second electrode 752.

Specifically, indium oxide, indium tin oxide, indium zinc oxide, zinc oxide, zinc oxide to which gallium is added, zinc oxide to which aluminum is added, or the like can be used for the second electrode 752.

### [Alignment Films AF1 and AF2]

For example, a material containing polyimide or the like can be used for the alignment film AF1 or AF2. Specifically, a material formed to have alignment in the predetermined direction by rubbing treatment or an optical alignment technique can be used.

For example, a film containing soluble polyimide can be used for the alignment film AF1 or AF2.

### [Coloring Film CF1]

A material that transmits light of a predetermined color can be used for the coloring film CF1, in which case the coloring film CF1 can be used as a color filter or the like.

A material that transmits blue light, a material that transmits green light, a material that transmits red light, a material that transmits yellow light, or a material that transmits white light can be used for the coloring film CF1, for example.

### [Light-Blocking Film BM]

A material that prevents light transmission can be used for the light-blocking film BM, in which case the light-blocking film BM serves as a black matrix, for example.

### [Insulating Film 771]

For example, polyimide, an epoxy resin, an acrylic resin, or the like can be used for the insulating film 771.

### [Functional Film 770P]

For example, a polarizing plate, a retardation plate, a diffusing film, an anti-reflective film, a condensing film, or the like can be used as the functional film 770P. Alternatively, a polarizing plate containing a dichromatic pigment can be used for the functional film 770P.

Alternatively, an antistatic film preventing the attachment of a foreign substance, a water repellent film suppressing the attachment of stain, a hard coat film suppressing a scratch in use, or the like can be used as the functional film 770P.

[Second Display Element 550(i, j)]

A light-emitting element, for example, can be used as the second display element 550(i, j). Specifically, an organic electroluminescence element, an inorganic electroluminescence element, a light-emitting diode, or the like can be used as the second display element 550(i, j).

For example, a stack formed so as to emit blue light, a stack formed so as to emit green light, a stack formed so as to emit red light, or the like can be used for the layer 553(j) containing a light-emitting organic compound.

For example, a belt-like stack that extends in the column direction along the signal line S1(f) can be used for the layer 553(j) containing a light-emitting organic compound. Furthermore, a belt-like stack that extends in the column direction along the signal line S1(j+1) that emits light of a color different from that of light emitted from the layer 553(j) containing a light-emitting organic compound can be used for a layer 553(j+1) containing a light-emitting organic compound.

For example, a stack formed so as to emit white light can be used for the layer 553(j) containing a light-emitting organic compound and the layer 553(j+1) containing a light-emitting organic compound. Specifically, a stack of a layer containing a light-emitting organic compound including a fluorescent material that emits blue light, and a layer containing a material that is other than a fluorescent material and that emits green light and red light or a layer containing a material that is other than a fluorescent material and that emits yellow light can be used for the layer 553(j) containing a light-emitting organic compound and the layer 553(j+1) containing a light-emitting organic compound.

For example, any of the materials that can be used for the wiring or the like can be used for the third electrode 551(i, j) or the fourth electrode 552.

For example, a material that transmits visible light among the materials that can be used for the wiring or the like can be used for the third electrode 551(i, j).

Specifically, conductive oxide, indium-containing conductive oxide, indium oxide, indium tin oxide, indium zinc oxide, zinc oxide, zinc oxide to which gallium is added, or the like can be used for the third electrode 551(i, j). Alternatively, a metal film that is thin enough to transmit light can be used as the third electrode 551(i, j).

For example, a material that reflects visible light among the materials that can be used for the wiring or the like can be used for the fourth electrode 552.

### [Driver Circuit GD]

Any of a variety of sequential circuits such as a shift register can be used as the driver circuit GD. For example, the transistor MD, a capacitor, and the like can be used in the driver circuit GD. Specifically, a transistor including a semiconductor film that can be formed in the same step as the transistor M can be used.

A transistor having a structure different from that of the transistor that can be used for the switch SW1 can be used as the transistor MD. Specifically, a transistor including the conductive film 524 can be used as the transistor MD (see FIG. 22C).

The semiconductor film 508 is provided between the conductive films 524 and 504. The insulating film 516 is provided between the conductive film 524 and the semiconductor film 508. The insulating film 506 is provided between the semiconductor film 508 and the conductive film 504. For example, the conductive film 524 is electrically connected to a wiring that supplies a potential equal to that supplied to the conductive film 504.

Note that the transistor MD can have the same structure as the transistor M.

### [Driver Circuit SD]

For example, an integrated circuit can be used as the driver circuit SD. Specifically, an integrated circuit formed on a silicon substrate can be used as the driver circuit SD.

For example, a chip on glass (COG) method can be used to mount the driver circuit SD on a pad electrically connected to the pixel circuit 530(i, j). Specifically, an anisotropic conductive film can be used to mount the integrated circuit on the pad.

Note that the pad can be formed in the same process as the terminal 519B or the terminal 519C.

### [Method for Controlling Resistivity of Oxide Semiconductor]

A method for controlling the resistivity of an oxide semiconductor film will be described.

An oxide semiconductor film with a predetermined resistivity can be used for the semiconductor film 508, the conductive film 524, or the like.

For example, a method for controlling the concentration of impurities such as hydrogen and water contained in the oxide semiconductor film and/or controlling oxygen vacancies in the film can be used as the method for controlling the resistivity of an oxide semiconductor.

Specifically, plasma treatment can be used as a method for increasing or decreasing the concentration of impurities such as hydrogen and water and/or the oxygen vacancies in the film.

Specifically, plasma treatment using a gas containing one or more kinds selected from a rare gas (He, Ne, Ar, Kr, Xe), hydrogen, boron, phosphorus, and nitrogen can be employed. For example, plasma treatment in an Ar atmosphere, plasma treatment in a mixed gas atmosphere of Ar and hydrogen, plasma treatment in an ammonia atmosphere, plasma treatment in a mixed gas atmosphere of Ar and ammonia, or plasma treatment in a nitrogen atmosphere can be employed. Thus, the oxide semiconductor film can have a high carrier density and a low resistivity.

Alternatively, hydrogen, boron, phosphorus, or nitrogen is added to the oxide semiconductor film by an ion implantation method, an ion doping method, a plasma immersion ion implantation method, or the like, so that the oxide semiconductor film can have a low resistivity.

Alternatively, an insulating film containing hydrogen is formed in contact with the oxide semiconductor film, and hydrogen is diffused from the insulating film to the oxide semiconductor film, so that the oxide semiconductor film can have a high carrier density and a low resistivity.

For example, an insulating film with a hydrogen concentration of greater than or equal to 1×10²² atoms/cm³ is formed in contact with the oxide semiconductor film, in which case hydrogen can be effectively supplied to the oxide semiconductor film. Specifically, a silicon nitride film can be used as the insulating film formed in contact with the oxide semiconductor film.

Hydrogen contained in the oxide semiconductor film reacts with oxygen bonded to a metal atom to be water, and in addition, an oxygen vacancy is formed in a lattice from which oxygen is released (or a portion from which oxygen is released). Due to entry of hydrogen into the oxygen vacancy, an electron serving as a carrier is generated in some cases. Furthermore, in some cases, bonding of part of hydrogen to oxygen bonded to a metal atom causes generation of an electron serving as a carrier. Thus, the oxide semiconductor film can have a high carrier density and a low resistivity.

Specifically, an oxide semiconductor with a hydrogen concentration measured by secondary ion mass spectrometry (SIMS) of greater than or equal to 8×10¹⁹ atoms/cm³, preferably greater than or equal to 1×10²⁰ atoms/cm³, more preferably greater than or equal to 5×10²⁰ atoms/cm³ can be suitably used for the conductive film 524.

On the other hand, an oxide semiconductor with a high resistivity can be used for a semiconductor film where a channel of a transistor is formed. Specifically, such an oxide semiconductor can be suitably used for the semiconductor film 508.

For example, an insulating film containing oxygen, in other words, an insulating film capable of releasing oxygen, is formed in contact with an oxide semiconductor film, and oxygen is supplied from the insulating film to the oxide semiconductor film, so that oxygen vacancies in the film or at the interface can be filled. Thus, the oxide semiconductor film can have a high resistivity.

For example, a silicon oxide film or a silicon oxynitride film can be used as the insulating film capable of releasing oxygen.

The oxide semiconductor film in which oxygen vacancies are filled and the hydrogen concentration is reduced can be referred to as a highly purified intrinsic or substantially highly purified intrinsic oxide semiconductor film. The term “substantially intrinsic” refers to the state in which an oxide semiconductor film has a carrier density lower than 8×10¹¹/cm³, preferably lower than 1×10¹¹/cm³, further preferably lower than 1×10¹⁰/cm³. A highly purified intrinsic or substantially highly purified intrinsic oxide semiconductor film has few carrier generation sources and thus can have a low carrier density. The highly purified intrinsic or substantially highly purified intrinsic oxide semiconductor film has a low density of defect states and accordingly can have a low density of trap states.

Furthermore, a transistor including the highly purified intrinsic or substantially highly purified intrinsic oxide semiconductor film has an extremely low off-state current; even when an element has a channel width of 1×10⁶ μm and a channel length (L) of 10 μm, the off-state current can be less than or equal to the measurement limit of a semiconductor parameter analyzer, i.e., less than or equal to 1×10⁻¹³ A, at a voltage (drain voltage) between a source electrode and a drain electrode of from 1 V to 10 V.

The transistor in which a channel region is formed in the highly purified intrinsic or substantially highly purified intrinsic oxide semiconductor film can have a small change in electrical characteristics and have high reliability.

Specifically, an oxide semiconductor with a hydrogen concentration measured by secondary ion mass spectrometry (SIMS) of lower than or equal to 2×10²⁰ atoms/cm³, preferably lower than or equal to 5×10¹⁹ atoms/cm³, more preferably lower than or equal to 1×10¹⁹ atoms/cm³, more preferably lower than 5×10¹⁸ atoms/cm³, more preferably lower than or equal to 1×10¹⁸ atoms/cm³, more preferably lower than or equal to 5×10¹⁷ atoms/cm³, more preferably lower than or equal to 1×10¹⁶ atoms/cm³ can be suitably used as a semiconductor where a channel of a transistor is formed.

Note that an oxide semiconductor film having a higher hydrogen concentration and/or a larger amount of oxygen vacancies and a lower resistivity than the semiconductor film 508 is used as the conductive film 524.

A film whose hydrogen concentration is two or more times, preferably 10 or more times the hydrogen concentration of the semiconductor film 508 can be used as the conductive film 524.

A film whose resistivity is greater than or equal to 1×10⁻⁸ times and less than 1×10⁻¹ times the resistivity of the semiconductor film 508 can be used as the conductive film 524.

Specifically, a film with a resistivity of greater than or equal to 1×10⁻³ Ωcm and less than 1×10⁴ Ωcm, preferably greater than or equal to 1×10⁻³ Ωcm and less than 1×10⁻¹ Ωcm can be used as the conductive film 524.

The above is the description of the method for controlling the resistivity of an oxide semiconductor.

### Modification Example

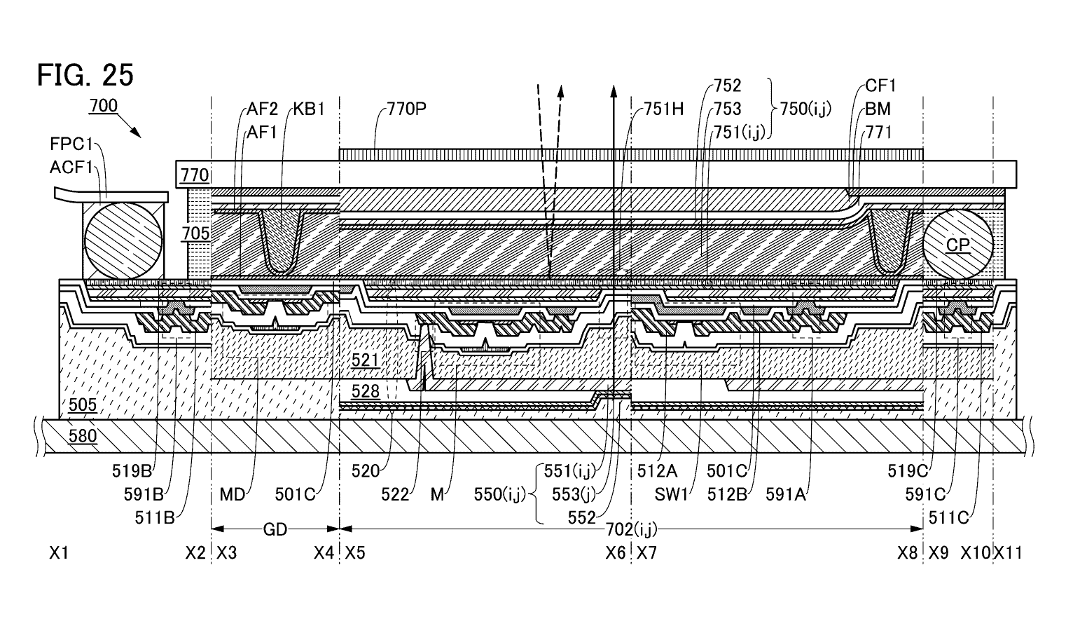

FIG. 25 is a cross-sectional view which is partly different from that in FIG. 22A. FIG. 25 differs from FIG. 22A mainly in lacking the substrate 570.

The display panel is directly attached and fixed to a housing 580. Specifically, the housing 580 and the functional layer 520 are attached to each other with the bonding layer 505.

With this structure, the thickness of a display device can be decreased. In addition, since the display panel is directly fixed to the housing 580, the number of components can be reduced. Furthermore, since one substrate can be eliminated, the display panel is suitable for use in a bent state.

For example, the support 12 of the display device 11 or the housing 22 of the electronic device 21, which is described in Embodiment 1, or the like can be used as the housing 580.

At least part of this embodiment can be implemented in combination with any of the other embodiments described in this specification as appropriate.

### Embodiment 3

In this embodiment, structural examples of an input/output device (a touch panel), an input device (a touch sensor), an output device (a display panel), and the like which can be used for the display portion in the above embodiment will be described.

### [Structural Example of Sensor Electrode or the Like]

A structural example of the input device (touch sensor) will be described below with reference to drawings.

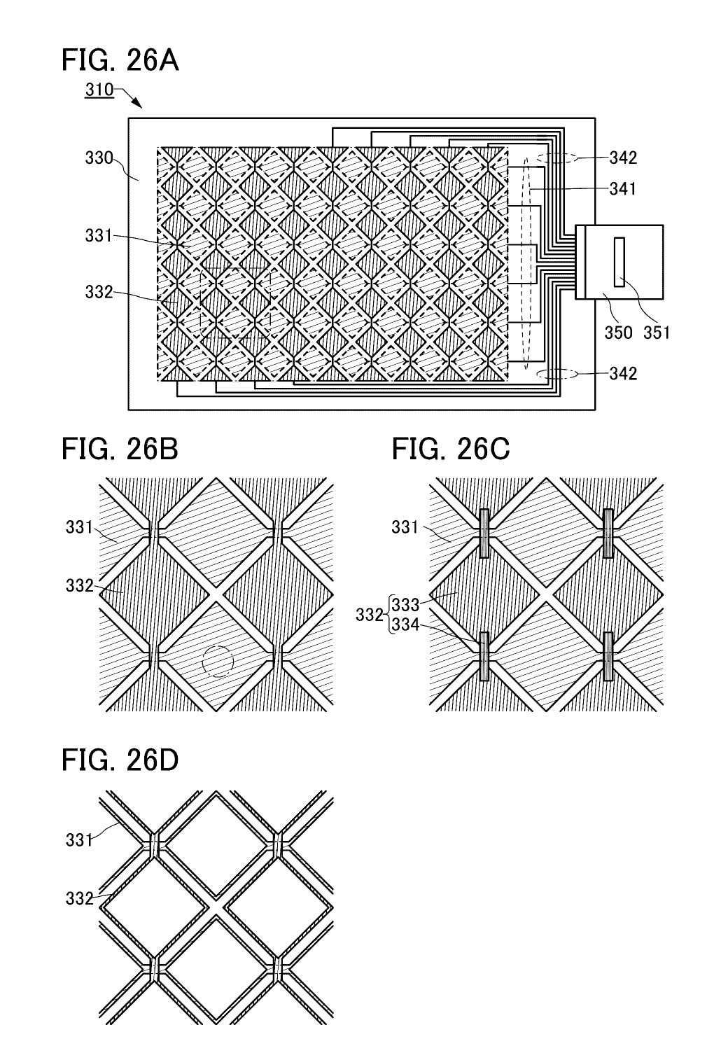

FIG. 26A is a schematic top view of an input device 310. The input device 310 includes a plurality of electrodes 331, a plurality of electrodes 332, a plurality of wirings 341, and a plurality of wirings 342 over a substrate 330. The substrate 330 is provided with a flexible printed circuit (FPC) 350 which is electrically connected to each of the plurality of wirings 341 and the plurality of wirings 342. FIG. 26A illustrates an example in which the FPC 350 is provided with an IC 351.

FIG. 26B is an enlarged view of a region surrounded by a dashed dotted line in FIG. 26A. The electrodes 331 are each in the form of a row of rhombic electrode patterns arranged in a lateral direction of this figure. The row of rhombic electrode patterns are electrically connected to each other. The electrodes 332 are also each in the form of a row of rhombic electrode patterns arranged in a longitudinal direction of this figure, and the row of rhombic electrode patterns are electrically connected. Part of the electrode 331 and part of the electrode 332 overlap and intersect with each other. At this intersection portion, an insulator is sandwiched in order to avoid an electrical short-circuit between the electrode 331 and the electrode 332.

As illustrated in FIG. 26C, the electrodes 332 may include a plurality of island-shape rhombic electrodes 333 and bridge electrodes 334. The island-shape rhombic electrodes 333 are arranged in the longitudinal direction of the figure, and two adjacent electrodes 333 are electrically connected to each other by the bridge electrode 334. Such a structure makes it possible that the electrodes 333 and the electrodes 331 can be formed at the same time by processing the same conductive film. This can prevent variations in the thickness of these electrodes, and can prevent the resistance value and the light transmittance of each electrode from varying from place to place. Note that although the electrodes 332 include the bridge electrodes 334 here, the electrodes 331 may have such a structure.

As illustrated in FIG. 26D, a design in which rhombic electrode patterns of the electrodes 331 and 332 illustrated in FIG. 26B are hollowed out and only edge portions are left may be used. At that time, when the electrodes 331 and 332 are narrow enough to be invisible to the users, the electrodes 331 and 332 can be formed using a light-blocking material such as a metal or an alloy, as will be described later. In addition, either the electrodes 331 or the electrodes 332 illustrated in FIG. 26D may include the above bridge electrodes 334.

One of the electrodes 331 is electrically connected to one of the wirings 341. One of the electrodes 332 is electrically connected to one of the wirings 342. Here, either one of the electrodes 331 and 332 corresponds to a row wiring, and the other corresponds to a column wiring.

The IC 351 has a function of driving the touch sensor. A signal output from the IC 351 is supplied to either of the electrodes 331 and 332 through the wirings 341 or 342. A current (or a potential) flowing to either of the electrodes 331 and 332 is input to the IC 351 through the wirings 341 or 342.

When a touch panel is formed in such a manner that the input device 310 is stacked over a display screen of the display panel, a light-transmitting conductive material is preferably used for the electrodes 331 and 332. In the case where a light-transmitting conductive material is used for the electrodes 331 and 332 and light from the display panel is extracted through the electrodes 331 or 332, it is preferable that a conductive film containing the same conductive material be arranged between the electrodes 331 and 332 as a dummy pattern. Part of a space between the electrodes 331 and 332 is filled with the dummy pattern, which can reduce variation in light transmittance. As a result, unevenness in luminance of light transmitted through the input device 310 can be reduced.

As the light-transmitting conductive material, a conductive oxide such as indium oxide, indium tin oxide, indium zinc oxide, zinc oxide, or zinc oxide to which gallium is added can be used. Note that a film containing graphene may be used as well. The film containing graphene can be formed, for example, by reducing a film containing graphene oxide. As a reducing method, a method with application of heat or the like can be employed.

Alternatively, a metal film or an alloy film which is thin enough to have a light-transmitting property can be used. For example, a metal such as gold, silver, platinum, magnesium, nickel, tungsten, chromium, molybdenum, iron, cobalt, copper, palladium, or titanium, or an alloy containing any of these metals can be used. Alternatively, a nitride of the metal or the alloy (e.g., titanium nitride), or the like may be used. Alternatively, a stacked film in which two or more of conductive films containing the above materials are stacked may be used.

For the electrodes 331 and 332, a conductive film that is processed to be thin enough to be invisible to the users may be used. Such a conductive film is processed into a lattice shape (a mesh shape), for example, which makes it possible to achieve both high conductivity and high visibility of the display device. It is preferable that the conductive film have a portion in which the width is greater than or equal to 30 nm and less than or equal to 100 μm, preferably greater than or equal to 50 nm and less than or equal to 50 μm, and further preferably greater than or equal to 50 nm and less than or equal to 20 μm. In particular, the conductive film having the pattern width of 10 μm or less is hardly visible to the users, which is preferable.

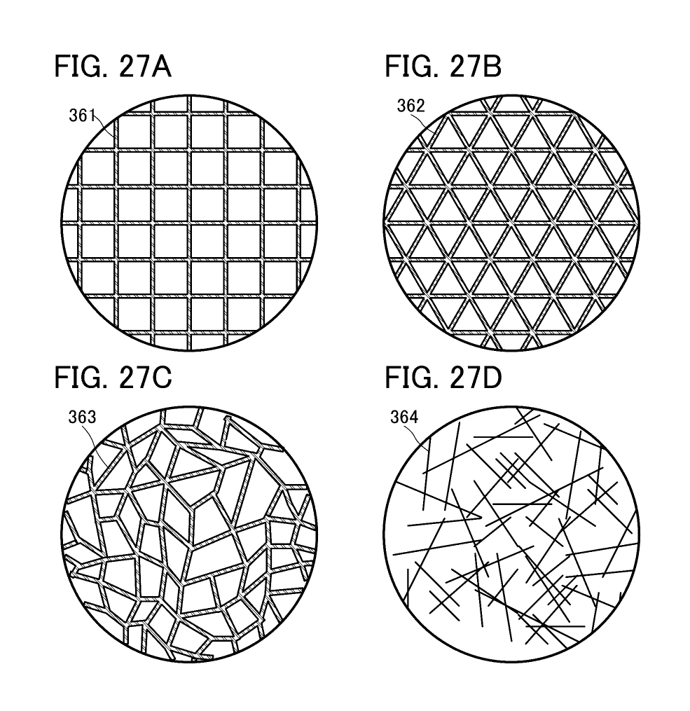

As examples, enlarged schematic views of part of the electrodes 331 or 332 are illustrated in FIGS. 27A to 27D. FIG. 27A illustrates an example where a lattice-shape conductive film 361 is used. The conductive film 361 is preferably placed so as not to overlap with the display element included in the display device because light from the display device is not blocked. In that case, it is preferable that the direction of the lattice be the same as the direction of the display element arrangement and that the pitch of the lattice be an integer multiple of the pitch of the display element arrangement.

FIG. 27B illustrates an example of a lattice-shape conductive film 362, which is processed so as to be provided with triangle openings. Such a structure makes it possible to further reduce the resistance compared with the structure illustrated in FIG. 27A.

In addition, a conductive film 363, which has an irregular pattern shape, may be used as illustrated in FIG. 27C. Such a structure can prevent generation of moire when overlapping with the display portion of the display device.

Conductive nanowires may be used for the electrodes 331 and 332. FIG. 27D illustrates an example where nanowires 364 are used. The nanowires 364 are dispersed at appropriate density so as to be in contact with the adjacent nanowires, which can form a two-dimensional network; therefore, the nanowires 364 can function as a conductive film with extremely high light-transmitting property. For example, nanowires which have a mean diameter of greater than or equal to 1 nm and less than or equal to 100 nm, preferably greater than or equal to 5 nm and less than or equal to 50 nm, and further preferably greater than or equal to 5 nm and less than or equal to 25 nm, can be used. As the nanowire 364, a metal nanowire such as an Ag nanowire, a Cu nanowire, or an Al nanowire, a carbon nanotube, or the like can be used. In the case of using an Ag nanowire, a light transmittance of 89% or more and a sheet resistance of 40 ohms per square or more and 100 ohms per square or less can be achieved.

The above is the description of the shapes of the electrodes and the like.

### [Structural Example of Touch Panel]

A structural example of a touch panel will be described below with reference to drawings as an example of an input/output device including the input device of one embodiment of the present invention.

### Structural Example

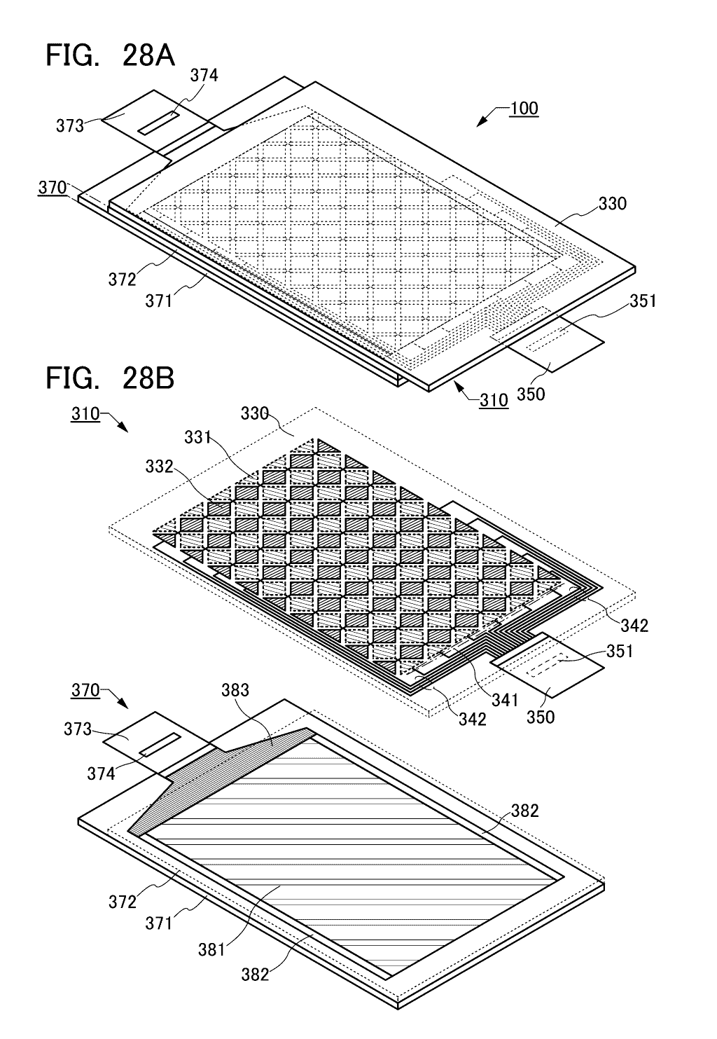

FIG. 28A is a schematic perspective view of a touch panel 100. FIG. 28B is a developed view of the schematic perspective view of FIG. 28A. Note that only typical components are illustrated for simplicity. In FIG. 28B, some components (such as the substrate 330 and a substrate 371) are illustrated only in dashed outline.

The touch panel 100 includes the input device 310 and a display panel 370, which are provided to overlap with each other.

The above description can be referred to for the structure of the input device 310. FIGS. 28A and 28B illustrate an example where the input device 310 includes the substrate 330, the plurality of electrodes 331, the plurality of electrodes 332, the plurality of wirings 341, the plurality of wirings 342, the FPC 350, and the IC 351.

As the input device 310, for example, a capacitive touch sensor can be used. Examples of the capacitive touch sensor include a surface capacitive touch sensor and a projected capacitive touch sensor. Examples of the projected capacitive touch sensor include a self-capacitive touch sensor and a mutual capacitive touch sensor. The use of a mutual capacitive type is preferable because multiple points can be sensed simultaneously. An example of using a projected capacitive touch sensor will be described below.

Note that one embodiment of the present invention is not limited to this example, and any of a variety of sensors capable of sensing the proximity or touch of an object to be sensed, such as a finger or a stylus, can be used as the input device 310.

The display panel 370 includes the substrate 371 and a substrate 372 which are provided so as to face each other. A display portion 381, a driver circuit 382, a wiring 383, and the like are provided over the substrate 371. The substrate 371 is also provided with an FPC 373 which is electrically connected to the wiring 383. In the example illustrated in FIGS. 28A and 28B, an IC 374 is provided over the FPC 373.

The display portion 381 includes at least a plurality of pixels. Each of the pixels includes at least one display element. It is preferable that each of the pixels include a transistor and a display element. As the display element, typically, a light-emitting element such as an organic EL element, a liquid crystal element, or the like can be used.

As the driver circuit 382, a circuit serving as a scan line driver circuit or a signal line driver circuit, for example, can be used.

The wiring 383 has a function of supplying a signal or power to the display portion 381 or the driver circuit 382. The signal or power is input to the wiring 383 from the outside or the IC 374 through the FPC 373.

In the example illustrated in FIGS. 28A and 28B, the IC 374 is mounted on the FPC 373 by a chip-on-film (COF) method. As the IC 374, an IC serving as a scan line driver circuit or a signal line driver circuit, for example, can be used. Note that it is possible that the IC 374 is not provided when the display panel 370 includes circuits serving as a scan line driver circuit and a signal line driver circuit or when circuits serving as a scan line driver circuit and a signal line driver circuit are externally provided and a signal for driving the display panel 370 is input through the FPC 373. The IC 374 may be directly mounted on the substrate 371 by a chip-on-glass (COG) method or the like.

### Cross-Sectional Structural Example 1

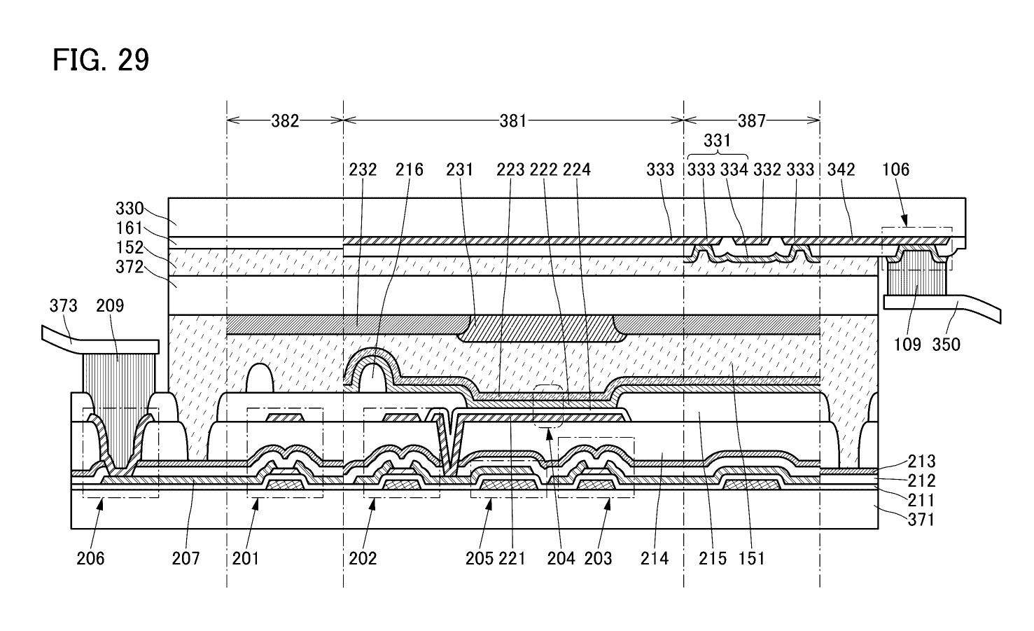

Next, an example of a cross-sectional structure of the touch panel 100 will be described with reference to a drawing. FIG. 29 is a schematic cross-sectional view of the touch panel 100. FIG. 29 illustrates cross sections of a region including the FPC 373, a region including the driver circuit 382, a region including the display portion 381, and a region including the FPC 350 in FIG. 28A.

The substrate 371 and the substrate 372 are attached to each other with an adhesive layer 151. The substrate 372 and the substrate 330 are attached to each other with an adhesive layer 152. Here, a structure including the substrate 371, the substrate 372, and components provided therebetween corresponds to the display panel 370. A structure including the substrate 330 and components formed over the substrate 330 corresponds to the input device 310.

### <Display Panel 370>

A transistor 201, a transistor 202, a transistor 203, a display element 204, a capacitor 205, a connection portion 206, a wiring 207, and the like are provided between the substrates 371 and 372.

An insulating layer 211, an insulating layer 212, an insulating layer 213, an insulating layer 214, an insulating layer 215, a spacer 216, and the like are provided over the substrate 371. Part of the insulating layer 211 functions as a gate insulating layer of each transistor, and another portion thereof functions as a dielectric of the capacitor 205. The insulating layer 212, the insulating layer 213, and the insulating layer 214 are provided to cover each transistor, the capacitor 205, and the like. The insulating layer 214 functions as a planarization layer. Note that an example where the three insulating layers, the insulating layers 212, 213, and 214, are provided to cover the transistors and the like is described here; however, the present invention is not limited to this example, and four or more insulating layers, a single insulating layer, or two insulating layers may be provided. The insulating layer 214 functioning as a planarization layer is not necessarily provided when not needed.

The display element 204 is provided over the insulating layer 214. An example where a top-emission organic EL element is used as the display element 204 is described here. The display element 204 emits light to the second electrode 223 side. The transistors 202 and 203, the capacitor 205, a wiring, and the like are provided to overlap with a light-emitting region of the display element 204. Thus, an aperture ratio of the display portion 381 can be increased.

The display element 204 includes an EL layer 222 between a first electrode 221 and a second electrode 223. An optical adjustment layer 224 is provided between the first electrode 221 and the EL layer 222. The insulating layer 215 is provided to cover end portions of the first electrode 221 and the optical adjustment layer 224.

FIG. 29 illustrates a cross section of one pixel as an example of the display portion 381. An example where the pixel includes the transistor 202 for current control, the transistor 203 for switching control, and the capacitor 205 is described here. One of a source and a drain of the transistor 202 and one electrode of the capacitor 205 are electrically connected to the first electrode 221 through an opening provided in the insulating layers 212, 213, and 214.

FIG. 29 illustrates an example of the driver circuit 382 in which the transistor 201 is provided.

In the example illustrated in FIG. 29, the transistors 201 and 202 each have a structure in which a semiconductor layer where a channel is formed is provided between two gate electrodes. Such transistors can have a higher field-effect mobility and thus have higher on-state current than other transistors. Consequently, a circuit capable of high-speed operation can be obtained. Furthermore, the area occupied by a circuit can be reduced. The use of the transistor having high on-state current can reduce signal delay in wirings and can reduce display luminance variation even in a display panel in which the number of wirings is increased because of increase in size or resolution.

Note that the transistors provided in the driver circuit 382 and the display portion 381 may have the same structure or different structures.

A material through which impurities such as water or hydrogen do not easily diffuse is preferably used for at least one of the insulating layers 212 and 213 which cover the transistors. That is, the insulating layer 212 or the insulating layer 213 can function as a barrier film. Such a structure can effectively suppress diffusion of the impurities into the transistors from the outside, and a highly reliable touch panel can be achieved.

The spacer 216 is provided over the insulating layer 215 and has a function of adjusting the distance between the substrate 371 and the substrate 372. In the example illustrated in FIG. 29, there is a gap between the spacer 216 and a light-blocking layer 232, which may however be in contact with each other. Although the spacer 216 is provided on the substrate 371 side in the structure described here, the spacer 216 may be provided on the substrate 372 side (e.g., in a position closer to the substrate 371 than that of the light-blocking layer 232). Alternatively, a particulate spacer may be used instead of the spacer 216. Although a material such as silica can be used for the particulate spacer, an elastic material such as an organic resin or rubber is preferably used. In some cases, the particulate spacer may be vertically crushed.

A coloring layer 231, the light-blocking layer 232, and the like are provided on the substrate 371 side of the substrate 372. The light-blocking layer 232 has an opening, and the opening is provided to overlap with the display region of the display element 204.

As examples of a material that can be used for the light-blocking layer 232, carbon black, a metal oxide, and a composite oxide containing a solid solution of a plurality of metal oxides can be given. Stacked films containing the material of the coloring layer 231 can also be used for the light-blocking layer 232. For example, a material containing an acrylic resin can be used for the coloring layer 231, and a stacked-layer structure of a film containing a material of a coloring layer which transmits light of a certain color and a film containing a material of a coloring layer which transmits light of another color can be employed. It is preferable that the coloring layer 231 and the light-blocking layer 232 be formed using the same material because the same manufacturing apparatus can be used and the process can be simplified.

As examples of a material that can be used for the coloring layer 231, a metal material, a resin material, and a resin material containing a pigment or a dye can be given.

An insulating layer which functions as an overcoat may be provided to cover the coloring layer 231 and the light-blocking layer 232.

The connection portion 206 is provided in a region near an end portion of the substrate 371. The connection portion 206 is electrically connected to the FPC 373 through a connection layer 209. In the example of the structure illustrated in FIG. 29, the connection portion 206 is formed by stacking a portion of the wiring 207 which is electrically connected to the driver circuit 382 and a conductive layer which is formed by processing a conductive film used for forming the first electrode 221. When the connection portion 206 is formed by stacking two or more conductive layers as described above, electric resistance can be reduced and mechanical strength of the connection portion 206 can be increased.

Furthermore, FIG. 29 illustrates a cross-sectional structure of a crossing portion 387 where a wiring formed by processing a conductive film used for forming the gate electrode of the transistor and a wiring formed by processing a conductive film used for forming the source electrode and the drain electrode of the transistor cross each other.

### <Input Device 310>

The electrode 331 and the electrode 332 are provided on the substrate 372 side of the substrate 330. An example where the electrode 331 includes the electrode 333 and the bridge electrode 334 is described here. As illustrated in the crossing portion 387 in FIG. 29, the electrode 332 and the electrode 333 are formed on the same plane. The bridge electrode 334 is provided over an insulating layer 161 which covers the electrode 332 and the electrode 333. The bridge electrode 334 electrically connects two electrodes 333, between which the electrode 332 is provided, through openings formed in the insulating layer 161.

A connection portion 106 is provided in a region near an end portion of the substrate 330. The connection portion 106 is electrically connected to the FPC 350 through a connection layer 109. In the example of the structure illustrated in FIG. 29, the connection portion 106 is formed by stacking a portion of the wiring 342 and a conductive layer which is formed by processing a conductive film used for forming the bridge electrode 334.

As the connection layer 109 or the connection layer 209, an anisotropic conductive film (ACF), an anisotropic conductive paste (ACP), or the like can be used.

The substrate 330 here can be used also as a substrate with which an object to be sensed, such as a finger or a stylus, is to be in contact. In that case, a protective layer (such as a ceramic coat) is preferably provided over the substrate 330. The protective layer can be formed using an inorganic insulating material such as silicon oxide, aluminum oxide, yttrium oxide, or yttria-stabilized zirconia (YSZ). Alternatively, tempered glass may be used for the substrate 330. Physical or chemical processing by an ion exchange method, a wind tempering method, or the like may be performed on the tempered glass, so that compressive stress is applied on the surface. In the case where the touch sensor is provided on one side of the tempered glass and the opposite side of the tempered glass is provided on, for example, the outermost surface of an electronic device for use as a touch surface, the thickness of the whole device can be decreased.

### <Components>

The above components are described below.

A substrate having a flat surface can be used as the substrate included in the touch panel. The substrate through which light emitted from the display element is extracted is formed using a material that transmits the light. For example, a material such as glass, quartz, ceramics, sapphire, or an organic resin can be used.

The weight and thickness of the touch panel can be decreased by using a thin substrate. Furthermore, a flexible touch panel can be obtained by using a substrate that is thin enough to have flexibility.

As the glass, for example, alkali-free glass, barium borosilicate glass, aluminoborosilicate glass, or the like can be used.

Examples of a material having flexibility and a light-transmitting property with respect to visible light include glass that is thin enough to have flexibility, polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, a polyvinyl chloride resin, and a polytetrafluoroethylene (PTFE) resin. In particular, a material whose thermal expansion coefficient is low is preferred, and for example, a polyamide imide resin, a polyimide resin, or PET can be suitably used. A substrate in which a glass fiber is impregnated with an organic resin or a substrate whose thermal expansion coefficient is reduced by mixing an organic resin with an inorganic filler can also be used. A substrate using such a material is lightweight, and thus, a touch panel using this substrate can also be lightweight.

Since the substrate through which light is not extracted does not need to have a light-transmitting property, a metal substrate or the like can be used as well as the above-described substrates. A metal substrate, which has high thermal conductivity, is preferable because it can easily conduct heat to the whole sealing substrate and accordingly can prevent a local temperature rise in the touch panel. To obtain flexibility and bendability, the thickness of a metal substrate is preferably greater than or equal to 10 μm and less than or equal to 200 μm, more preferably greater than or equal to 20 μm and less than or equal to 50 μm.

There is no particular limitation on a material of the metal substrate, but it is preferable to use, for example, a metal such as aluminum, copper, or nickel or an alloy such as an aluminum alloy or stainless steel.

It is possible to use a substrate subjected to insulation treatment in such a manner that a surface of a metal substrate is oxidized or an insulating film is formed on a surface. An insulating film may be formed by, for example, a coating method such as a spin-coating method or a dipping method, an electrodeposition method, an evaporation method, or a sputtering method. An oxide film may be formed on the substrate surface by an anodic oxidation method, exposing to or heating in an oxygen atmosphere, or the like.

The flexible substrate may have a stacked structure of a layer of any of the above-mentioned materials and a hard coat layer (e.g., a silicon nitride layer) which protects a surface of the touch panel from damage or the like, a layer (e.g., an aramid resin layer) which can disperse pressure, or the like. Furthermore, to suppress a decrease in the lifetime of the light-emitting element due to moisture and the like, an insulating film with low water permeability may be provided. For example, a film containing nitrogen and silicon (e.g., a silicon nitride film or a silicon oxynitride film) or a film containing nitrogen and aluminum (e.g., an aluminum nitride film) may be provided.

The substrate may be formed by stacking a plurality of layers. In particular, when a glass layer is used, a barrier property against water and oxygen can be improved, and thus, a highly reliable touch panel can be provided.

A substrate in which a glass layer, an adhesive layer, and an organic resin layer are stacked from the side closer to the light-emitting element can be used, for example. The thickness of the glass layer is greater than or equal to 20 μm and less than or equal to 200 μm, preferably greater than or equal to 25 μm and less than or equal to 100 μm. With such a thickness, the glass layer can have both a high barrier property against water and oxygen and a high flexibility. The thickness of the organic resin layer is greater than or equal to 10 μm and less than or equal to 200 μm, preferably greater than or equal to 20 μm and less than or equal to 50 μm. By providing such an organic resin layer, occurrence of a break or a crack in the glass layer can be inhibited, and the mechanical strength can be improved. With the substrate that includes such a composite material of a glass material and an organic resin, a highly reliable flexible touch panel can be provided.

The transistor includes a conductive layer functioning as the gate electrode, the semiconductor layer, a conductive layer functioning as the source electrode, a conductive layer functioning as the drain electrode, and the insulating layer functioning as the gate insulating layer. FIG. 29 illustrates the case where a bottom-gate transistor is used.

Note that there is no particular limitation on the structure of the transistor included in the touch panel of one embodiment of the present invention. For example, a staggered transistor or an inverted staggered transistor may be used. A top-gate transistor or a bottom-gate transistor may be used. There is no particular limitation on a semiconductor material used for the transistor, and an oxide semiconductor, silicon, or germanium can be used, for example.

There is no particular limitation on the crystallinity of a semiconductor material used for the transistor, and an amorphous semiconductor or a semiconductor having crystallinity (a microcrystalline semiconductor, a polycrystalline semiconductor, a single-crystal semiconductor, or a semiconductor partly including crystal regions) may be used. It is preferable that a semiconductor having crystallinity be used, in which case deterioration of the transistor characteristics can be suppressed.

As a semiconductor material for the semiconductor layer of the transistor, an element of Group 14, a compound semiconductor, or an oxide semiconductor can be used, for example. Typically, a semiconductor containing silicon, a semiconductor containing gallium arsenide, an oxide semiconductor containing indium, or the like can be used.

In particular, an oxide semiconductor having a wider band gap than silicon is preferably used. A semiconductor material having a wider band gap and a lower carrier density than silicon is preferably used because the off-state current of the transistor can be reduced.

For example, the oxide semiconductor preferably contains at least indium (In) or zinc (Zn). The oxide semiconductor more preferably includes an In-M-Zn-based oxide (M is a metal such as Al, Ti, Ga, Ge, Y, Zr, Sn, La, Ce, or Hf).

As the semiconductor layer, it is particularly preferable to use an oxide semiconductor film including a plurality of crystal parts whose c-axes are aligned substantially perpendicular to a surface on which the semiconductor layer is formed or the top surface of the semiconductor layer and in which a grain boundary is not observed between adjacent crystal parts.

There is no grain boundary in such an oxide semiconductor; therefore, generation of a crack in an oxide semiconductor film which is caused by stress when a display panel is bent is prevented. Therefore, such an oxide semiconductor can be preferably used for a flexible touch panel which is used in a bent state, or the like.

Moreover, the use of such an oxide semiconductor with crystallinity for the semiconductor layer makes it possible to provide a highly reliable transistor in which a variation in electrical characteristics is suppressed.

A transistor with an oxide semiconductor whose band gap is wider than that of silicon can hold electric charge stored in a capacitor that is series-connected to the transistor for a long time, owing to a low off-state current of the transistor. When such a transistor is used for a pixel, operation of a driver circuit can be stopped while a gray scale of an image displayed in each display region is maintained. As a result, a display device with an extremely low power consumption can be obtained.

### <Composition of CAC-OS>

Described below is the composition of a cloud aligned complementary oxide semiconductor (CAC-OS) applicable to a transistor disclosed in one embodiment of the present invention.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in an active layer of a transistor is called an oxide semiconductor in some cases. In other words, an OS FET is a transistor including a metal oxide or an oxide semiconductor.

In this specification, a metal oxide in which regions functioning as a conductor and regions functioning as a dielectric are mixed and which functions as a semiconductor as a whole is defined as a CAC-OS or a CAC-metal oxide.

The CAC-OS has, for example, a composition in which elements included in an oxide semiconductor are unevenly distributed. Materials including unevenly distributed elements each have a size of greater than or equal to 0.5 nm and less than or equal to 10 nm, preferably greater than or equal to 0.5 nm and less than or equal to 3 nm, or a similar size. Note that in the following description of an oxide semiconductor, a state in which one or more elements are unevenly distributed and regions including the element(s) are mixed is referred to as a mosaic pattern or a patch-like pattern. The region has a size of greater than or equal to 0.5 nm and less than or equal to 10 nm, preferably greater than or equal to 0.5 nm and less than or equal to 3 nm, or a similar size.

The physical properties of a region including an unevenly distributed element are determined by the properties of the element. For example, a region including an unevenly distributed element which relatively tends to serve as an insulator among elements included in a metal oxide serves as a dielectric region. In contrast, a region including an unevenly distributed element which relatively tends to serve as a conductor among elements included in a metal oxide serves as a conductive region. A material in which conductive regions and dielectric regions are mixed to form a mosaic pattern serves as a semiconductor.

That is, a metal oxide in one embodiment of the present invention is a kind of matrix composite or metal matrix composite, in which materials having different physical properties are mixed.

Note that an oxide semiconductor preferably contains at least indium. In particular, indium and zinc are preferably contained. In addition, an element M (M is one or more of gallium, aluminum, silicon, boron, yttrium, copper, vanadium, beryllium, titanium, iron, nickel, germanium, zirconium, molybdenum, lanthanum, cerium, neodymium, hafnium, tantalum, tungsten, magnesium, and the like) may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0), gallium zinc oxide (Ga_{X4}Zn_{Y4}O_{Z4}, where X4, Y4, and Z4 are real numbers greater than 0), or the like, and a mosaic pattern is formed. Then, InO_{X1} and In_{X2}Zn_{Y2}O_{Z2} forming the mosaic pattern are evenly distributed in the film. This composition is also referred to as a cloud-like composition.

That is, the CAC-OS is a composite oxide semiconductor with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to an element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≦x0≦1; m0 is a given number).

The above crystalline compounds have a single crystal structure, a polycrystalline structure, or a CAAC structure. Note that the CAAC structure is a crystal structure in which a plurality of IGZO nanocrystals have c-axis alignment and are connected in the a-b plane direction without alignment.

On the other hand, the CAC-OS relates to the material composition of an oxide semiconductor. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, silicon, boron, yttrium, copper, vanadium, beryllium, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected element(s) as a main component(s) are observed in part of the CAC-OS and nanoparticle regions including In as a main component are observed in part thereof, and these nanoparticle regions are randomly dispersed to form a mosaic pattern in the CAC-OS.

### <Analysis of CAC-OS>

Next, measurement results of an oxide semiconductor over a substrate by a variety of methods are described.

### <<Structure of Samples and Formation Method Thereof>>

Nine samples of one embodiment of the present invention are described below. The samples are formed at different substrate temperatures and with different ratios of an oxygen gas flow rate in formation of the oxide semiconductor. Note that each sample includes a substrate and an oxide semiconductor over the substrate.

A method for forming the samples is described.

A glass substrate is used as the substrate. Over the glass substrate, a 100-nm-thick In—Ga—Zn oxide is formed as an oxide semiconductor with a sputtering apparatus. The formation conditions are as follows: the pressure in a chamber is 0.6 Pa, and an oxide target (with an atomic ratio of In:Ga:Zn=4:2:4.1) is used as a target. The oxide target provided in the sputtering apparatus is supplied with an AC power of 2500 W.

As for the conditions in the formation of the oxide of the nine samples, the substrate temperature is set to a temperature that is not increased by intentional heating (hereinafter such a temperature is also referred to as room temperature or R.T.), to 130° C., and to 170° C. The ratio of a flow rate of an oxygen gas to a flow rate of a mixed gas of Ar and oxygen (also referred to as an oxygen gas flow rate ratio) is set to 10%, 30%, and 100%.

### <<Analysis by X-Ray Diffraction>>

In this section, results of X-ray diffraction (XRD) measurement performed on the nine samples are described. As an XRD apparatus, D8 ADVANCE manufactured by Bruker AXS is used. The conditions are as follows: scanning is performed by an out-of-plane method at θ/2θ, the scanning range is 15 deg. to 50 deg., the step width is 0.02 deg., and the scanning speed is 3.0 deg./min.

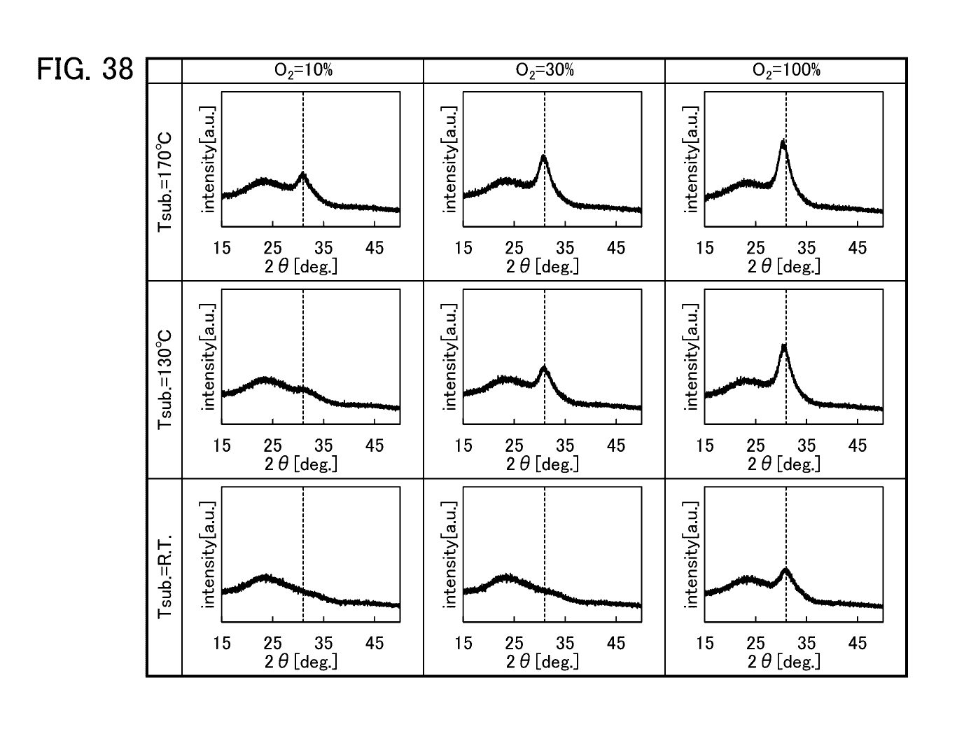

FIG. 38 shows XRD spectra measured by an out-of-plane method. In FIG. 38, the top row shows the measurement results of the samples formed at a substrate temperature of 170° C.; the middle row shows the measurement results of the samples formed at a substrate temperature of 130° C.; the bottom row shows the measurement results of the samples formed at a substrate temperature of R.T. The left column shows the measurement results of the samples formed with an oxygen gas flow rate ratio of 10%; the middle column shows the measurement results of the samples formed with an oxygen gas flow rate ratio of 30%; the right column shows the measurement results of the samples formed with an oxygen gas flow rate ratio of 100%.

In the XRD spectra shown in FIG. 38, the higher the substrate temperature at the time of formation is or the higher the oxygen gas flow rate ratio at the time of formation is, the higher the intensity of the peak at around 2θ=31° is. Note that it is found that the peak at around 2θ=31° is derived from a crystalline IGZO compound whose c-axes are aligned in a direction substantially perpendicular to a formation surface or a top surface of the crystalline IGZO compound (such a compound is also referred to as c-axis aligned crystalline (CAAC) IGZO).

As shown in the XRD spectra in FIG. 38, as the substrate temperature at the time of formation is lower or the oxygen gas flow rate ratio at the time of formation is lower, a peak becomes less clear. Accordingly, it is found that there are no alignment in the a-b plane direction and c-axis alignment in the measured areas of the samples that are formed at a lower substrate temperature or with a lower oxygen gas flow rate ratio.

<<Analysis with Electron Microscope>>

This section describes the observation and analysis results of the samples formed at a substrate temperature of R.T. and with an oxygen gas flow rate ratio of 10% with a high-angle annular dark-field scanning transmission electron microscope (HAADF-STEM). An image obtained with an HAADF-STEM is also referred to as a TEM image.

Described are the results of image analysis of plan-view images and cross-sectional images obtained with an HAADF-STEM (also referred to as plan-view TEM images and cross-sectional TEM images, respectively). The TEM images are observed with a spherical aberration corrector function. The HAADF-STEM images are obtained using an atomic resolution analytical electron microscope JEM-ARM200F manufactured by JEOL Ltd. under the following conditions: the acceleration voltage is 200 kV, and irradiation with an electron beam with a diameter of approximately 0.1 nm is performed.

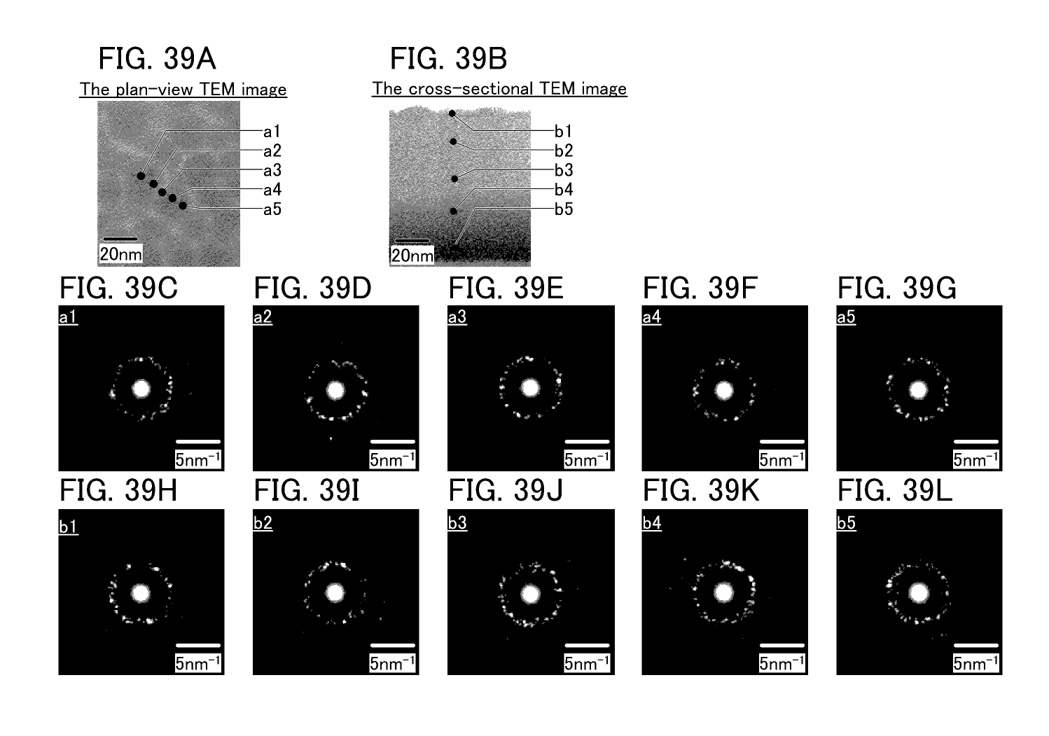

FIG. 39A is a plan-view TEM image of the sample formed at a substrate temperature of R.T. and with an oxygen gas flow rate ratio of 10%. FIG. 39B is a cross-sectional TEM image of the sample formed at a substrate temperature of R.T. and with an oxygen gas flow rate ratio of 10%.

### <<Analysis of Electron Diffraction Patterns>>

This section describes electron diffraction patterns obtained by irradiation of the sample formed at a substrate temperature of R.T. and an oxygen gas flow rate ratio of 10% with an electron beam with a probe diameter of 1 nm (also referred to as a nanobeam).

Electron diffraction patterns of points indicated by black dots a1, a2, a3, a4, and a5 in the plan-view TEM image in FIG. 39A of the sample formed at a substrate temperature of R.T. and an oxygen gas flow rate ratio of 10% are observed. Note that the electron diffraction patterns are observed while electron beam irradiation is performed at a constant rate for 35 seconds. FIGS. 39C, 39D, 39E, 39F, and 39G show the results of the points indicated by the black dots a1, a2, a3, a4, and a5, respectively.

In FIGS. 39C, 39D, 39E, 39F, and 39G, regions with high luminance in a circular (ring) pattern can be shown. Furthermore, a plurality of spots can be shown in a ring-like shape.

Electron diffraction patterns of points indicated by black dots b1, b2, b3, b4, and b5 in the cross-sectional TEM image in FIG. 39B of the sample formed at a substrate temperature of R.T. and an oxygen gas flow rate ratio of 10% are observed. FIGS. 39H, 39I, 39J, 39K, and 39L show the results of the points indicated by the black dots b1, b2, b3, b4, and b5, respectively.

In FIGS. 39H, 39I, 39J, 39K, and 39L, regions with high luminance in a ring pattern can be shown. Furthermore, a plurality of spots can be shown in a ring-like shape.

For example, when an electron beam with a probe diameter of 300 nm is incident on a CAAC-OS including an InGaZnO₄ crystal in a direction parallel to the sample surface, a diffraction pattern including a spot derived from the (009) plane of the InGaZnO₄ crystal is obtained. That is, the CAAC-OS has c-axis alignment and the c-axes are aligned in the direction substantially perpendicular to the formation surface or the top surface of the CAAC-OS. Meanwhile, a ring-like diffraction pattern is shown when an electron beam with a probe diameter of 300 nm is incident on the same sample in a direction perpendicular to the sample surface. That is, it is found that the CAAC-OS has neither a-axis alignment nor b-axis alignment.

Furthermore, a diffraction pattern like a halo pattern is observed when an oxide semiconductor including a nanocrystal (a nanocrystalline oxide semiconductor (nc-OS)) is subjected to electron diffraction using an electron beam with a large probe diameter (e.g., 50 nm or larger). Meanwhile, bright spots are shown in a nanobeam electron diffraction pattern of the nc-OS obtained using an electron beam with a small probe diameter (e.g., smaller than 50 nm). Furthermore, in a nanobeam electron diffraction pattern of the nc-OS, regions with high luminance in a circular (ring) pattern are shown in some cases. Also in a nanobeam electron diffraction pattern of the nc-OS, a plurality of bright spots are shown in a ring-like shape in some cases.

The electron diffraction pattern of the sample formed at a substrate temperature of R.T. and with an oxygen gas flow rate ratio of 10% has regions with high luminance in a ring pattern and a plurality of bright spots appear in the ring-like pattern. Accordingly, the sample formed at a substrate temperature of R.T. and with an oxygen gas flow rate ratio of 10% exhibits an electron diffraction pattern similar to that of the nc-OS and does not show alignment in the plane direction and the cross-sectional direction.

According to what is described above, an oxide semiconductor formed at a low substrate temperature or with a low oxygen gas flow rate ratio is likely to have characteristics distinctly different from those of an oxide semiconductor film having an amorphous structure and an oxide semiconductor film having a single crystal structure.

### <<Elementary Analysis>>

This section describes the analysis results of elements included in the sample formed at a substrate temperature of R.T. and with an oxygen gas flow rate ratio of 10%. For the analysis, by energy dispersive X-ray spectroscopy (EDX), EDX mapping images are obtained. An energy dispersive X-ray spectrometer AnalysisStation JED-2300T manufactured by JEOL Ltd. is used as an elementary analysis apparatus in the EDX measurement. A Si drift detector is used to detect an X-ray emitted from the sample.

In the EDX measurement, an EDX spectrum of a point is obtained in such a manner that electron beam irradiation is performed on the point in a detection target region of a sample, and the energy of characteristic X-ray of the sample generated by the irradiation and its frequency are measured. In this embodiment, peaks of an EDX spectrum of the point are attributed to electron transition to the L shell in an In atom, electron transition to the K shell in a Ga atom, and electron transition to the K shell in a Zn atom and the K shell in an O atom, and the proportions of the atoms in the point are calculated. An EDX mapping image indicating distributions of proportions of atoms can be obtained through the process in an analysis target region of a sample.

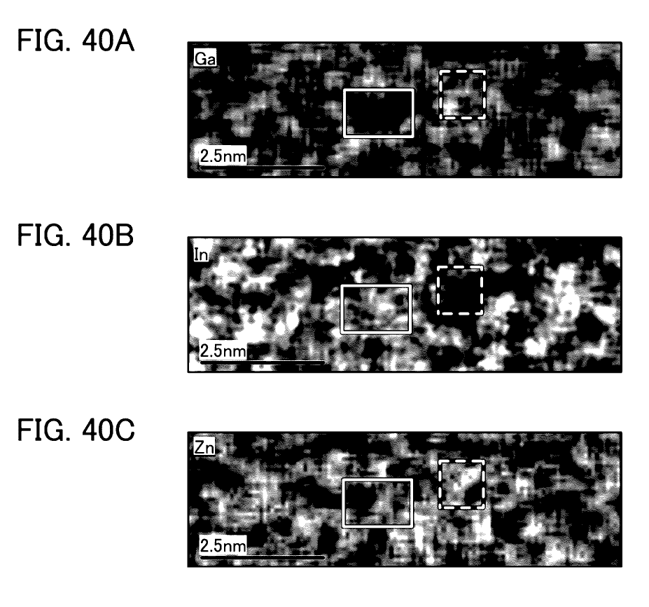

FIGS. 40A to 40C show EDX mapping images in a cross section of the sample formed at a substrate temperature of R.T. and with an oxygen gas flow rate ratio of 10%. FIG. 40A shows an EDX mapping image of Ga atoms. The proportion of the Ga atoms in all the atoms is 1.18 atomic % to 18.64 atomic %. FIG. 40B shows an EDX mapping image of In atoms. The proportion of the In atoms in all the atoms is 9.28 atomic % to 33.74 atomic %. FIG. 40C shows an EDX mapping image of Zn atoms. The proportion of the Zn atoms in all the atoms is 6.69 atomic % to 24.99 atomic %. FIGS. 40A to 40C show the same region in the cross section of the sample formed at a substrate temperature of R.T. and with an oxygen gas flow rate ratio of 10%. In the EDX mapping images, the proportion of an element is indicated by grayscale: the more measured atoms exist in a region, the brighter the region is; the less measured atoms exist in a region, the darker the region is. The magnification of the EDX mapping images in FIGS. 40A to 40C is 7200000 times.

The EDX mapping images in FIGS. 40A to 40C show relative distribution of brightness indicating that each element has a distribution in the sample formed at a substrate temperature of R.T. and with an oxygen gas flow rate ratio of 10%. Areas surrounded by solid lines and areas surrounded by dashed lines in FIGS. 40A to 40C are examined.

In FIG. 40A, a relatively dark region occupies a large area in the area surrounded by the solid line, while a relatively bright region occupies a large area in the area surrounded by the dashed line. In FIG. 40B, a relatively bright region occupies a large area in the area surrounded by the solid line, while a relatively dark region occupies a large area in the area surrounded by the dashed line.

That is, the areas surrounded by the solid lines are regions including a relatively large number of In atoms and the areas surrounded by the dashed lines are regions including a relatively small number of In atoms. In FIG. 40C, the right portion of the area surrounded by the solid line is relatively bright and the left portion thereof is relatively dark. Thus, the area surrounded by the solid line is a region including In_{X2}Zn_{Y2}O_{Z2}, InO_{X1}, and the like as main components.

The area surrounded by the solid line is a region including a relatively small number of Ga atoms and the area surrounded by the dashed line is a region including a relatively large number of Ga atoms. In FIG. 40C, the upper left portion of the area surrounded by the dashed line is relatively bright and the lower right portion thereof is relatively dark. Thus, the area surrounded by the dashed line is a region including GaO_{X3}, Ga_{X4}Zn_{Y4}O_{Z4}, and the like as main components.

Furthermore, as shown in FIGS. 40A to 40C, the In atoms are relatively more uniformly distributed than the Ga atoms, and regions including InO_{X1} as a main component is seemingly joined to each other through a region including In_{X2}Zn_{Y2}O_{Z2} as a main component. Thus, the regions including In_{X2}Zn_{Y2}O_{Z2} and InO_{X1} as main components extend like a cloud.

An In—Ga—Zn oxide having a composition in which the regions including GaO_{X3} or the like as a main component and the regions including In_{X2}Zn_{Y2}O_{Z2} or InO_{X1} as a main component are unevenly distributed and mixed can be referred to as a CAC-OS.

The crystal structure of the CAC-OS includes an nc structure. In an electron diffraction pattern of the CAC-OS with the nc structure, several or more bright spots appear in addition to bright sports derived from IGZO including a single crystal, a polycrystal, or a CAAC. Alternatively, the crystal structure is defined as having high luminance regions appearing in a ring pattern in addition to the several or more bright spots.

As shown in FIGS. 40A to 40C, each of the regions including GaO_{X3} or the like as a main component and the regions including In_{X2}Zn_{Y2}O_{Z2} or InO_{X1} as a main component has a size of greater than or equal to 0.5 nm and less than or equal to 10 nm, or greater than or equal to 1 nm and less than or equal to 3 nm. Note that it is preferable that a diameter of a region including each metal element as a main component be greater than or equal to 1 nm and less than or equal to 2 nm in the EDX mapping images.

As described above, the CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor exhibits. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Ion) and high field-effect mobility (μ) can be achieved.

A semiconductor element including a CAC-OS has high reliability. Thus, the CAC-OS is suitably used in a variety of semiconductor devices typified by a display.

Alternatively, silicon is preferably used as a semiconductor in which a channel of the transistor is formed. Although amorphous silicon may be used as silicon, silicon having crystallinity is particularly preferable. For example, microcrystalline silicon, polycrystalline silicon, single crystal silicon, or the like is preferably used. In particular, polycrystalline silicon can be formed at a lower temperature than single crystal silicon and has a higher field-effect mobility and a higher reliability than amorphous silicon. When such a polycrystalline semiconductor is used for a pixel, the aperture ratio of the pixel can be improved. Even in the case where the resolution is extremely high, a scan line driver circuit and a signal line driver circuit can be formed over a substrate over which pixels are formed, and the number of components of an electronic device can be reduced.

Examples of materials that can be used for conductive layers such as a gate, a source, and a drain of the transistor and a wiring and an electrode in the touch panel include metals such as aluminum, titanium, chromium, nickel, copper, yttrium, zirconium, molybdenum, silver, tantalum, and tungsten, an alloy containing any of these metals as its main component, and the like. A single-layer structure or a multi-layer structure including a film containing any of these materials can be used. For example, a single-layer structure of an aluminum film containing silicon, a two-layer structure in which an aluminum film is stacked over a titanium film, a two-layer structure in which an aluminum film is stacked over a tungsten film, a two-layer structure in which a copper film is stacked over a copper-magnesium-aluminum alloy film, a two-layer structure in which a copper film is stacked over a titanium film, a two-layer structure in which a copper film is stacked over a tungsten film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that an oxide such as indium oxide, tin oxide, or zinc oxide may also be used. Copper containing manganese is preferably used because controllability of a shape by etching is increased.

As a light-transmitting conductive material that can be used for conductive layers such as wirings and electrodes in the touch panel, a conductive oxide such as indium oxide, indium tin oxide, indium zinc oxide, zinc oxide, or zinc oxide to which gallium is added, or graphene can be used. Alternatively, a metal material such as gold, silver, platinum, magnesium, nickel, tungsten, chromium, molybdenum, iron, cobalt, copper, palladium, or titanium or an alloy material containing any of these metal materials can be used. Alternatively, a nitride of the metal material (e.g., titanium nitride) or the like may be used. In the case of using the metal material or the alloy material (or the nitride thereof), the thickness is set small enough to be able to transmit light. Alternatively, a stacked film of any of the above materials can be used as the conductive layer. For example, a stacked film of indium tin oxide and an alloy of silver and magnesium is preferably used because the conductivity can be increased.

Examples of insulating materials that can be used for the insulating layers, the overcoat, the spacer, and the like include a resin such as an acrylic or an epoxy, a resin having a siloxane bond, and an inorganic insulating material such as silicon oxide, silicon oxynitride, silicon nitride oxide, silicon nitride, or aluminum oxide.

The light-emitting element is preferably provided between a pair of insulating films with low water permeability, in which case impurities such as water can be prevented from entering the light-emitting element. Thus, a decrease in device reliability can be prevented.

As an insulating film with low water permeability, a film containing nitrogen and silicon (e.g., a silicon nitride film or a silicon nitride oxide film), a film containing nitrogen and aluminum (e.g., an aluminum nitride film), or the like can be used. Alternatively, a silicon oxide film, a silicon oxynitride film, an aluminum oxide film, or the like can be used.

For example, the water vapor transmittance of the insulating film with low water permeability is lower than or equal to 1×10⁻⁵ [g/(m²·day)], preferably lower than or equal to 1×10⁻⁶ [g/(m²·day)], further preferably lower than or equal to 1×10⁻⁷ [g/(m²·day)], and still further preferably lower than or equal to 1×10⁻⁸ [g/(m²·day)].

As the adhesive layer, a variety of curable adhesives, e.g., a photo-curable adhesive such as an ultraviolet curable adhesive, a reactive curable adhesive, a thermosetting adhesive, and an anaerobic adhesive can be used. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin. In particular, a material with low moisture permeability, such as an epoxy resin, is preferred. Alternatively, a two-component-mixture-type resin may be used. Further alternatively, an adhesive sheet or the like may be used.

Furthermore, the resin may include a drying agent. For example, a substance that adsorbs moisture by chemical adsorption, such as oxide of an alkaline earth metal (e.g., calcium oxide or barium oxide), can be used. Alternatively, a substance that adsorbs moisture by physical adsorption, such as zeolite or silica gel, may be used. The drying agent is preferably included because it can prevent impurities such as moisture from entering a functional element, thereby improving the reliability of the display panel.

In addition, it is preferable to mix a filler with a high refractive index or a light-scattering member into the resin, in which case light extraction efficiency can be enhanced. For example, titanium oxide, barium oxide, zeolite, zirconium, or the like can be used.

As the light-emitting element, a self-luminous element can be used, and an element whose luminance is controlled by current or voltage is included in the category of the light-emitting element. For example, a light-emitting diode (LED), an organic EL element, an inorganic EL element, or the like can be used.

The light-emitting element may be a top emission, bottom emission, or dual emission light-emitting element. A conductive film that transmits visible light is used as the electrode through which light is extracted. A conductive film that reflects visible light is preferably used as the electrode through which light is not extracted.

The EL layer includes at least a light-emitting layer. In addition to the light-emitting layer, the EL layer may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

For the EL layer, either a low molecular compound or a high molecular compound can be used, and an inorganic compound may also be used. Each of the layers included in the EL layer can be formed by any of the following methods: an evaporation method (including a vacuum evaporation method), a transfer method, a printing method, an inkjet method, a coating method, and the like.

When a voltage higher than the threshold voltage of the light-emitting element is applied between a cathode and an anode, holes are injected to the EL layer from the anode side and electrons are injected to the EL layer from the cathode side. The injected electrons and holes are recombined in the EL layer, so that a light-emitting substance contained in the EL layer emits light.

In the case where a light-emitting element emitting white light is used as the light-emitting element, the EL layer preferably contains two or more kinds of light-emitting substances. For example, light-emitting substances are selected so that two or more light-emitting substances emit complementary colors to obtain white light emission. Specifically, it is preferable to contain two or more light-emitting substances selected from light-emitting substances emitting light of red (R), green (G), blue (B), yellow (Y), orange (O), and the like and light-emitting substances emitting light containing two or more of spectral components of R, G, and B. The light-emitting element preferably emits light with a spectrum having two or more peaks in the wavelength range of a visible light region (e.g., 350 nm to 750 nm). An emission spectrum of a material emitting light having a peak in the wavelength range of yellow light preferably includes spectral components also in the wavelength ranges of green light and red light.

A light-emitting layer containing a light-emitting material emitting light of one color and a light-emitting layer containing a light-emitting material emitting light of another color are preferably stacked in the EL layer. For example, the plurality of light-emitting layers in the EL layer may be stacked in contact with each other or may be stacked with a region not including any light-emitting material therebetween. For example, between a fluorescent layer and a phosphorescent layer, a region containing the same material as the one in the fluorescent layer or phosphorescent layer (for example, a host material or an assist material) and no light-emitting material may be provided. This facilitates the manufacture of the light-emitting element and reduces the drive voltage.

The light-emitting element may be a single element including one EL layer or a tandem element in which a plurality of EL layers are stacked with a charge generation layer therebetween.

The conductive film that transmits visible light can be formed using, for example, indium oxide, indium tin oxide (ITO), indium zinc oxide, zinc oxide, or zinc oxide to which gallium is added. Alternatively, a film of a metal material such as gold, silver, platinum, magnesium, nickel, tungsten, chromium, molybdenum, iron, cobalt, copper, palladium, or titanium; an alloy containing any of these metal materials; or a nitride of any of these metal materials (e.g., titanium nitride) can be used when formed thin so as to have a light-transmitting property. Alternatively, a stacked film of any of the above materials can be used as the conductive layer. For example, a stacked film of ITO and an alloy of silver and magnesium is preferably used because the conductivity can be increased. Further alternatively, graphene or the like may be used.

For the conductive film that reflects visible light, for example, a metal material, such as aluminum, gold, platinum, silver, nickel, tungsten, chromium, molybdenum, iron, cobalt, copper, or palladium or an alloy including any of these metal materials can be used. Lanthanum, neodymium, germanium, or the like may be added to the metal material or the alloy. Furthermore, an alloy containing aluminum (an aluminum alloy) such as an alloy of aluminum and titanium, an alloy of aluminum and nickel, or an alloy of aluminum and neodymium; or an alloy containing silver such as an alloy of silver and copper, an alloy of silver, copper, and palladium, or an alloy of silver and magnesium can be used for the conductive film. An alloy of silver and copper is preferable because of its high heat resistance. Further, when a metal film or a metal oxide film is stacked on and in contact with an aluminum alloy film, oxidation of the aluminum alloy film can be prevented. Examples of materials for the metal film or the metal oxide film include titanium and titanium oxide. Alternatively, the above conductive film that transmits visible light and a film containing a metal material may be stacked. For example, a stacked film of silver and ITO or a stacked film of an alloy of silver and magnesium and ITO can be used.

Each of the electrodes can be formed by an evaporation method or a sputtering method. Alternatively, a discharging method such as an inkjet method, a printing method such as a screen printing method, or a plating method may be used.

Note that the aforementioned light-emitting layer and layers containing a substance with a high hole-injection property, a substance with a high hole-transport property, a substance with a high electron-transport property, a substance with a high electron-injection property, and a substance with a bipolar property may include an inorganic compound such as a quantum dot or a high molecular compound (e.g., an oligomer, a dendrimer, and a polymer). For example, when used for the light-emitting layer, the quantum dot can serve as a light-emitting material.

The quantum dot may be a colloidal quantum dot, an alloyed quantum dot, a core-shell quantum dot, a core quantum dot, or the like. A quantum dot containing elements belonging to Groups 12 and 16, elements belonging to Groups 13 and 15, or elements belonging to Groups 14 and 16, may be used. Alternatively, a quantum dot containing an element such as cadmium, selenium, zinc, sulfur, phosphorus, indium, tellurium, lead, gallium, arsenic, or aluminum may be used.

The above is the description of the components.

Structural examples which partly differ from the above cross-sectional structural example 1 will be described below with reference to drawings. Note that descriptions of the portions already described are omitted and different portions are described below.

### [Cross-Sectional Structural Example 2]

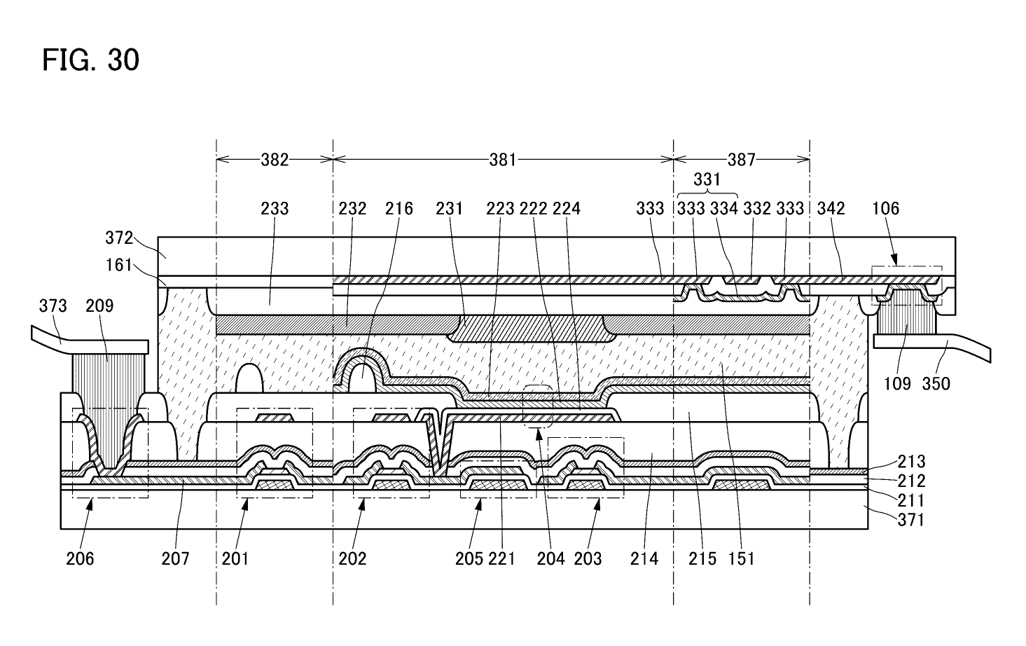

FIG. 30 illustrates a cross-sectional structural example of the touch panel 100 which partly differs from that in FIG. 29. Note that descriptions of the portions already described are omitted and different portions are described.

In a touch panel illustrated in FIG. 30, the electrodes and the like in the touch sensor are provided on the substrate 371 side of the substrate 372. Specifically, the electrode 332, the electrode 333, the wiring 341 (not illustrated), the wiring 342, and the like are formed over the substrate 372; the insulating layer 161 is formed to cover these components; and the bridge electrode 334 and the like are formed over the insulating layer 161.

An insulating layer 233 is provided to cover the electrodes and the like in the touch sensor. In addition, the coloring layer 231, the light-blocking layer 232, and the like are provided over the insulating layer 233.

In this structure, the input device 310 and the display panel 370 can share the substrate 372 and one surface of the substrate 372 can be used as a touch surface; thus, the thickness of the touch panel 100 can be further decreased.

### [Cross-Sectional Structural Example 3]

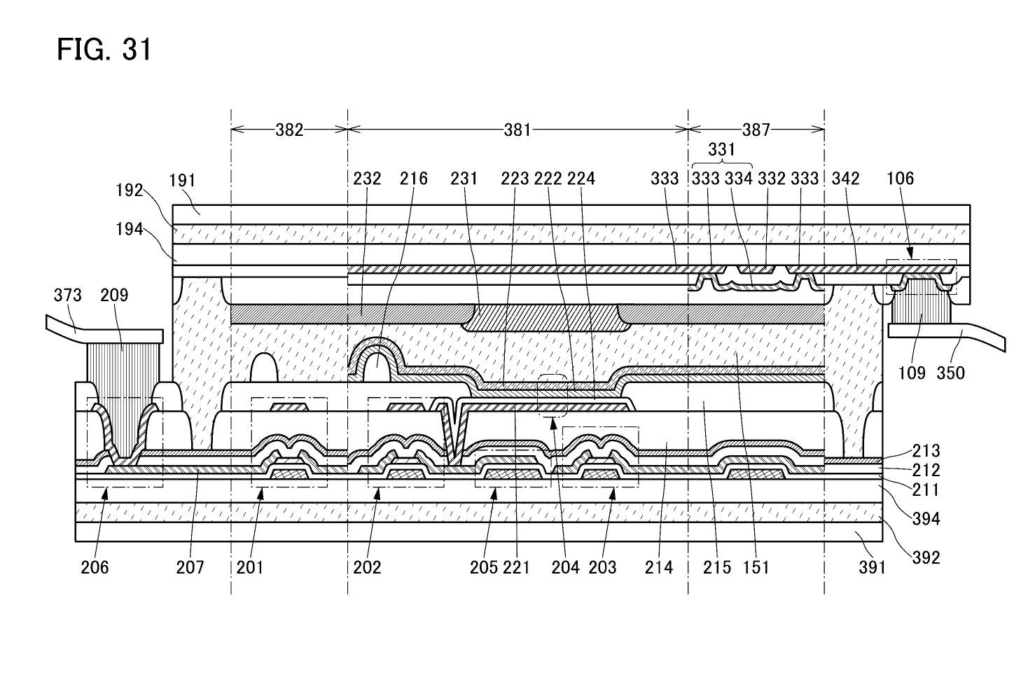

FIG. 31 illustrates a modification example of the touch panel illustrated in FIG. 30.

The touch panel in FIG. 31 has a stacked-layer structure including a substrate 391, an adhesive layer 392, and an insulating layer 394 in place of the substrate 371. The touch panel also has a stacked-layer structure including a substrate 191, an adhesive layer 192, and an insulating layer 194 in place of the substrate 372.

A material through which impurities such as water or hydrogen do not easily diffuse can be used for the insulating layer 394 and the insulating layer 194. Such a structure can effectively suppress diffusion of the impurities from the outside into the display element 204 and the transistors even in the case of using a material permeable to moisture for the substrate 391 and the substrate 191, and a highly reliable touch panel can be achieved.

Films having flexibility or the like are preferably used as the substrate 391 and the substrate 191. With the use of a material having flexibility for these substrates, a bendable touch panel can be achieved.

### [Cross-Sectional Structural Example 4]

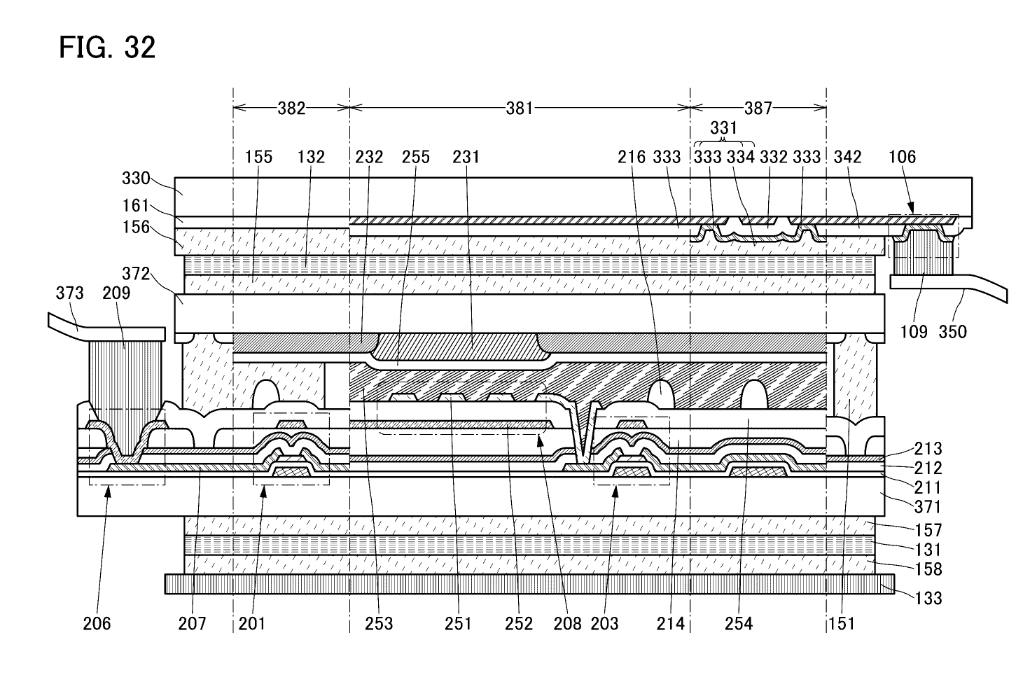

FIG. 32 illustrates a cross-sectional structural example of a touch panel where a liquid crystal display device is used as the display panel 370. In the touch panel illustrated in FIG. 32, a liquid crystal element is used as a display element 208. The touch panel includes a polarizing plate 131, a polarizing plate 132, and a backlight 133.

In the example illustrated here, a liquid crystal element using a fringe field switching (FFS) mode is used as the display element 208. The display element 208 includes an electrode 252, an electrode 251, and a liquid crystal 253. The electrode 251 is provided over the electrode 252 with an insulating layer 254 provided therebetween, and has a comb-like shape or a shape provided with a slit.

An overcoat 255 is provided to cover the coloring layer 231 and the light-blocking layer 232. The overcoat 255 has a function of preventing a pigment or the like which is included in the coloring layer 231 or the light-blocking layer 232 from diffusing into the liquid crystal 253.

Surfaces of the overcoat 255, the insulating layer 254, the electrode 251, and the like which are in contact with the liquid crystal 253 may be provided with alignment films for controlling the orientation of the liquid crystal 253.

In FIG. 32, the polarizing plate 131 is attached to the substrate 371 with an adhesive layer 157. The backlight 133 is attached to the polarizing plate 131 with an adhesive layer 158. The polarizing plate 132 is positioned between the substrate 372 and the substrate 330. The polarizing plate 132 is attached to the substrate 372 with an adhesive layer 155, and is attached to the substrate 330 (specifically, a portion of the insulating layer 161 formed over the substrate 330) with an adhesive layer 156.

Although the liquid crystal element using an FFS mode is described above, a vertical alignment (VA) mode, a twisted nematic (TN) mode, an in-plane-switching (IPS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, or the like can be used.

As the liquid crystal, a thermotropic liquid crystal, a low-molecular liquid crystal, a high-molecular liquid crystal, a ferroelectric liquid crystal, an anti-ferroelectric liquid crystal, a polymer dispersed liquid crystal (PDLC), or the like can be used. Moreover, a liquid crystal exhibiting a blue phase is preferably used because an alignment film is not needed and a wide viewing angle is obtained in that case.

### [Cross-Sectional Structural Example 5]

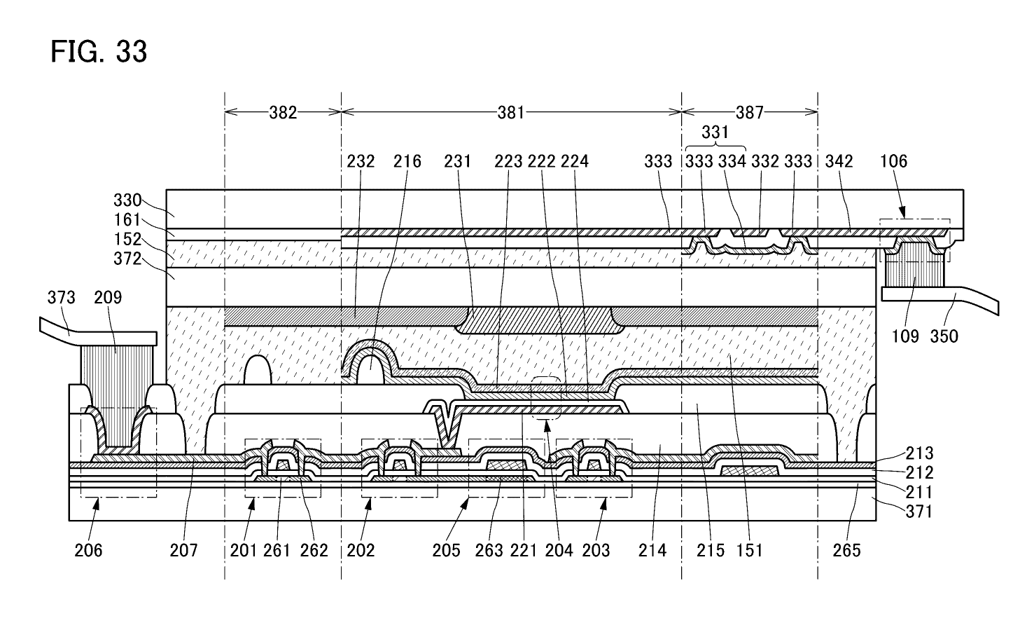

FIG. 33 illustrates an example in which the transistors 201, 202, and 203 in the cross-sectional structural example illustrated in FIG. 29 each have a top-gate structure.

Each of the transistors includes a semiconductor layer 261, and a gate electrode is provided over the semiconductor layer 261 with the insulating layer 211 provided therebetween. The semiconductor layer 261 may include a low-resistance region 262.

Source electrodes and drain electrodes of the transistors are provided over the insulating layer 213 and electrically connected to the regions 262 through openings provided in the insulating layers 213, 212, and 211.

FIG. 33 illustrates an example in which the capacitor 205 has a stacked-layer structure including a layer formed by processing a semiconductor film used for the semiconductor layer 261, the insulating layer 211, and a layer formed by processing a conductive film used for the gate electrode. It is preferable that a region 263 having a higher conductivity than a region in which a channel of the transistor is formed be formed in a portion of the semiconductor film of the capacitor 205.

The regions 262 and 263 can be, for example, a region containing a larger amount of impurity than the region where the channel of the transistor is formed, a region with a high carrier concentration, a region with low crystallinity, or the like. An impurity which can increase the conductivity depends on a semiconductor used for the semiconductor layer 261; typically, an element that can impart n-type conductivity, such as phosphorus, an element that can impart p-type conductivity, such as boron, a rare gas such as helium, neon, or argon, hydrogen, lithium, sodium, magnesium, aluminum, nitrogen, fluorine, potassium, calcium, or the like can be given. In addition to the above elements, titanium, iron, nickel, copper, zinc, silver, indium, tin, or the like also functions as an impurity which influences the conductivity of the semiconductor. For example, the region 262 and the region 263 contain the above impurity at a higher concentration than the region where the channel of the transistor is formed.

### [Cross-Sectional Structural Example 6]

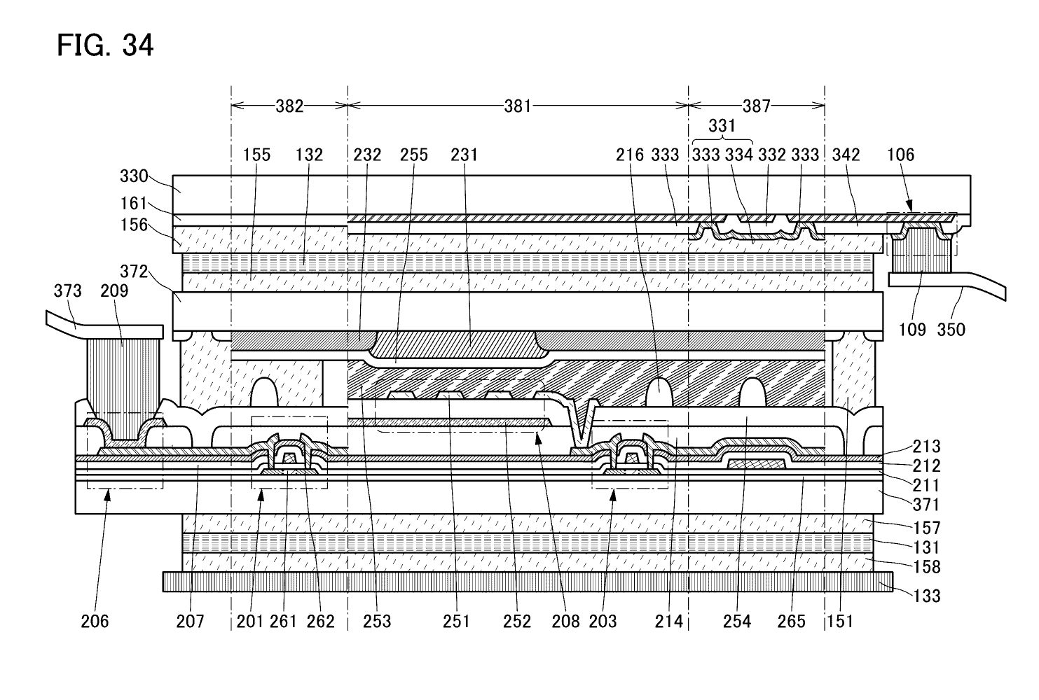

FIG. 34 illustrates an example in which the transistors 201 and 203 in the cross-sectional structural example illustrated in FIG. 32 each have a top-gate structure.

### Modification Example

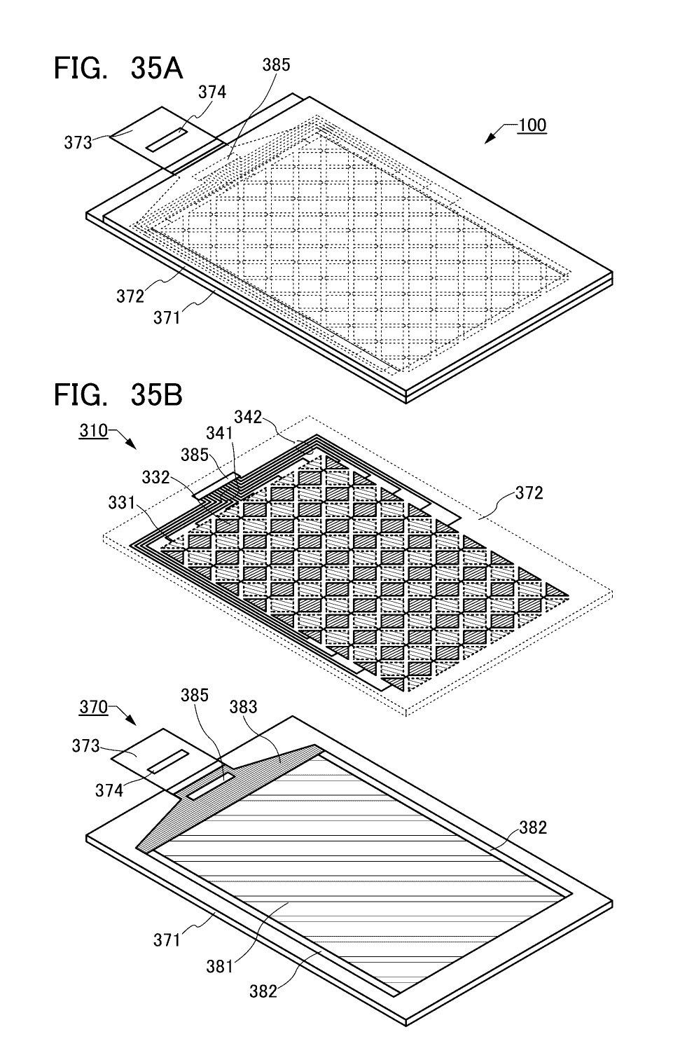

FIGS. 35A and 35B are perspective schematic views of the touch panel 100 whose structure partly differs from the structure illustrated in FIGS. 28A and 28B.

In FIGS. 35A and 35B, the substrate 372 of the display panel 370 is provided with the input device 310. The wiring 341, the wiring 342, and the like of the input device 310 are electrically connected to the FPC 373 provided for the display panel 370 through a connection portion 385.

With the above structure, the FPC connected to the touch panel 100 can be provided only on one substrate side (on the substrate 371 side in this embodiment). Although two or more FPCs may be attached to the touch panel 100, it is preferable that the touch panel 100 be provided with one FPC 373 which has a function of supplying signals to both the display panel 370 and the input device 310 as illustrated in FIGS. 35A and 35B, for the simplicity of the structure.

The IC 374 can have a function of driving the input device 310. Alternatively, an IC for driving the input device 310 may further be provided. Further alternatively, an IC for driving the input device 310 may be mounted on the substrate 371.

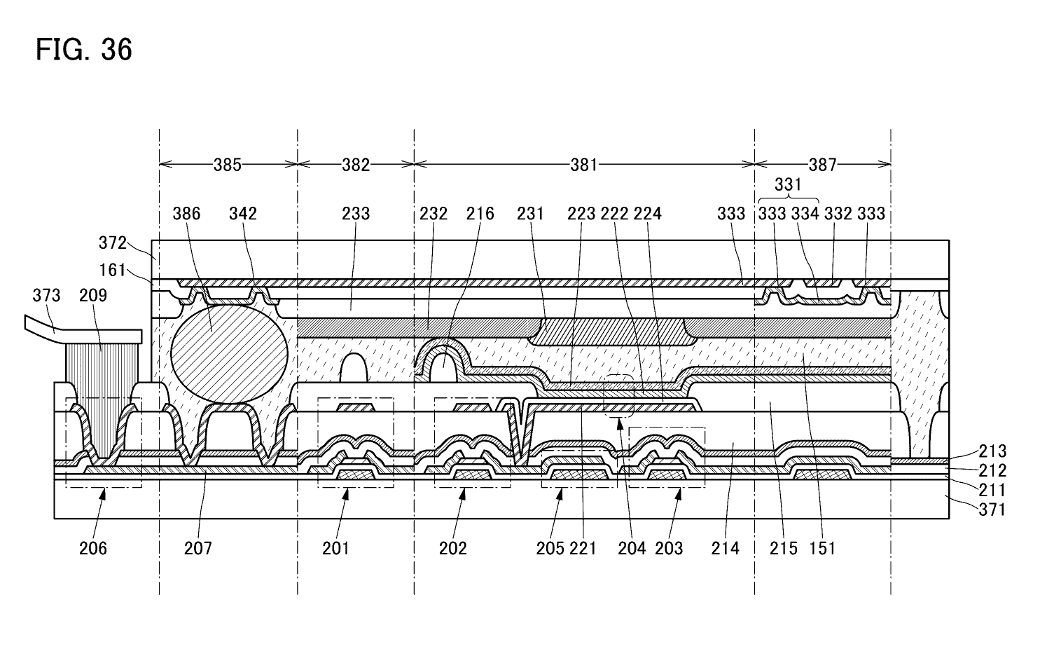

FIG. 36 illustrates the cross sections of a region including the FPC 373, a region including the connection portion 385, a region including the driver circuit 382, and a region including the display portion 381 in FIGS. 35A and 35B.

In the connection portion 385, one of the wirings 342 (or the wirings 341) and one of the wirings 207 are electrically connected to each other through a connector 386.

As the connector 386, a conductive particle can be used, for example. As the conductive particle, a particle of an organic resin, silica, or the like coated with a metal material can be used. It is preferable to use nickel or gold as the metal material because contact resistance can be decreased. It is also preferable to use a particle coated with layers of two or more kinds of metal materials, such as a particle coated with nickel and further with gold. As the connector 386, a material capable of elastic deformation or plastic deformation is preferably used. As illustrated in FIG. 36, the conductive particle has a shape that is vertically crushed in some cases. With the crushed shape, the contact area between the connector 386 and a conductive layer electrically connected to the connector 386 can be increased, thereby reducing contact resistance and suppressing the generation of problems such as disconnection.

The connector 386 is preferably provided so as to be covered with the adhesive layer 151. For example, a paste or the like for forming the adhesive layer 151 may be applied, and then, the connectors 386 may be scattered in the connection portion 385. A structure in which the connection portion 385 is provided in a portion where the adhesive layer 151 is provided can be similarly applied not only to a structure in which the adhesive layer 151 is also provided over the display element 204 as illustrated in FIG. 36 (also referred to as a solid sealing structure) but also to, for example, a hollow sealing structure in which the adhesive layer 151 is provided in the periphery of a light-emitting device, a liquid crystal display device, or the like.

The above is the description of the cross-sectional structural examples.

### [Example of Manufacturing Method]

Here, a method for manufacturing a flexible touch panel will be described.

For convenience, a structure including a pixel and a circuit, a structure including an optical member such as a color filter, a structure including an electrode and a wiring in a touch sensor, or the like is referred to as an element layer. An element layer includes a display element, for example, and may include a wiring electrically connected to the display element or an element such as a transistor used in a pixel or a circuit in addition to the display element.

Here, a support (e.g., the substrate 391 or the substrate 191 in FIG. 31) with an insulating surface where an element layer is formed is referred to as a substrate.

As a method for forming an element layer over a flexible substrate provided with an insulating surface, there are a method in which an element layer is formed directly over a substrate, and a method in which an element layer is formed over a supporting base that is different from the substrate and then the element layer is separated from the supporting base and transferred to the substrate.

In the case where a material of the substrate can withstand heating temperature in a process for forming the element layer, it is preferable that the element layer be formed directly over the substrate, in which case a manufacturing process can be simplified. At this time, the element layer is preferably formed in a state where the substrate is fixed to a supporting base, in which case transportation thereof in an apparatus and between apparatuses can be easy.

In the case of employing the method in which the element layer is formed over the supporting base and then transferred to the substrate, first, a separation layer and an insulating layer are stacked over the supporting base, and then the element layer is formed over the insulating layer. Next, the element layer is separated from the supporting base and then transferred to the substrate. At this time, a material is selected such that separation occurs at an interface between the supporting base and the separation layer, at an interface between the separation layer and the insulating layer, or in the separation layer.

For example, it is preferable that a stacked layer of a layer including a high-melting-point metal material, such as tungsten, and a layer including an oxide of the metal material be used as the separation layer, and a stacked layer of a plurality of layers, such as a silicon nitride layer, a silicon oxynitride layer, and a silicon nitride oxide layer be used as the insulating layer over the separation layer. The use of the high-melting-point metal material is preferable because the degree of freedom of the process for forming the element layer can be increased.

The separation may be performed by application of mechanical power, by etching of the separation layer, by dripping of a liquid into part of the separation interface to penetrate the entire separation interface, or the like. Alternatively, separation may be performed by heating the separation interface by utilizing a difference in thermal expansion coefficient.

The separation layer is not necessarily provided in the case where separation can occur at an interface between the supporting base and the insulating layer. For example, glass and an organic resin such as polyimide may be used as the supporting base and the insulating layer, respectively, and a separation trigger may be formed by locally heating part of the organic resin by laser light or the like, so that separation may be performed at an interface between the glass and the insulating layer. Alternatively, a metal layer may be provided between the supporting base and the insulating layer formed of an organic resin, and separation may be performed at the interface between the metal layer and the insulating layer by heating the metal layer by feeding current to the metal layer. A layer of a light-absorbing material (e.g., a metal, a semiconductor, or an insulator) may be provided between the supporting base and the insulating layer formed of an organic resin and locally heated by irradiation with laser light or the like to form a separation trigger. In these methods, the insulating layer formed of an organic resin can be used as a substrate.

Examples of materials of flexible substrates include polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, and a polyvinyl chloride resin. In particular, a material whose thermal expansion coefficient is low is preferred, and for example, a polyamide imide resin, a polyimide resin, or PET with a thermal expansion coefficient of 30×10⁻⁶/K or less can be suitably used. A substrate in which a fibrous body is impregnated with a resin (this substrate is also referred to as a prepreg) or a substrate whose coefficient of thermal expansion is reduced by mixing an organic resin with an inorganic filler can also be used.

In the case where a fibrous body is included in the above material, a high-strength fiber of an organic compound or an inorganic compound is used as the fibrous body. The high-strength fiber is specifically a fiber with a high tensile elastic modulus or a fiber with a high Young's modulus. Typical examples thereof include a polyvinyl alcohol based fiber, a polyester based fiber, a polyamide based fiber, a polyethylene based fiber, an aramid based fiber, a polyparaphenylene benzobisoxazole fiber, a glass fiber, and a carbon fiber. As the glass fiber, a glass fiber using E glass, S glass, D glass, Q glass, or the like can be used. These fibers may be used in a state of a woven or nonwoven fabric, and a structure body in which this fibrous body is impregnated with a resin and the resin is cured may be used as the flexible substrate. The structure body including the fibrous body and the resin is preferably used as the flexible substrate, in which case the reliability against bending or breaking due to local pressure can be increased.

Alternatively, glass, metal, or the like that is thin enough to have flexibility can be used as the substrate. Alternatively, a composite material where glass and a resin material are attached to each other may be used.

In the structure illustrated in FIG. 31, for example, a first separation layer and the insulating layer 394 are formed in this order over a first supporting base, and then components in a layer over the first separation layer and the insulating layer 394 are formed. Separately, a second separation layer and the insulating layer 194 are formed in this order over a second supporting base, and then components in a layer over the second separation layer and the insulating layer 194 are formed. Next, the first supporting base and the second supporting base are attached to each other with the adhesive layer 151. After that, separation at an interface between the second separation layer and the insulating layer 194 is conducted so that the second supporting base and the second separation layer are removed, and then the substrate 191 is attached to the insulating layer 194 with the adhesive layer 192. Further, separation at an interface between the first separation layer and the insulating layer 394 is conducted so that the first supporting base and the first separation layer are removed, and then the substrate 391 is attached to the insulating layer 394 with the adhesive layer 392. Note that either side may be subjected to separation and attachment first.

The above is the description of the manufacturing method of a flexible touch panel.

The input/output device (the touch panel), the input device (the touch sensor), the output device (the display panel), and the like which are described as examples in this embodiment can be applied to the display portions of the electronic device 21 and the display device 11 which are described as examples in Embodiment 1. The flexible display panel or touch panel can be applied to the display portion 24 provided along the curved surface of the housing 22 or the display portion 13 of the display device 11 which is intended to be bent. The display portion 23 which displays an image over a flat surface may include the flexible display panel or touch panel or may include an inflexible display panel or touch panel.

At least part of this embodiment can be implemented in combination with any of the other embodiments described in this specification as appropriate.

### Embodiment 4

The system of one embodiment of the present invention can be applied to a wearable terminal.

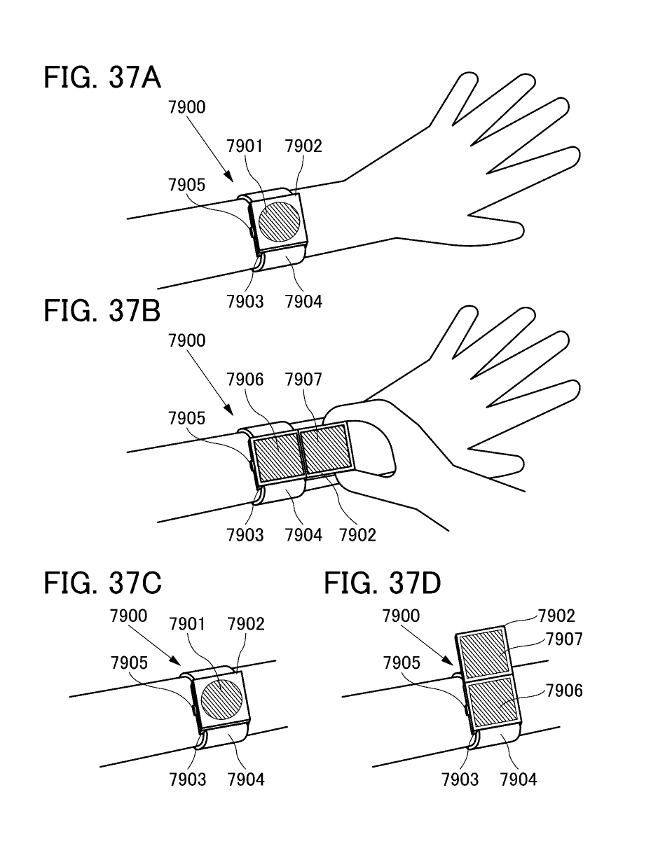

FIGS. 37A and 37B illustrate an example of a watch-type foldable portable information terminal. A portable information terminal 7900 includes a housing 7902, a housing 7903, a band 7904, an operation button 7905, and the like.

FIG. 37A illustrates a folded state of the portable information terminal 7900. A display portion 7901 provided in the housing 7902 can display information such as time.

The portable information terminal 7900 can be changed from a state in which the housing 7902 overlaps with the housing 7903 as illustrated in FIG. 37A into a state in which a display portion 7906 and a display portion 7907 can be seen as illustrated in FIG. 37B by opening the housing 7902. Therefore, the portable information terminal 7900 can be normally used in a state where the display portion 7901 is folded and can also be used with a display region extended by developing the display portion 7901.

When the display portion 7906 and the display portion 7907 function as a touch panel, the portable information terminal 7900 can be operated by touch on the display portion 7906 and the display portion 7907. The portable information terminal 7900 can be operated by pushing, turning, or sliding the operation button 7905 vertically, forward, or backward.

A lock mechanism is preferably provided so that the housing 7902 and the housing 7903 are not detached from each other accidentally when overlapping with each other as illustrated in FIG. 37A. In that case, it is preferable that the lock state can be canceled by pushing the operation button 7905, for example. Alternatively, the lock state may be canceled by utilizing restoring force of a spring or the like as a mechanism in which the portable information terminal is automatically changed in shape from the state illustrated in FIG. 37A into the state illustrated in FIG. 37B. Alternatively, the relative positions of the housing 7902 and the housing 7903 may be fixed by utilizing magnetic force of a magnet instead of the lock mechanism. By utilizing magnetic force, the housing 7902 and the housing 7903 can be easily attached or detached.

Although the housing 7902 can be opened in a direction substantially perpendicular to the bending direction of the band 7904 in FIGS. 37A and 37B, the housing 7902 may be opened in a direction substantially parallel to the bending direction of the band 7904 as illustrated in FIGS. 37C and 37D. In that case, the housing 7902 may be used in a curved state to be wrapped around the band 7904.

A portable information terminal with extremely low power consumption can be obtained by applying the display panel described as an example in the above embodiment, which can be switched between a transmissive mode and a reflective mode, to at least one of the display portions 7901, 7906, and 7907.

At least part of this embodiment can be implemented in combination with any of the other embodiments described in this specification as appropriate.

This application is based on Japanese Patent Application serial no. 2015-157126 filed with Japan Patent Office on Aug. 7, 2015 and Japanese Patent Application serial no. 2016-119609 filed with Japan Patent Office on Jun. 16, 2016, the entire contents of which are hereby incorporated by reference.

What is claimed is:

1. A display device attachable to an electronic device,
wherein the electronic device comprises a housing,
wherein the housing comprises a first display portion and a second display portion,
wherein the first display portion is positioned on a first surface including an upper surface of the housing,
wherein the second display portion is positioned on a second surface including a first side surface of the housing,
wherein the display device comprises a support portion, a connection portion, and a third display portion,
wherein the third display portion is positioned on a third surface of the support portion,
wherein the connection portion is configured to connect to the housing and reversibly change relative positions of the support portion and the housing between a first configuration and a second configuration,
wherein, in the first configuration, the support portion covers the first display portion such that the second display portion is visible,
wherein, in the second configuration, the support portion and the housing are opened such that the first display portion, the second display portion, and the third display portion are visible,
wherein, in a portion of the third display portion, a liquid crystal element and a light-emitting element are stacked,
wherein the liquid crystal element comprises a first electrode comprising an opening and being capable of reflecting visible light, and
wherein the light-emitting element is configured to emit light through the opening.

2. The display device according to claim 1, wherein, in the first configuration, the first display portion and the third display portion face each other.

3. The display device according to claim 1, wherein, in the first configuration, the support portion does not cover at least a portion of the second display portion.

4. The display device according to claim 1,
wherein the support portion comprises a light-transmitting portion, and
wherein, in the first configuration, the light-transmitting portion covers a portion of the first side surface of the housing and overlaps with the second display portion.

5. The display device according to claim 1, wherein the support portion is flexible and allows the third display portion to be bent.

6. The display device according to claim 1,
wherein the connection portion is flexible, and
wherein the relative positions of the support portion and the housing are reversibly changed between the first configuration and the second configuration by bending the connection portion.

7. The display device according to claim 1,
wherein the connection portion comprises a hinge structure with two or more rotation axes, and
wherein the hinge structure enables the relative positions of the support portion and the housing to be reversibly changed between the first configuration and the second configuration.

8. The display device according to claim 1, wherein the connection portion comprises a reception portion for receiving power and a signal from the housing.

9. The display device according to claim 8, wherein the reception portion is configured to receive the power and the signal wirelessly.

10. The display device according to claim 1, wherein the connection portion is magnetically attachable to and detachable from the housing.

11. An electronic device to which a display device is attachable,
wherein the electronic device comprises a housing,
wherein the housing comprises a first display portion and a second display portion,
wherein the first display portion is positioned on a first surface including an upper surface of the housing,
wherein the second display portion is positioned on a second surface including a first side surface of the housing,
wherein the display device comprises a support portion, a connection portion, and a third display portion,
wherein the third display portion is positioned on a third surface of the support portion,
wherein the connection portion is configured to connect to the housing and reversibly change relative positions of the support portion and the housing between a first configuration and a second configuration,
wherein, in the first configuration, the support portion covers the first display portion such that the second display portion is visible,
wherein, in the second configuration, the support portion and the housing are opened such that the first display portion, the second display portion, and the third display portion are visible,
wherein, in a portion of the third display portion, a liquid crystal element and a light-emitting element are stacked,
wherein the liquid crystal element comprises a first electrode comprising an opening and being capable of reflecting visible light, and
wherein the light-emitting element is configured to emit light through the opening.

12. The electronic device according to claim 11, wherein the connection portion is attachable to a second side surface opposite to the first side surface of the housing.

13. The electronic device according to claim 11,
wherein the first display portion and the second display portion are constituted by one display panel, and
wherein the second display portion comprises a curved portion.

14. The electronic device according to claim 11,
wherein the housing comprises a support mechanism, and
wherein, in the second configuration, the support mechanism is configured to support the support portion such that the first surface and the third surface are at a predetermined angle.

15. The electronic device according to claim 14, wherein the support mechanism comprises a lock mechanism configured to enable the relative positions of the housing and the support portion to include a plurality of stable positions.

16. The electronic device according to claim 11, wherein the housing comprises a transmission portion for supplying power and a signal to the connection portion.

17. The electronic device according to claim 16, wherein the transmission portion is configured to supply the power and the signal from the housing wirelessly.

18. The electronic device according to claim 11, wherein the housing is magnetically attachable to and detachable from the connection portion.

19. A system comprising the display device according to claim 1.

20. A system comprising the electronic device according to claim 11.
